(19) United States
(12) Patent Application Publication
(10) Pub. No.: US 2009/0210411 A1
(43) Pub. Date: Aug. 20, 2009

(54) Information Retrieving System

(75) Inventors: Toshiki Murata, Kyoto (JP); Mihoko Kitamura, Kyoto (JP); Tatsuya Sukehiro, Osaka (JP); Takeshi Yamamoto, Aichi (JP); Tadashi Fukushima, Aichi (JP); Sayori Shimohata, Saitama (JP); Atsushi Ikeno, Kyoto (JP)

Correspondence Address: Moss & Burke, PLLC, 401 Holland Lane, Suite 407, Alexandria, VA, 22314, US

(73) Assignee: OKI ELECTRIC INDUSTRY CO., LTD., Tokyo (JP)

(21) Appl. No.: 12/273,556

(22) Filed: Nov. 19, 2008

(30) Foreign Application Priority Data
Feb. 15, 2008 (JP) 2008-034743
Feb. 15, 2008 (JP) 2008-034999
Feb. 18, 2008 (JP) 2008-036342
Feb. 18, 2008 (JP) 2008-036356

(51) Int. Cl. G06F 7/06; G06F 17/30; G10L 15/18

(52) U.S. Cl. 707/5; 704/257; 707/E17.014; 707/E17.015

(57) ABSTRACT

A user speech analyzing component poses, to a user, question sentences for respective ones of a plurality of attributes, and analyzes an attribute value for each of the attributes from an answer sentence from the user to the sentence question. A user data holding component, as a result of analysis, holds user data that allows the plurality of attributes, and respective user attribute values for the attributes to correspond to one another. A matching component, when an acquisition ratio of the attribute values from the user with respect to all of the attributes is a predetermined value or greater, selects at least one target data candidate that matches each of the attributes and each of the attribute values of the user data, from a plurality of target data. A dialogue control component outputs each of the target data candidates selected, to the user's side.

### CROSS-REFERENCE TO RELATED APPLICATION

This application claims priority under 35 USC 119 from Japanese Patent Applications No. 2008-036342, No. 2008-034999, No. 2008-036356 and No. 2008-034743, the disclosures of which are incorporated by reference herein.

### BACKGROUND OF THE INVENTION

1. Field of the Invention

The present invention relates to a device included in an information retrieving system, a method applied to the information retrieving system, and a storage medium having a program stored therein.

2. Description of the Related Art

With the advancement of an information-intensive society, information analyzing techniques and information retrieving techniques for searching for necessary information from a large volume of various information existing on a network are not limited only to the information industry and are becoming an important issue that is directly linked to strengthening of competitiveness of every field of industry that utilizes information such as communication, media, advertising, content, distribution and the like.

As information analyzing/information retrieving systems that retrieve information existing on a network, various systems such as Google (registered trademark), Yahoo (registered trademark) and the like are in practical use.

In these information analyzing/information retrieving systems, generally, information is presented sequentially from the information having the highest hit counts for an input keyword. Accordingly, in order for a user to retrieve information that he or she hopes to acquire, the information keyword needs to be correctly input. However, there are cases in which a user may not know what keyword should be input.

Accordingly, as techniques that solve the aforementioned problems, the adoption of, for example, automatic expansion of keywords that also allows display of keywords used together with an input keyword, a recommendation system that allows introduction of goods for sale or the like by word-of-mouth advertising from many users, and the like has also been considered.

However, the techniques such as described above introduce typical information recommended by a greater number of users, and do not necessarily introduce concrete information individualized for respective users.

Hence, information analyzing/information retrieving techniques are proposed in which a dialogue is held between a user and a system, and due to repetition of questions that gradually delve deeper in the dialogue, needs or value judgments that a user really hopes for are pulled up, whereby information that the user is conscious of can be retrieved.

As described above, in a system in which the consciousness of a user is analyzed and information corresponding to the consciousness is retrieved, it becomes necessary to correctly extract information that the user is conscious of, which information matches attribute information of the system, from the dialogue with the user.

Japanese Patent Application Laid-Open (JP-A) No. 2003-036271 discloses a technique regarding an interactive information retrieving method in which data having a data structure constituted by a plurality of attributes and attribute values thereof is accumulated, a target attribute that a user hopes to acquire, a key attribute used for narrowing-down of data, and an attribute value of the key attribute are inputted, an attribute value of the target attribute is retrieved by using the key attribute and the attribute value thereof, and the retrieval result is outputted.

Further, in the technique described in JP-A No. 2003-036271, control is effected such that, prior to retrieval of the attribute value of the target attribute, the degree of distribution of the attribute values of the target attribute is calculated based on the input key attribute and the attribute value of the key attribute, and only when the degree of distribution converges in a predetermined range, the retrieval result is outputted.

Incidentally, in the information analyzing/information retrieving technique as proposed above, the consciousness of a user is extracted from a dialogue with the user, and therefore, it is necessary that a matching result of the result of the dialogue with the user and retrieval object data be reflected, and that, next, a determination be made as to the content (attribute) of a question that is to be presented.

However, in the technique disclosed in JP-A No. 2003-036271, since the degree of distribution of the attribute value of the target attribute is calculated prior to retrieval of the attribute value of the target attribute, there is some narrowing-down of input conditions prior to retrieval, but since the matching result of the attribute value of the key attribute and the attribute value of the target attribute is not referred to, the matching result regarding the subsequent question cannot be reflected. As a result, there arises a problem that in the dialogue, it is not possible to recommend another attribute that does not match (retrieval object data). Further, there also arises a problem that it is not possible to consider the precedence of a user with respect to a certain attribute, or decision conditions.

To this end, an information retrieving device, an information retrieving method, and a program matching management device, in which in a dialogue with a user, it is possible to precisely determine the user precedence and current matching conditions and acquire an optimum matching result, and with reference to the matching result, a precise retrieval result can be obtained, is demanded.

JP-A No. 2000-276487 describes a technique regarding a conventional interactive information retrieving system. In the technique of JP-A No. 2000-276487, due to the fact that, as the number of times for the dialogue increases, the time required for a narrowing-down process becomes longer and false recognition occurs very often, the number of times for the dialogue is optimized.

However, the object of the information analyzing/information retrieving technique that is currently proposed is to retrieve information that the user is conscious of, as described above, and therefore, it is necessary to obtain information that the user essentially is conscious of.

In this case, by only obtaining, from the user, information necessary for retrieval of information, it is not possible to probe the user's original consciousness. For example, if trustful relations between a certain person and a conversation partner are built up, then the former person will open his/her mind to the latter. Further, in the course of moving the conversation along, when the conversation has moved on to another subject, the certain person may reveal his/her consciousness to the previous subject for the first time.

In order to perform these behaviors in the aforementioned system, the way of advancing the dialogue in the dialogue with the user, the kind of subjects to be brought up, and the way of building up a feeling of trust and a feeling of security between the user and the system become issues.

Hence, a dialogue managing device, a dialogue managing method, a dialogue managing program, and a consciousness extracting system are demanded, in which a dialogue between a user and a system is smoothly developed, and in the course of moving the conversation along, a feeling of security or a feeling of trust is imparted to the user, thereby making it possible to extract the original consciousness of a user.

JP-A No. 2000-276487 describes a technique in which case examples occurring in the past are accumulated, and a case example similar to that which is occurring currently is retrieved from the accumulated case examples.

However, in the technique described in JP-A No. 2000-276487, while referring to a domain ontology in which accumulation of case examples, and knowledge regarding the relations between terms stored in a region to be retrieved are stored, case example sentences formed into a cluster depending on the degree of similarity of case example sentences are accumulated, the degree of similarity of a case example sentence similar to the inputted retrieval sentence is obtained, and based on the degree of similarity, the clustered similar case example sentences are retrieved.

That is to say, JP-A No. 2000-276487 as described above discloses only one kind of method of retrieving case example sentences similar to the current retrieval sentence from the case example sentences accumulated in the past, and therefore, there may arise a problem in that when information is extracted from a variously developed dialogue with a user, proper extraction of information cannot be effected.

Hence, an information extracting device, an information extracting method and an information extracting program in which proper information can be extracted from a variously developed dialogue with a user are demanded.

Conventionally, as a device in which a speech of a human being is analyzed, and a predicate and a case element corresponding thereto are identified (extracted), and a response is prepared using them, a response generating device described in JP-A No. 2007-206888 has been proposed. In this conventional device, in response to the user's speech “I made the sideboard and other things in the living room.”, the response “You made the sideboard?” which is the speech of the system (device) is realized. In the device described in JP-A No. 2007-206888, a plurality of candidate responses of the system is prepared, and therefore, the response of the system can be selected in random manner or can be selected by setting the precedence freely (for groups classified by the method of generating candidate speeches).

Incidentally, as an interactive information retrieving device, the present inventors have studied and developed a laddering type retrieving device. That is to say, they have studied and developed a device in which due to repetition of questions that gradually delve deeper in the dialogue between the device and a user, needs or value judgments of the user are pulled out, and service or content that matches the pulled-out information is searched out. In order to properly pull out needs or value judgments of the user, it is demanded that the user is made to bear a feeling of sympathy (friendliness) in a natural dialogue.

However, the aforementioned conventional device is a method in which a predicate and a case element corresponding thereto are identified (extracted) and a response is prepared using them. Thus, the method of generating a response is restrictive, and the feeling of sympathy cannot be efficiently represented.

Further, in the conventional device, in the predicate or case element, only the keywords are left, and modifiers are not used in the response. As the case element to be combined with the predicate, only one case element is used for one candidate. Accordingly, naturalness of the dialogue is not ensured sufficiently.

Still further, in the laddering type retrieving device, several speeches (a kind of question addressed to a user) used to obtain information from the user are prepared, and it becomes necessary that the system has a key role in changing the subject. However, in the conventional device, the speech from the system is a “response to a speech from the user” or a “simple agreement”, and no disclosure or suggestion about a way in which the system changes the subject is provided.

Furthermore, in the conventional device, the system can use only the vocabularies that the user has used, whereby the response becomes monotonous.

Further, in the conventional device, when neither predicate nor case element exist, a simple agreement word (“Wow.” or “Really?”) merely appears, and thus, the feeling of sympathy is not strongly produced.

Accordingly, a dialogue system, a dialogue method and a dialogue program, in which a feeling of sympathy to a human can be sufficiently produced and a natural dialogue (response) can be realized, are demanded.

### SUMMARY OF THE INVENTION

One aspect of the present invention relates to an information retrieving device, an information retrieving method, and a storage medium having a program stored therein. For example, the invention can be applied to an information retrieving device in which a response relating to a dialogue is determined using a result of matching, which dialogue is held subsequent to the matching, in an interactive information retrieving system, an information retrieving method, and a storage medium having a program stored therein.

Another aspect of the present invention relates to a dialogue managing device, a dialogue managing method, a storage medium having a program stored therein, and a consciousness extracting system. For example, in the information retrieving system, the invention can be applied to a dialogue managing device in which consciousness of a user is extracted from a dialogue between the user and the system, a dialogue managing method, a storage medium having a program stored therein, and a consciousness extracting system.

Still another aspect of the present invention relates to information extracting device, an information extracting method, and a storage medium having a program stored therein. For example, in the information retrieving system, the invention can be applied to an information extracting system in which predetermined information is extracted from input information.

Yet another aspect of the present invention relates to a dialogue system, a dialogue method and a dialogue program. For example, the invention can be applied to an interactive information retrieving system.

A first aspect of the present invention is an information retrieving device. The information retrieving device includes comprising: a user speech analyzing component that poses, to a user, question sentences for respective ones of a plurality of attributes during a dialogue with a user, and analyzes an attribute value for each of the attributes from an answer sentence from the user to a question sentence; a user data holding component that, as a result of analysis by the user speech analyzing component, holds user data that allows the plurality of attributes, and respective user attribute values for the attributes to correspond to one another; a matching component that, by referring to the user data, when an acquisition ratio of the attribute values from a received user answer sentence with respect to all of the attributes is a predetermined value or greater, selects at least one target data candidate that matches each of the attributes and each of the attribute values of the user data, from a plurality of target data; and a dialogue control component that outputs each of the target data candidates selected by the matching component, to the user's side.

A second aspect of the present invention is an information retrieving method. The information retrieving method includes: (a) posing, to a user, a question sentence about each of a plurality of attributes during a dialogue with the user, and analyzing an attribute value for each of the attributes from an answer sentence from the user to the question sentence; (b) holding, as a result of the analyzing in (a), user data in which the plurality of attributes and user attribute values for each of the attributes correspond with each other; (c) with reference to the user data, selecting at least one target data candidate that matches each of the attributes of the user data, and each of the attribute values, from a plurality of target data, when an acquisition ratio of the attribute values from a received user answer sentence with respect to all of the attributes is a predetermined value or greater; and (d) outputting each of the target data candidates selected in (c) to the user's side.

A third aspect of the present invention is a storage medium readable by a computer, the storage medium storing a program of instructions executable by the computer to perform a function for information retrieval. The function includes: (a) posing, to a user, a question sentence about each of a plurality of attributes during a dialogue with the user and analyzing an attribute value for each of the attributes from an answer sentence from the user to the question sentence; (b) holding, as a result of the analyzing in (a), user data in which the plurality of attributes and user attribute values for each of the attributes correspond with each other; (c) by referring to the user data, selecting, from a plurality of target data, at least one target data candidate that matches each of the attributes of the user data, and each of the attribute values, when an acquisition ratio of the attribute values from a received user answer sentence with respect to all of the attributes is a predetermined value or greater; and (d) outputting each of the target data candidates selected in (c) to the user's side.

A fourth aspect of the present invention is a dialog managing device. The dialog managing device includes: a dialogue scenario database in which a plurality of dialogue scenarios is stored; a scenario selecting component that selects a dialogue scenario for information requested by an information requesting component, from the dialogue scenario database; a response generating component that, based on the dialogue scenario selected by the scenario selecting component, generates a response sentence about the requested information and gives the response sentence to a user terminal; a behavior determining component that receives, as an analysis result of an answer sentence, an attribute and an attribute value for the attribute from an answer sentence analyzing component that analyzes a user answer sentence to the response sentence, retrieves at least one of the dialogue scenarios corresponding to a response condition based on the attribute and the attribute value, from the dialogue scenario database, and determines a next behavior in accordance with each of the dialogue scenarios; and a dialogue control component that effects control of a dialogue with a user in accordance with the next behavior determined by the behavior determining component.

A fifth aspect of the present invention is a dialogue managing method. The dialogue managing method includes: (a) selecting, from a dialogue scenario database, a dialogue scenario about information requested by an information requesting component; (b) preparing a response sentence for the requested information based on the dialogue scenario selected in (a), and giving the response sentence to a user terminal; (c) receiving, from an answer sentence analyzing component that analyzes a user answer sentence to the response sentence, an attribute and an attribute value for the attribute as an analysis result of the answer sentence, retrieving at least one of the dialogue scenarios, which corresponds to a response condition based on the attribute and the attribute value, from the dialogue scenario database, and determining the next behavior in accordance with each of the dialogue scenarios; and (d) effecting control of a dialogue with a user in accordance with the next behavior determined in (c).

A sixth aspect of the present invention is a storage medium readable by a computer, the storage medium storing a program of instructions executable by the computer to perform a function for dialogue management. The function includes: (a) selecting, from a dialogue scenario database, a dialogue scenario about information requested by an information requesting component; (b) based on the dialogue scenario selected in (a), preparing a response sentence for the requested information, and giving the response sentence to a user terminal; (c) receiving, from an answer sentence analyzing component that analyzes a user answer sentence to the response sentence, an attribute and an attribute value for the attribute, as a result of analysis of the answer sentence, retrieving at least one of the dialogue scenarios, which corresponds to a response condition, from the dialogue scenario database based on the attribute and the attribute value, and determining a next behavior in accordance with each of the dialogue scenarios; and (d) effecting control of a dialogue with a user in accordance with the next behavior determined in (c).

A seventh aspect of the present invention is a consciousness extracting system for extracting consciousness of a user based on dialogue information exchanged between the user and the system. The consciousness extracting system includes: a dialogue managing device that gives a response sentence to a user terminal of the user, receives an answer sentence to the response sentence, and effects a dialogue with the user in accordance with a predetermined dialogue scenario; an answer sentence analyzing device that analyzes the user answer sentence received from the user terminal; and a dialogue information accumulating device that allows accumulation of dialogue information of each of the dialogue scenarios, for each user, wherein the dialogue managing device includes: a dialogue scenario database in which a plurality of dialogue scenarios is stored; a scenario selecting component that selects a dialogue scenario for information requested by an information requesting component, from the dialogue scenario database; a response generating component that, based on the dialogue scenario selected by the scenario selecting component, generates a response sentence about the requested information and gives the response sentence to a user terminal; a behavior determining component that receives, as an analysis result of an answer sentence, an attribute and an attribute value for the attribute from an answer sentence analyzing component that analyzes a user answer sentence to the response sentence, retrieves at least one of the dialogue scenarios corresponding to a response condition based on the attribute and the attribute value, from the dialogue scenario database, and determines a next behavior in accordance with each of the dialogue scenarios; and a dialogue control component that effects control of a dialogue with a user in accordance with the next behavior determined by the behavior determining component.

An eighth aspect of the present invention is an information extracting device. The information extracting device includes: a knowledge database that allows systematic classification of relationships between a plurality of words in a plurality of fields; an input component that takes in input information; an information extracting component that, if an attribute to be extracted, included in the input information is detected, extracts an attribute value for the attribute included in the input information using knowledge in a field relating to the attribute in the knowledge database; and an extracted information storing component that stores therein the attribute and the attribute value of the attribute, extracted from the information extracting component, so that the attribute and the attribute value correspond to each other.

A ninth aspect of the present invention is an information extracting method. The information extracting method includes: (a) taking in input information; (b) when an attribute to be extracted, which is included in the input information, is detected, extracting an attribute value for the attribute included in the input information using knowledge of a field relating to the attribute in a knowledge database; and (c) storing the attribute and the attribute value of the attribute extracted in (b) so that the attribute and the attribute value correspond to each other.

A tenth aspect of the present invention is a storage medium readable by a computer, the storage medium storing a program of instructions executable by the computer to perform a function for information extraction. The function includes: (a) taking in input information; (b) extracting, when an attribute to be extracted, which is included in the input information, is detected, an attribute value for the attribute included in the input information using knowledge of a field relating to the attribute in a knowledge database; and (c) storing the attribute and the attribute value of the attribute extracted in (b) so that the attribute and the attribute value correspond to each other.

An eleventh aspect of the present invention is a dialogue system that has a dialogue with a human by transmitting and receiving data of a natural language sentence between the human and a device that interfaces with the human, The dialogue system includes: an analyzing section that analyzes a speech of the human; a target place authorizing section that authorizes target places at which elements used to produce a speech by the system are extracted from the speech of the human, by using the analysis result; and an extracting section that extracts, from the target place, elements from the human speech so that a system speech has a proper length.

A twelfth aspect of the present invention is a dialogue method of having a dialogue with a human by transmitting and receiving data of a natural language sentence between a dialogue system and a device that interfaces with the human. The dialogue system includes an analyzing section, a target place authorizing section and an extracting section. The dialogue method includes: the analyzing section analyzing a speech of the human; the target place authorizing section using the analysis result, and authorizing a target place used to extract elements used by the system to produce a speech, from the human speech; and the extracting section extracting, from the target place, elements from the human speech so that the system speech has a proper length.

A thirteenth aspect of the present invention is a storage medium readable by a computer, the storage medium storing a program of instructions executable by the computer to perform a function for a dialogue. The function includes: analyzing a speech of a human; authorizing a target place used to extract, from the human speech, elements used by the computer to produce a speech, by using the analysis result; and extracting, from the target place, elements from the human speech so that the speech of the computer has a proper length.

According to the first to third aspects of the present invention, user's precedence and a current matching condition are precisely determined in a dialogue with a user, an optimum matching result can be acquired therefrom, and with reference to the matching result, a precise retrieval result can be obtained.

According to the fourth to seventh aspects of the present invention, in the process of smoothly extending dialogue between a user and a system and developing the dialogue, a feeling of security or feeling of trust is imparted to the user, thereby making it possible to extract the user's original consciousness.

According to the eighth to tenth aspects of the present invention, it is possible to extract proper information from a variously extended dialogue with a user.

According to the eleventh to thirteenth aspects of the present invention, in accordance with expressions in the speech of a human being, position of the elements used for producing a system's response, a length (number of words) of the response, and the like are changed, so that the feeling of sympathy for a human being can be sufficiently produced and a natural dialogue (response) can be realized.

### BRIEF DESCRIPTION OF THE DRAWINGS

FIG. 1 is a structural diagram showing an internal structure of a matching managing device according to a first embodiment of the present invention.

FIG. 2 is a structural diagram showing an overall construction of a laddering type retrieving system according to the first embodiment of the present invention.

FIG. 3 is a structural diagram showing the structure of a laddering search engine of the first embodiment of the present invention.

FIGS. 4A and 4B are structural diagrams each showing the structure of user data of the first embodiment of the present invention.

FIGS. 5A and 5B are structural diagrams each showing the structure of object data of the first embodiment of the present invention.

FIGS. 6A and 6B are structural diagrams each showing the structure of domain knowledge of the first embodiment of the present invention.

FIG. 7 is a flow chart showing a matching managing process of the first embodiment of the present invention.

FIG. 8 is a diagram showing a display example of a question sentence of the first embodiment of the present invention.

FIG. 9 is a diagram showing a display example of a question sentence of the first embodiment of the present invention.

FIGS. 10A to 10C are explanatory diagrams showing attribute determination rules of the first embodiment of the present invention.

FIG. 11 is a diagram of a display example that shows speech analysis display and matching results in the display example of a question sentence of the first embodiment of the present invention.

FIG. 12 is a structural diagram showing an internal constitution of a dialogue control component of a second embodiment of the present invention.

FIG. 13 is a structural diagram showing an internal constitution of a dialogue control component of the second embodiment of the present invention.

FIG. 14 is a structural diagram showing the structure of a dialogue scenario database of the second embodiment of the present invention.

FIGS. 15A and 15B are a flow chart showing a dialogue control process of the second embodiment of the present invention.

FIGS. 16A and 16B are a flow chart showing a behavior determining process of the second embodiment of the present invention.

FIG. 17 is a diagram showing a structural example of interactive sentences of the second embodiment of the present invention.

FIGS. 18A and 18B are structural diagrams each showing a scenario structure of the second embodiment of the present invention.

FIGS. 19A and 19B are structural diagrams each showing a scenario structure of the second embodiment of the present invention.

FIG. 20 is an explanatory diagram that illustrates schematic proceeding of a laddering dialogue in a laddering dialogue engine of the second embodiment of the present invention.

FIGS. 21A and 21B are an example of a display screen shown in a user terminal (browser) of the second embodiment of the present invention.

FIG. 22 is a structural diagram showing an internal constitution of an information extracting device according to a third embodiment of the present invention.

FIGS. 23A and 23B are structural diagrams each illustrating the structure of an ontology of the third embodiment of the present invention.

FIG. 24 is a flow chart showing information extracting processing of retrieval object data in the third embodiment of the present invention.

FIGS. 25A and 25B are portions of a diagram showing a structure example of retrieval object data in the third embodiment of the present invention.

FIG. 26 is a flow chart showing information extracting processing of a user input sentence in the third embodiment of the present invention.

FIG. 27 is a diagram showing a structure example of user input sentences in the third embodiment of the present invention.

FIG. 28 is a diagram showing the relationship between attributes and ontology that is referenced in the third embodiment of the present invention.

FIG. 29 is a functional block diagram showing a main structure of a dialogue system according to a fourth embodiment of the present invention.

FIG. 30 is a flow chart showing the operation of a dialogue system according to the fourth embodiment of the present invention.

FIG. 31 is an explanatory diagram showing a result of morphological analysis for a user's speech, “hito/to/sesshi/nagara/jibun/ga/ninngenn/toshite/seichou/dekiru/shigoto/ga/shi/tai(JP:Japanese)/I hope to do the job that I can grow up as a human while contacting other people(EN: English)”.

FIG. 32 is an explanatory diagram showing a result of syntactic analysis for the user's speech, “hito/to/sesshi/nagara/jibun/ga/ninngenn/toshite/seichou/dekiru/shigoto/ga/shi/tai(JP)/I hope to do the job that I can grow up as a human while contacting other people(EN)”.

FIG. 33 is an explanatory diagram showing a special expression list for authorization embedded in a target place authorizing section in the fourth embodiment of the present invention.

FIG. 34 is an explanatory diagram showing a special expression list for extraction embedded in the extracting section in the fourth embodiment of the present invention.

FIG. 35 is a functional block diagram showing a main structure of a dialogue system according to a fifth embodiment of the present invention.

FIG. 36 is a functional block diagram showing a main structure of a dialogue system according to a sixth embodiment of the present invention.

FIG. 37 is a functional block diagram showing a main structure of a dialogue system according to a seventh embodiment of the present invention.

FIG. 38 is a functional block diagram showing a main structure of a dialogue system according to an eighth embodiment of the present invention.

### DETAILED DESCRIPTION OF THE INVENTION

### (A) First Embodiment

Referring now to the attached drawings, an information retrieving device, an information retrieving method and an information retrieving program of the first embodiment of the present invention will be described hereinafter in detail.

In the first embodiment, a case in which an information retrieving device, an information retrieving method and an information retrieving program of the present invention are used and applied to an information analyzing/information retrieving system in which, for example, a predetermined attribute and an attribute value are extracted from information that a user is conscious of and retrieval object information by employing a laddering type retrieval service, and information that matches the information that the user is conscious of is retrieved and introduced, is exemplified.

### (A-1) Structure of First Embodiment

### (A-1-1) Description of Overall Construction of Laddering Type Retrieving System

First, an overall image of a laddering type retrieving system using the information retrieving device, the information retrieving method and the information retrieving program of the present invention is hereinafter described with reference to the attached drawings.

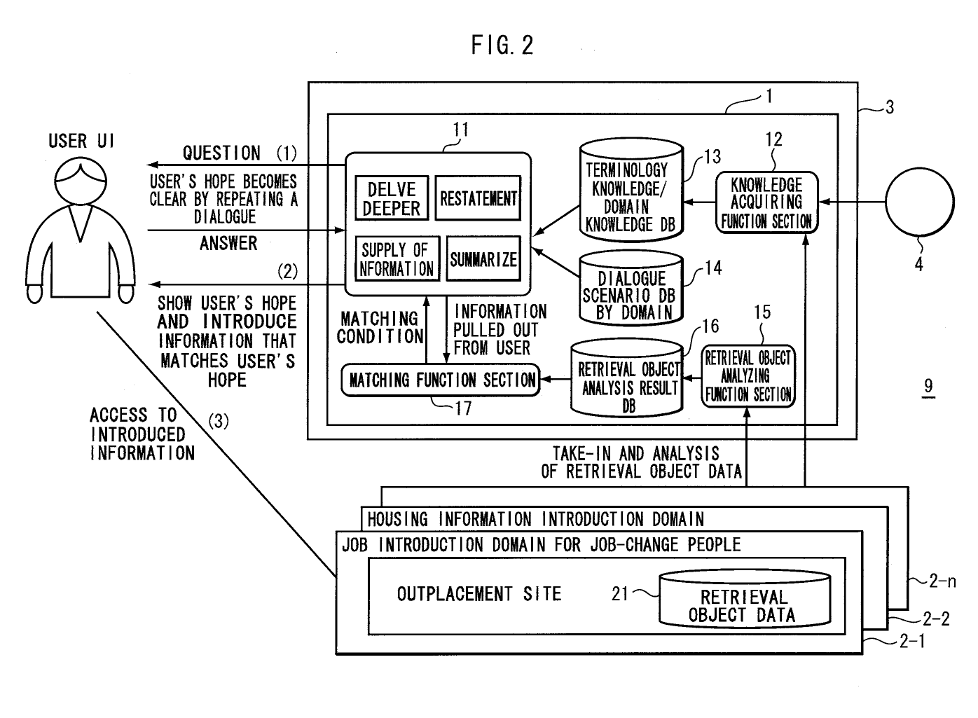

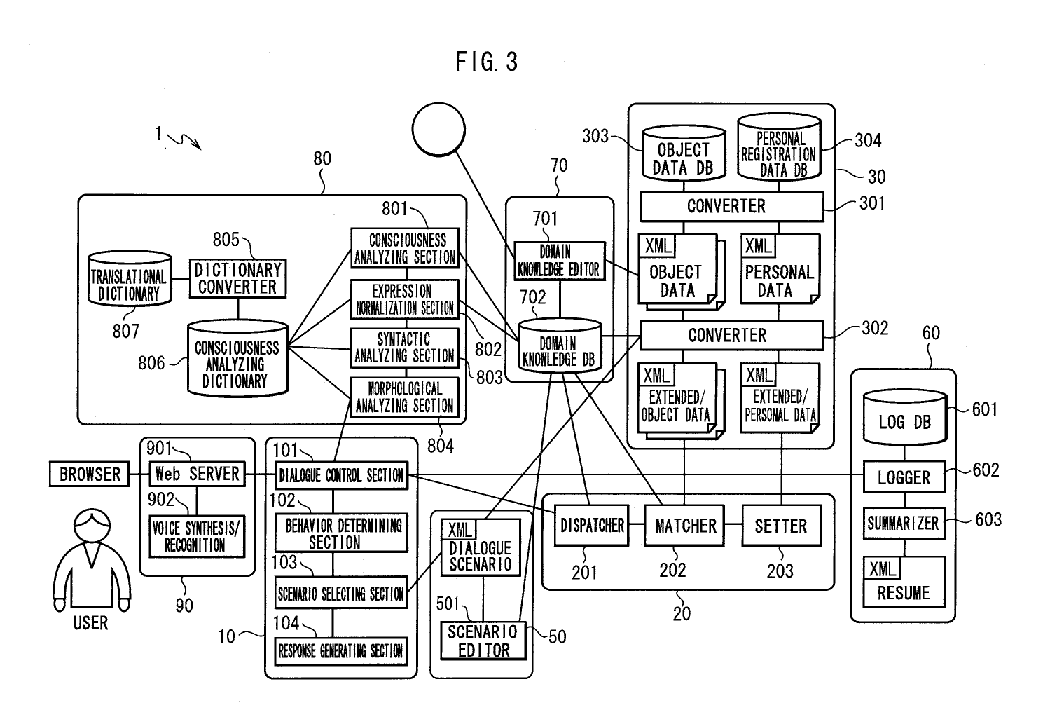

FIG. 2 is an overall image diagram that illustrates an overall image of a laddering type retrieving system 9 of the first embodiment. Further, FIG. 3 is a structural diagram showing the structure of a laddering search engine 1 that realizes the laddering type retrieving system 9.

In FIG. 2, the laddering type retrieving system 9 of the first embodiment is constituted by a laddering type retrieving service site 3 having a laddering dialogue engine 1, a service site 2 that provides various services (2-1 to 2-n; n is a positive integer), and Web information 4 that exists on a network, all of which can be connected together via the network.

User Interface (UI) component 90 has a Web server 901 that is accessible to a user terminal (browser) operated by a user UI and that provides a laddering type retrieval service. Further, User Interface (UI) component 90 has, if necessary, a speech synthesis/recognition section 902, and if information from the user UI is voice information, a dialogue can be realized by voice.

The laddering dialogue engine 1 poses questions to the user U1, analyzes the answer of the user U1 to each of the questions, thereby pursuing a dialogue with the user U1, and then analyzes consciousness that the user U1 really expects.

In any embodiments of the present invention, the terms “conscious” and “consciousness” may represent a “potential need” or a “genuine desire”. Human beings sometimes have a feeling such as a vague desire, requirement, or expectation, although they do not recognize that they have such feeling or they cannot explain or describe the feeling explicitly. The terms “conscious” and “consciousness” represent such feeling.

Further, the laddering dialogue engine 1 acquires information provided by the service site 2, or Web information 4 as retrieval object information, extracts an attribute and an attribute value corresponding thereto from the information from the service site 2 or Web information 4, retrieves information having an attribute value corresponding to response information from the user U1, and introduces to the user U1 information having an attribute value corresponding to the consciousness of the user U1.

The term “laddering” means a technique of bringing out needs or value judgments of a speech partner due to repetition of questions that gradually delve deeper in the dialogue with the speech partner.

As the type of the dialogue with a user, performed by the laddering dialogue engine 1, for example, question types such as a “YES/No” type from the system to the user, a “selection from options” type, a question type that allows a user to make a free answer, a question type that prompts a user to make voluntary remarks by agreeing or restating with respect to an answer of the user, and the like can be applied.

In FIG. 2, the laddering type dialogue engine 1 has a knowledge acquiring function section 12 that acquires, via the network, information used to bring out information used for pursuing a dialogue from the service site 2 or Web information 4, or consciousness information used for bringing out the consciousness of the user U1, and a terminology knowledge/domain knowledge database 13 in which knowledge information acquired by the knowledge acquiring function section 12 is stored.

Further, the laddering dialogue engine 1 has, depending on the type of the service site 2 that is connectable via the network, a domain-divisional dialogue scenario database 14 in which scenarios used to pursue a dialogue are stored by domains.

Moreover, the laddering dialogue engine 1 has a laddering dialogue control function section 11 that pursues a dialogue with the user U1 while referring to the terminology knowledge/domain knowledge database 13 and the domain-divisional dialogue scenario database 14.

At this time, the laddering dialogue control function section 11 effects processing of “delving deeper” in which a more deeply delving question is posed to a user in order to clarify the consciousness of the user, or questions are posed to confirm the consciousness of the user, “restating” in which a user's answer is restated, or feeling-expressive questions are posed to a user in order to increase motivation for speech, “provision of information” that provides various information to a user in order to impart a feeling of satisfaction or expectation to the user, “summarization” in which information obtained in the past is summarized and reused, and the like.

Furthermore, the laddering dialogue engine 1 has a retrieval-object analyzing function section 15 that analyzes retrieval-object data from retrieval-object data 21 in each service site 2, and also has a retrieval-object analysis result database 16 in which a retrieval-object analysis result analyzed by the retrieval-object analyzing function section 15 is stored.

The laddering dialogue engine 1 extracts information that matches the answer analysis result (information pulled out from the user U1) of the user U1, which is analyzed by the laddering dialogue control function section 11, and the matching condition is given to the laddering dialogue control function section 11.

Various service sites 2-1 to 2-n are service sites that each provide various information to the user via the network.

The various service sites 2-1 to 2-n respectively correspond to service domains of various enterprises and organizations, for example, domain sites provided by enterprises, such as a job-search domain for people changing jobs, a housing information introduction domain, a domain of various shopping sites, a domain of travel planning/personal navigation, a domain of content industries such as broadcasting, movies and the like, community sites such as so-called blogs, SNS (social network sites) or the like, domain sites of government ministries and agencies, and domain sites provided by enterprises and organizations that offer searches and counseling (for example, medical practice, health care, welfare, and questionnaire surveying, and the like).

Web information 4 is Web information existing on the network, and is also information which the laddering dialogue engine 1 can access via the network.

Next, with reference to FIG. 3, the internal structure of the laddering dialogue engine 1 is described.

In FIG. 3, the laddering type dialogue engine 1 includes at least a dialogue managing component 10, a matching component 20, a matching-object analyzing component 30, a scenario managing component 50, a correspondence result summarizing component 60, a domain knowledge acquiring component 70, a user speech analyzing component 80, and a user interface (UI) component 90.

In any embodiments of the present invention, a “speech” may be a phrase spoken by a user which is input via an input means such as a microphone, a phrase which is input by a user via a keyboard. This also applies to a “dialogue” and an “answer” and the like.

The dialogue managing component 10 is used to control processing in the laddering dialogue engine 1. The dialog managing component 10 operates in such a manner as to pose various questions in a repeated manner to the user U1 who desires retrieval, accumulate answers from the user to these questions (dialogue contents), and integrate the accumulated dialogue logs, whereby information that the user is really conscious of is brought out, and information or content that match the information that the user is conscious of are retrieved, so as to be introduced to the user U1.

The dialogue managing component 10 has, as main functions, at least a dialogue control section 101 in which a question is posed to the user U1, and based on the analysis result of the answer from the user U1, next dialogue is pursued, so as to execute dialogue control, a behavior determining section 102 in which a question is posed to the user U1 in accordance with a scenario relating to the dialogue, and based on the answer from the user U1, change of the scenario is made, or the like, a scenario selecting section 103 in which a scenario having no feeling of strangeness for the dialogue with the user U1 is selected from the scenario managing component 50, and a response generating section 104 in which based on the scenario selected by the scenario selecting section 103, a response sentence to the answer from the user U1 is generated.

The matching component 20 is used to receive the analyzed result of the user U1's answer, that is analyzed by the dialogue managing component 10 (information brought out from the user U1) from the dialogue managing component 10, and carry out matching of the received analysis result with information acquired from the service site 2.

The matching component 20 has, as main functions, at least a dispatcher 201 that provides the analyzed result of the user U1's answer received from the dialogue control section 101 to a matcher 202 and further provides information matched by the matcher 202 to the domain knowledge acquiring component 70, the matcher 202 that effects matching processing between object data and personal registration data and further effects matching processing between the analyzed result of the user U1's answer and retrieval information of the service site 2, and a setter 203 that makes a determination about an object to be retrieved from the service site 2 based on the analyzed result of the user U1's answer.

The matching-object analyzing component 30 converts matching-object data (that is, information regarding an attribute about a question to be posed to the user U1) or personal registration data into a predetermined data format, and further effects extension processing of the matching-object data and personal registration data using a dialogue result or domain knowledge.

The matching-object analyzing component 30 has, as main functions, at least an object data DB (data base) 303 in which object data intended for matching, showing an attribute, is stored, a personal registration data DB 304 in which personal registration data of the user U1 is stored, a converter 301 that allows object data and personal registration data stored in the object data DB 303 and the personal registration data DB 304, respectively, to be converted to a predetermined data format, and an enhancer 302 that, based on domain knowledge or log information of the dialogue result, allows data converted by the converter 301 into a predetermined data format to be further converted to data extending to similar data, related data and the like.

The domain knowledge acquiring component 70 is used to acquire, via the Web, domain information and knowledge information provided on the service site 2, from the service site 2 or other Web information 4.

The domain knowledge acquiring component 70 has a domain knowledge editor 701 that acquires domain knowledge information (that is, vocabulary) regarding the field to be retrieved via the Web, provides the acquired domain knowledge information (hereinafter referred to merely as domain knowledge) to the matching-object analyzing component 30, and converts it into a predetermined data format, and also has a domain knowledge DB 702 in which the domain knowledge converted into a predetermined data format is stored as a systematic aggregate (hereinafter occasionally referred to as ontology).

The scenario managing component 50 is used to generate and manage a scenario for each domain while referring to the domain knowledge DB 702. The scenario managing component 50 has a scenario editor 501 that generates a scenario used to have a dialogue with the user U1 while referring to the domain knowledge DB 702, and in accordance with control of the behavior determination section 102 of the dialogue managing component 10, changes the scenario or effects editing of the scenario. The scenario editor 501 allows, in the dialogue scenario with the user, a dialogue scenario based on the object data having extended contents in cooperation with the enhancer 302 of the matching-object analyzing component 30. Further, the dialogue scenario generated by the scenario editor 501 is selected by the scenario selecting section 103.

The dialogue result summarizing component 60 has a log DB 601 in which logs exchanged in the dialogue between the system and the user U1 are stored, a logger 602 that reads out log information stored in the log DB 601 under the control of the dialogue control section 101 and provides the information to the dialogue control section 101, and a summarizer 603 that effects summarizing processing for the answer of the user U1 using extension/object data and extension/personal data.

The user speech analyzing component 80 is used to input the answer of the user U1 via the dialogue control section 101, and based on the input answer information of the user U1, analyze information that the user is conscious of. Further, the user speech analyzing component 80 is used to provide analysis information that the user is conscious of as analyzed above, to the dialogue control section 101.

As shown in FIG. 3, the user speech analyzing component 80 has, as main functions, at least a consciousness analyzing section 801, an expression normalization section 802, a syntactic analyzing section 803, a morphological analyzing section 804, a dictionary converter 805, a consciousness analyzing dictionary 806, and a translational dictionary 807.

The consciousness analyzing dictionary 806 is used to store therein various information required for analysis of consciousness. In FIG. 3, for convenience of explanation, the consciousness analyzing dictionary 806 is shown as a single dictionary, but is intended as required for analysis of consciousness, and for example, this dictionary has morpheme information, syntactic information, normalization information and the like stored therein. Further, the translational dictionary 807 has translation information stored therein.

The dictionary converter 805 is used, if necessary, to effect translation processing of information stored in the consciousness analyzing dictionary 806 while referring to the translational dictionary 807 and the consciousness analyzing dictionary 806.

The morpheme analyzing section 804 is used to acquire, from the dialogue control section 101, response information of the user U1 or retrieval object information from the service site 2 or the like, and effect morphological analysis while referring to the consciousness analyzing dictionary for the response information of the user U1 or the retrieval object information from the service site 2 or the like.

The syntactic analyzing section 803 is used to, based on the result of morphological analysis from the morpheme analyzing section 804, effect syntactic analysis for the answer information of the user U1 or the retrieval object information from the service site 2 or the like while referring to the consciousness analyzing dictionary 806.

The expression normalization section 802 is used to form normalized expression for the result of syntactic analysis from the syntactic analyzing section 803 while referring to the consciousness analyzing dictionary 806 and the domain knowledge DB 702.

The consciousness analyzing section 801 is used to extract consciousness information that the user is conscious of, contained in the response information of the user U1, while referring to the consciousness analyzing dictionary 806 and the domain knowledge DB 702. The user consciousness information extracted by the consciousness analyzing section 801 is stored via the dialogue control section 101 in the personal registration data DB 304 of the matching object analyzing component 30.

### (A-1-2) Matching Managing Device

Next, a matching managing device according to the first embodiment is described in detail with reference to the attached drawings.

Further, a case in which the service site 2 is a job-introduction domain site for people changing jobs is explained below as an example.

The matching managing device of the first embodiment is, preferably, realized so as to have the function in which with the matching component 20 serving as the center, the dialogue managing component 10, the user speech analyzing component 80 and the matching object analyzing component 30 are in cooperation with one another in the aforementioned laddering dialogue engine 1.

Of course, in the aforementioned laddering dialogue engine 1, the dialogue managing component 10 is used to introduce information corresponding to the user's consciousness while having a dialogue with the user by a laddering technique in cooperation with the various components 20 to 90, and therefore, positions at which the matching management processing is realized, which will be described below, are not particularly limited.

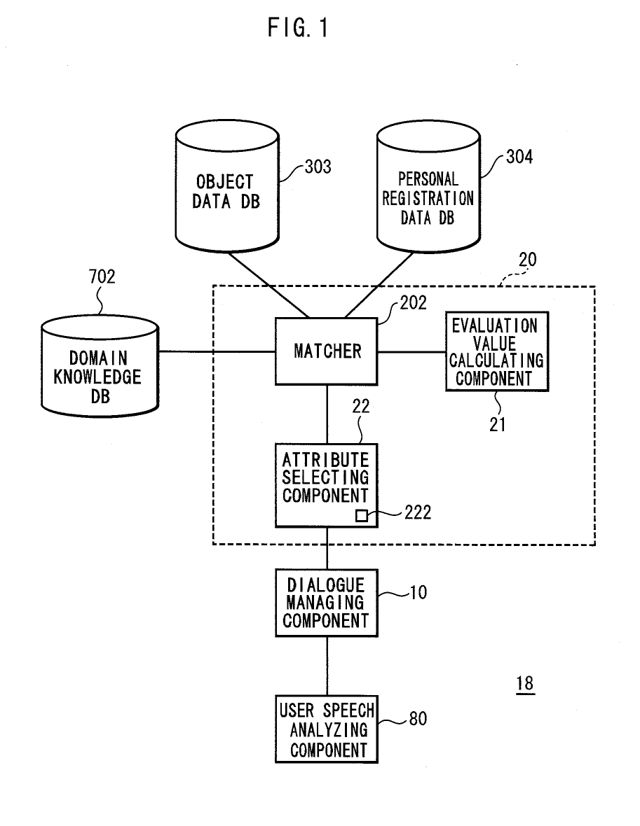

FIG. 1 is a structural diagram showing the structure of the matching managing device 18 of the first embodiment. In FIG. 1, the matching managing device 18 of the first embodiment is realized in such a manner that the matcher 22, an evaluation value calculating component 21, an attribute selecting component 22, a dialogue managing component 10, a user speech analyzing component 80, an object data database (DB) 303, a personal registration data database (DB) 304, and a domain knowledge database (DB) 702 are at least in cooperation with one another.

Further, the matcher 202, the evaluation value calculating component 21, and the attribute selecting component 22 correspond to the functional structure of the matching component 20 of the aforementioned laddering dialogue engine 1. For example, the evaluation value calculating component 21 and the attribute selecting component 22 are preferably made to have the function of the dispatcher 201.

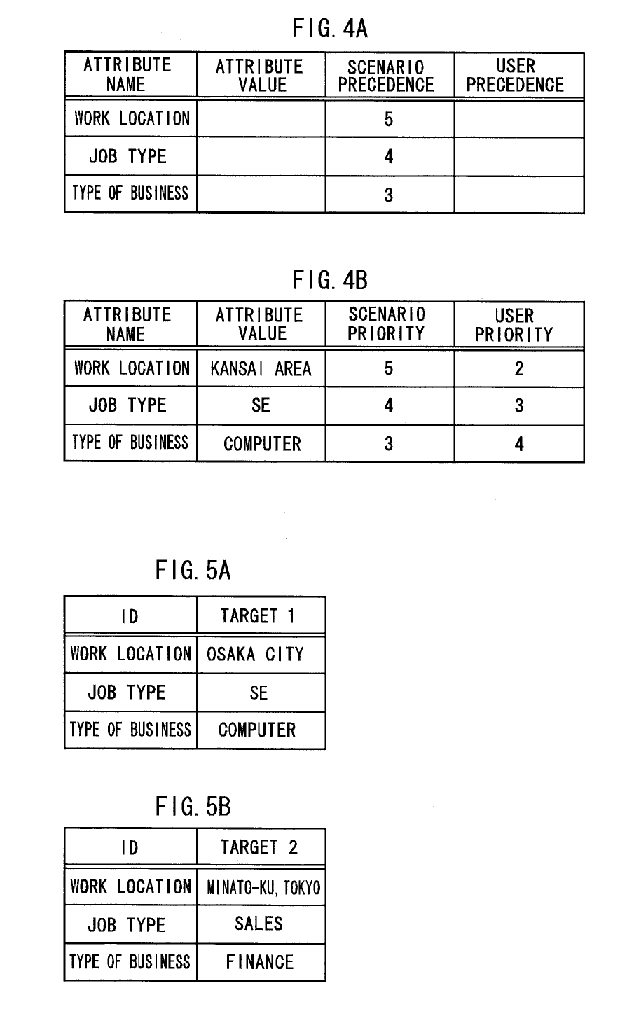

The personal registration data DB 304 is a database that holds personal registration data of the user. FIGS. 4A and 4B are structural diagrams each showing a structural example of user data held in the personal registration data DB 304. As shown in FIGS. 4A and 4B, items of the user data include “attribute name”, “attribute value”, “scenario precedence”, and “user precedence”.

The “attribute name” mentioned above is the name of an attribute used for retrieval of information, and is an attribute value of a user for the attribute. The “scenario precedence” mentioned above means an order of posing a question to the user, which is set in the dialogue scenario that pursues the dialogue. In FIGS. 4A and 4B, the larger the numeric character is, the higher the precedence is. The “user precedence” is the precedence of the attributes obtained from the user's answer. In FIGS. 4A and 4B, the larger the numeric character is, the higher the precedence of the user is. Further, the attribute value obtained by the dialogue with the user is embedded in the user data.

The object data DB 303 is a database that holds retrieval object data acquired from the service site 2 via the network.

FIGS. 5A and 5B are structural diagrams showing structural examples of object data held in the object data DB 303. FIGS. 5A and 5B show structural examples of the object data as job-change information, and examples thereof include “ID”, “work location”, “type of job”, “kind of industry” and the like.

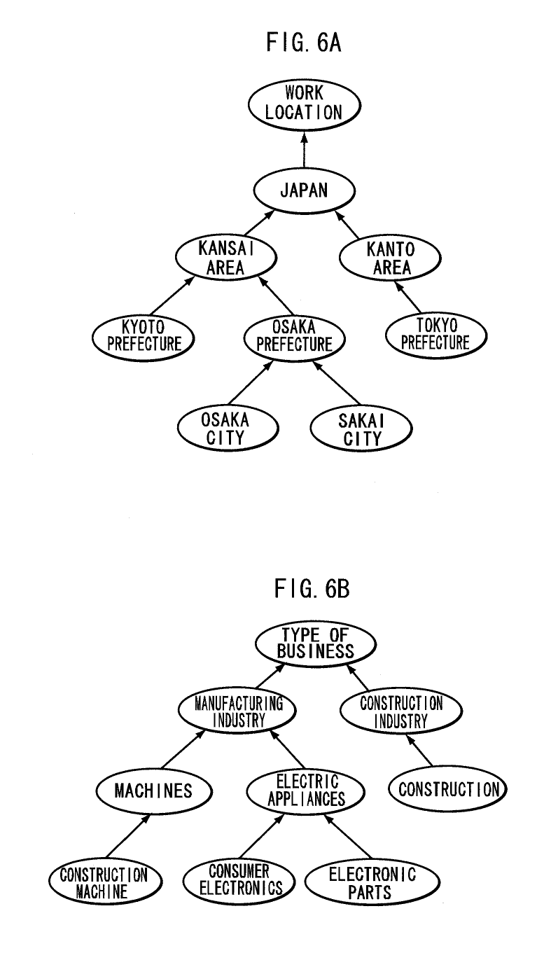

The domain knowledge DB 702 is a database that holds domain knowledge. FIGS. 6A and 6B are structural diagrams showing structural examples of domain knowledge held in the domain knowledge DB 702. As shown in FIGS. 6A and 6B, the domain knowledge is constituted by an ontology that allows systematic classification of knowledge regarding a plurality of terms.

For example, FIG. 6A is an example of the ontology of work location, and FIG. 6B is an example of the ontology of the kind of industry. FIG. 6A shows case in which, for example, regarding the attribute “work location”, “Kansai (area)” and “Kanto (area)” are linked as the narrower concept of “Japan (nation name)” which is the broader concept. Further, FIG. 6A also shows a case in which the “Kansai (area)” is shown as the broader concept, and “Kyoto (prefecture)” and “Osaka (prefecture)” which are the narrower concepts thereof are linked to “Kansai (area)”. In this way, the knowledge held in FIGS. 6A and 6B is configured in such a manner that the broader concept terms and the narrower concept terms are linked together in a parent-child relationship.

The evaluation value calculating component 21 is used to calculate an evaluation value based on the result of matching by the matcher 202. When an evaluation value is calculated by the evaluation value calculating component 21, a ratio of an attribute value set in the user data (a property ratio of the user) is calculated as the evaluation value.

The attribute selection component 22 is used to determine items of conditions that the user hopes for, which are required for narrowing down data most precisely by viewing the result of matching by the matcher 202, user data or the evaluation value. The determined items are given to the dialogue managing component 10. As a result, the dialogue managing component 10 is used to pose questions for items determined by the attribute selecting component 22, to the user. A method of determining items by the attribute selecting component 22 will be described in detail in the section regarding operation.

In a case in which the attribute selecting component 22 refers to user data and, for example, the user data includes no attribute value embedded therein, the attribute name having a high precedence from among attributes having no attribute value embedded therein is provided to the dialogue managing component 10. A question for the attribute name having a high precedence can be posed to the user and the attribute value can be acquired. Further, as the precedence as mentioned above, scenario precedence and user precedence are shown, but the scenario precedence is given priority.

Further, in a case in which the attribute selecting component 22 refers to user data, and the attribute values are embedded in the user data to some degree, the attribute name having the greatest number of descendants among the user data is given to the dialogue managing component 10.

Further, in the case in which the attribute selecting component 22 has a small number of object data to be matched, matching is performed on the condition that only one non-matched data may exist, and the attribute name that is not matched from the data of which evaluation value is highest is given to the dialogue managing component 10. This process will be described in detail in the section regarding operation.

### (A-2) Operation of First Embodiment

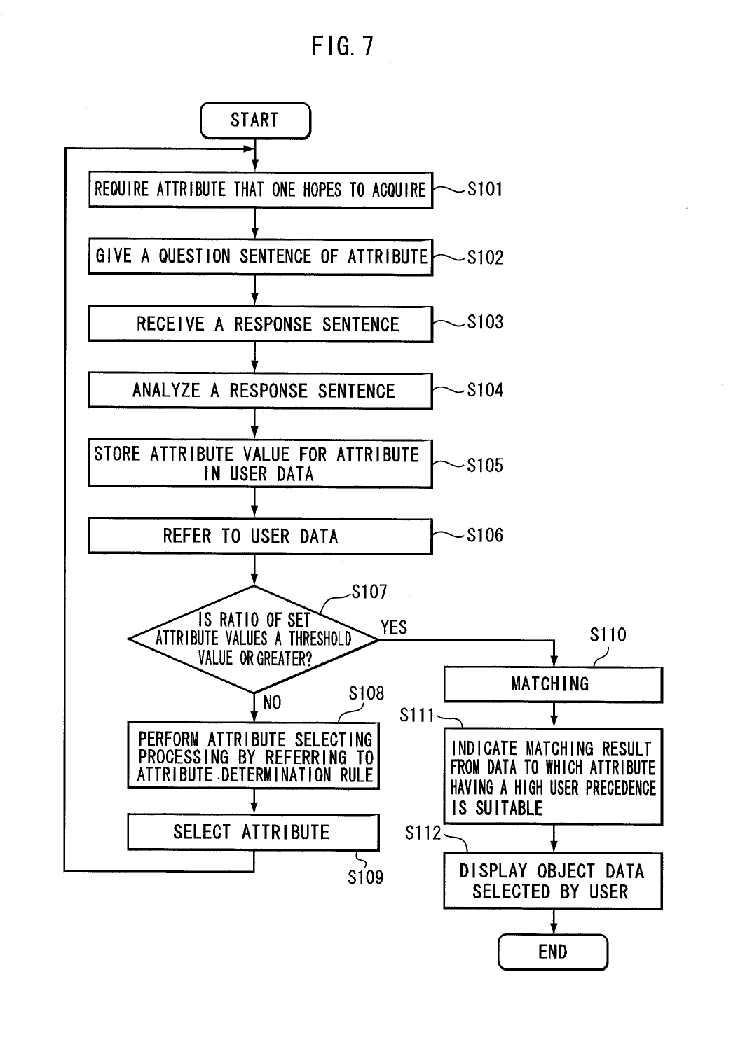

Next, the matching managing processing of the first embodiment will be described with reference to the attached drawings. FIG. 7 is a flow chart showing the matching managing processing of the first embodiment.

First, the attribute selecting component 22 requests the attribute that the user hopes to acquire, to the dialogue managing component 10 (step S101). At this time, an initial attribute that the attribute selecting component 22 requests to the dialogue managing component 10 may be previously set as a default, or may also be an attribute of ontology that is randomly selected by referring to the domain knowledge DB 702.

Upon receiving a request from the attribute selecting component 22, the dialogue managing component 10 generates a question sentence that inquires the attribute value of the attribute so as to acquire the attribute value for the required attribute from the user, and gives the question sentence to the user (step S102).

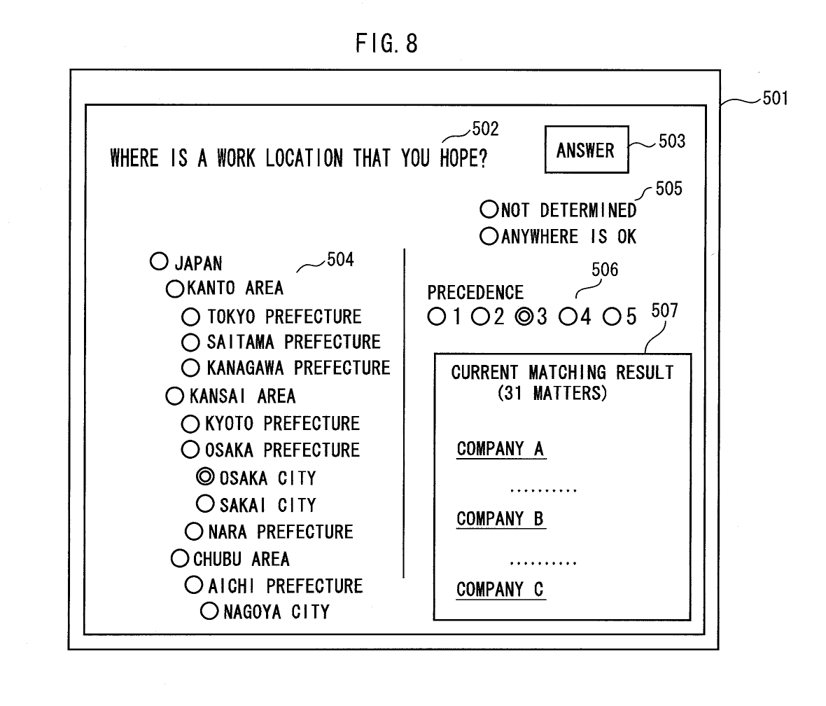

FIG. 8 shows a display example 501 when the question sentence from the dialogue managing component 10 is displayed on the browser of the user (on the user terminal). FIG. 8 exemplifies a case in which the attribute inquired to the user is the “work location”.

The display example 501 of the question sentence shown in FIG. 8 has at least a question sentence 502, an answer button 503, a work location selection indicating section 504, an intention indicating section 505, a precedence applying indicating section 506 and a matching result indicating section 507.

The question sentence 502 has a portion in which the question sentence given from the laddering dialogue engine 1 is displayed, and the user gives an answer to the question sentence. When the user gives an answer, he/she selects a desired work location from among the work location options displayed in the work location selection indicating section 504. In this drawing, the case in which “Osaka City” is selected is shown.

Further, in retrieval of the attribute (that is, “work location”) for changing jobs, in order to comprehend what degree of importance the consciousness has for the user, the intention indicating section 505 and the precedence addition indicating section 506 are provided.

The intention indicating section 505 shows information used to know the user's consciousness for the attribute such as “not determined”, “anything” or the like. Further, in the precedence addition indicating section 506, the user can select the precedence for the attribute. Incidentally, the method of setting the precedence is not particularly limited and various methods can be applied. In this case, for example, the precedence “3” means a “standard level”, and as the value increases, the precedence of the attribute becomes higher in the retrieval of new jobs.

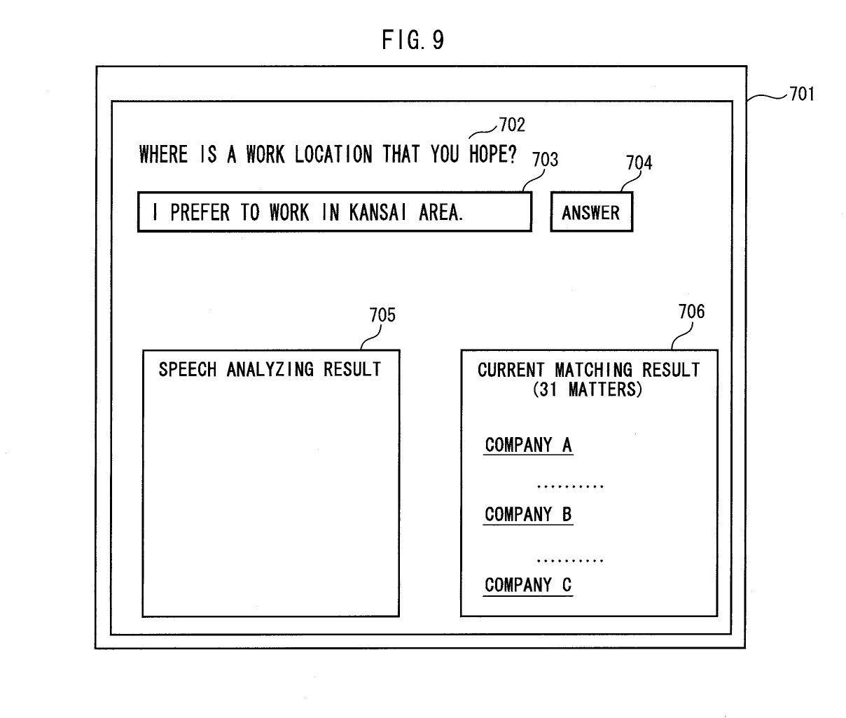

Further, FIG. 9 shows an example of display of another question sentence different from that of FIG. 8. In the display example 701 shown in FIG. 9, an input section 703 in which the user inputs natural language is provided for the question sentence 702. In this case, after the user inputs, in the input section 703, an answer to the question sentence 720, the user selects the answer button 704 to send back the answer sentence. The display example shown in FIG. 9 has a speech analysis result indicating section 705 and a matching result indicating section 706.

When the user gives an answer to the question sentence shown in FIG. 8 or FIG. 9 by way of example, the answer sentence is given to the dialogue managing component 10 (step S103). Further, the answer sentence is given from the dialogue managing component 10 to the user speech analyzing component 80, and is analyzed by the user speech analyzing component 80 (step S104). As a result, the attribute included in the answer sentence is made to correspond to the attribute value of the attribute, and is stored in the user data (step S105).

When the attribute and the attribute value of the attribute are stored in the user data, the attribute selecting component 22 refers to the user data (step S106), and makes a determination as to whether the ratio of the attribute value stored in the user data is a threshold value or greater (step S107).

Then, in a case in which the ratio of the attribute value stored in the user data is less than the threshold value, the attribute selecting component 22 refers to the attribute determination rule 222, and performs attribute selecting processing corresponding to an evaluation value of the attribute value stored in the user data (step S108).

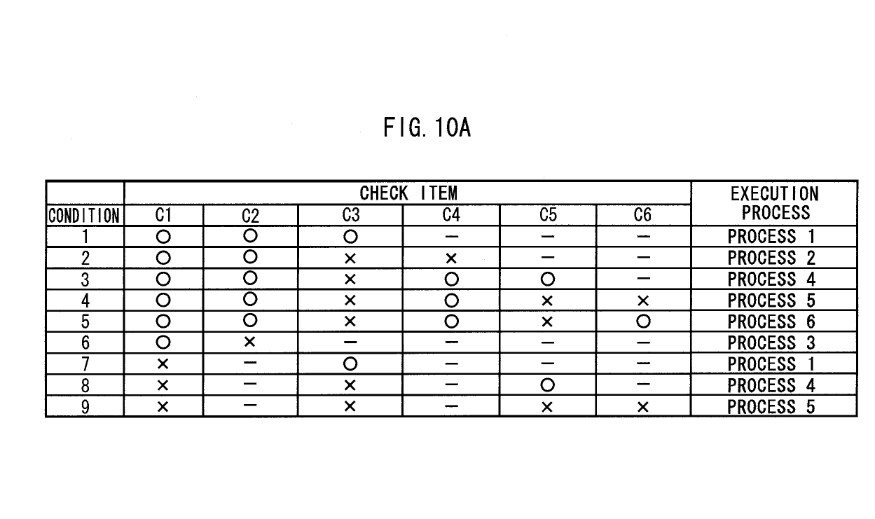

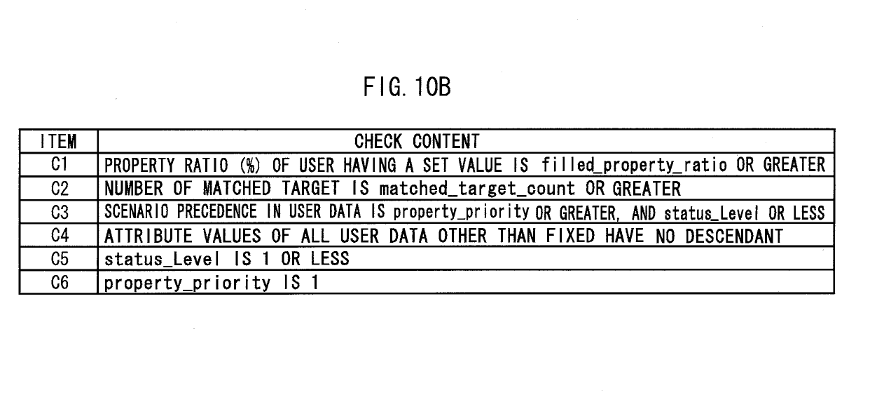

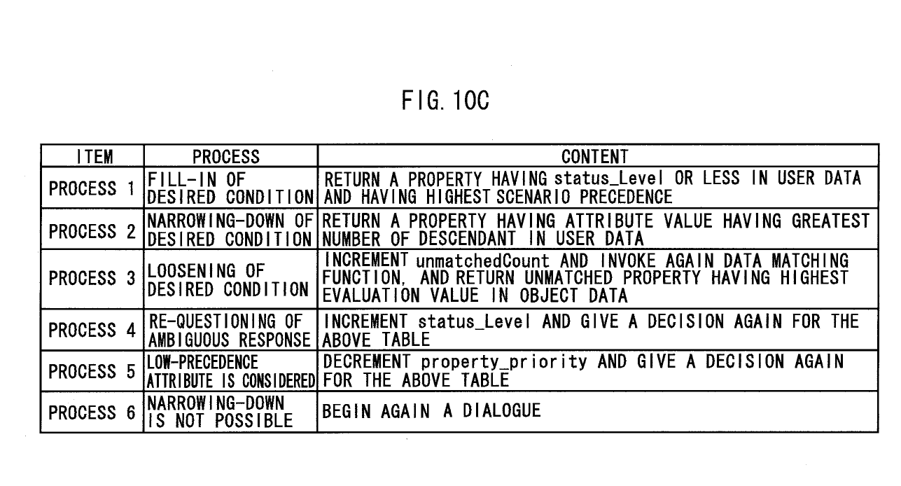

FIGS. 10A to 1-C are illustrative diagrams showing the attribute determination rule 222. FIG. 10A shows the structural example of the attribute determination rule 222, FIG. 10B shows definition contents of check items of the attribute determination rule 222, and FIG. 10C shows definition contents of execution processing of the attribute determination rule 222.

FIG. 10A shows rules which, when they correspond to nine conditions, condition 1 to condition 9, allow corresponding execution processing (processing 1 to processing 6) to be executed. In FIG. 10A, “o” indicates a case in which the rule corresponds to the check item, “x” indicates a case in which the rule does not correspond to the check item, and “--” indicates a case in which a rule for the execution processing is not determined.

As shown in FIG. 10B, the check items of the attribute determination rule 222 include six kinds of items, C1 to C6. C1 indicates that the ratio of the property of the user with the attribute value being set is a threshold value (filed_property_ratio) or greater, C2 indicates that the matched target number is a threshold value (matched_target_count) or greater, C3 indicates that the precedence of scenario in the user data is a predetermined precedence (property_priority) or greater, whose state is a property not more than a predetermined level (status_Level), C4 indicates that attribute values of all user data excluding FIXED each have no descendant, C5 indicates that the status level (status_Level) is 1 or less, and C6 indicates that the predetermined precedence (property_priority) is 1.

Further, as shown in FIG. 10C, execution processing includes six types of processing, processes 1 to 6. The process 1 is that of filling in desired conditions, in which the status level (status_Level) from the user data is 1 or less and a property having the highest precedence of the scenario is selected. The process 2 is that of narrowing down desired conditions, in which a property having the attribute value having the greatest number of descendants from among the user data is selected. The process 3 is that of reducing desired conditions, in which the number of unmatched attributes (unmatchedCount) is incremented, a data matching function is invoked again, and an unmatched property in the target data having the highest evaluation value is selected. The process 4 is that of re-questioning with regard to an ambiguous answer, in which the status level (status_Level) is incremented and determination processing referring to the attribute determination rule 222 is performed again. The process 5 is that of considering an attribute having a low precedence, in which the precedence (property_priority) is decremented and determination processing referring to the attribute determination rule 222 is performed again. The process 6 is that of preventing narrowing-down of data, in which a dialogue with the user is performed again.

In step S108, when the attribute selecting processing using the attribute selecting component 22 is performed and the attribute is selected (step S109), the process returns to step S101 in which the question sentence for the selected attribute is given to the user.

In step S107, when the ratio of the attribute value set in the user data is a threshold value or greater, object data that matches the user data is retrieved from the object data DB 303 by the matcher 202 (step S110).

When matching is performed by the matcher 22, the dialogue managing component 10 refers to the user precedence recorded in the user data, selecting the matching result that matches the attribute having a high user precedence, and the matching result is preferentially given to the user and displayed (step S111).

The user selects desired object data from the displayed matching result. The dialogue managing component 10 invokes detailed data of the object data selected by the user from the object data DB 303, and gives the object data to the user, and then displays the same (step S112).

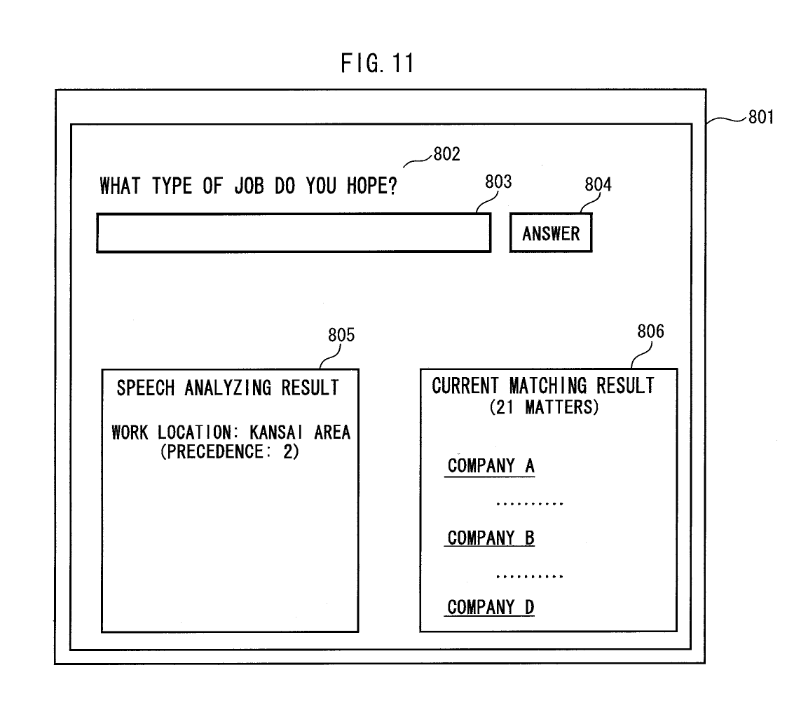

For example, FIG. 11 is a display example corresponding to the display example shown in FIG. 9 by way of example. The speech analysis result indication section 805 of FIG. 11 indicates a speech analysis result for the input (see FIG. 9) constituted by the user using the natural language “If possible, I prefer to work in the Kansai area”. That is to say, in FIG. 11, for the input “if possible” which is the answer shown in FIG. 9, the attribute selecting component 22 analyzes that the user precedence is 2, and the analysis result is displayed in the speech analysis indicating section 805.

Further, the matching result indicating section 806 allows retrieval of 21 matched object data, and from among them, in order from the highest user precedence, Company A, Company B, Company D, and so on are indicated.

### (A-3) Effects of First Embodiment

As described above, the first embodiment can produce the following effects.

According to the first embodiment, it is possible to precisely determine the user precedence and current matching conditions, and obtain optimum matching results by means of a small number of questions.

According to the first embodiment, even if the object data does not completely match the conditions, if the relevance ratio is high, it is possible to pose a question as to whether the condition is acceptable, thereby making it possible to obtain good effects that the user is not aware of.

According to the first embodiment, by proposing a broader concept, narrower concept or similar concept to the hierarchical type knowledge database, narrowing-down and reduction of conditions can be freely performed, and the matching result can be adjusted.

According to the first embodiment, an answer of “not determined”, “anything” or the like can be made by the user for a certain condition, and in consideration of the condition, a precise candidate can be found.

### (A-4) Other Embodiments

(A-4-1) In the first embodiment, as an example of the service site, a job introduction site for people changing jobs is shown by way of example, but the present invention is not limited thereto and can be widely applied to information existing on a network.

Further, with respect to the information on the network, text data, image data, moving image data, sound data and the like can be used as retrieval object data.

(A-4-2) The functions of various constituent elements realized by the laddering search engine and the matching managing device illustrated in the first embodiment are realized by software processing. For example, a hardware configuration is formed by, for example, a CPU, a ROM, a RAM and the like, and the functions of these constituent elements are realized by the CPU executing a processing program stored in the ROM using data required for the processing.

(A-4-3) The matching managing device shown in the first embodiment is not limited to the structure in which various elements are physically mounted in the same apparatus, and these constituent elements may be mounted in dispersed apparatuses. That is to say, various constituent elements may be arranged in a dispersed manner.

### (B) Second Embodiment

The second embodiment of a dialogue managing device, a dialogue managing method, a dialogue managing program, and a consciousness extracting system of the present invention is hereinafter described in detail with reference to the attached drawings.

The second embodiment shows an example in which, the dialogue managing device, the dialogue managing method, the dialogue managing program, and the consciousness extracting system of the present invention are used and applied to an information analyzing/information retrieving system in which a predetermined attribute and an attribute value are extracted from information that a user is conscious of and retrieval-object information by employing a laddering type retrieval service, and information that matches the information that the user is conscious of is retrieved and introduced.

### (B-1) Structure of Second Embodiment

(B-1-1) Overall Construction of Laddering type Retrieving System

The laddering type retrieving system using the dialogue managing device, the dialogue managing method, the dialogue managing program, and the consciousness extracting system of the present invention are described in the first embodiment. Note that the same structures as those of the first embodiment are denoted by the same reference numerals, and a description thereof is omitted.

### (B-1-2) Dialogue Managing Device

Next, the dialogue managing device according to the second embodiment is described in detail with reference to the attached drawings. Further, an example in which the service site 2 is a job introduction domain site for people changing jobs is described below.

The dialogue managing processing of the second embodiment is preferably realized as the function of the dialogue managing component 10 in the aforementioned laddering type retrieving system 9.

Of course, in the aforementioned laddering type retrieving system 9, the dialogue managing component 10 is used to introduce information corresponding to the user's consciousness while having a dialogue with the user by means of a laddering technique in cooperation with the various components 20 to 90 by software processing, and therefore, a portion at which information extracting processing is realized is not particularly limited.

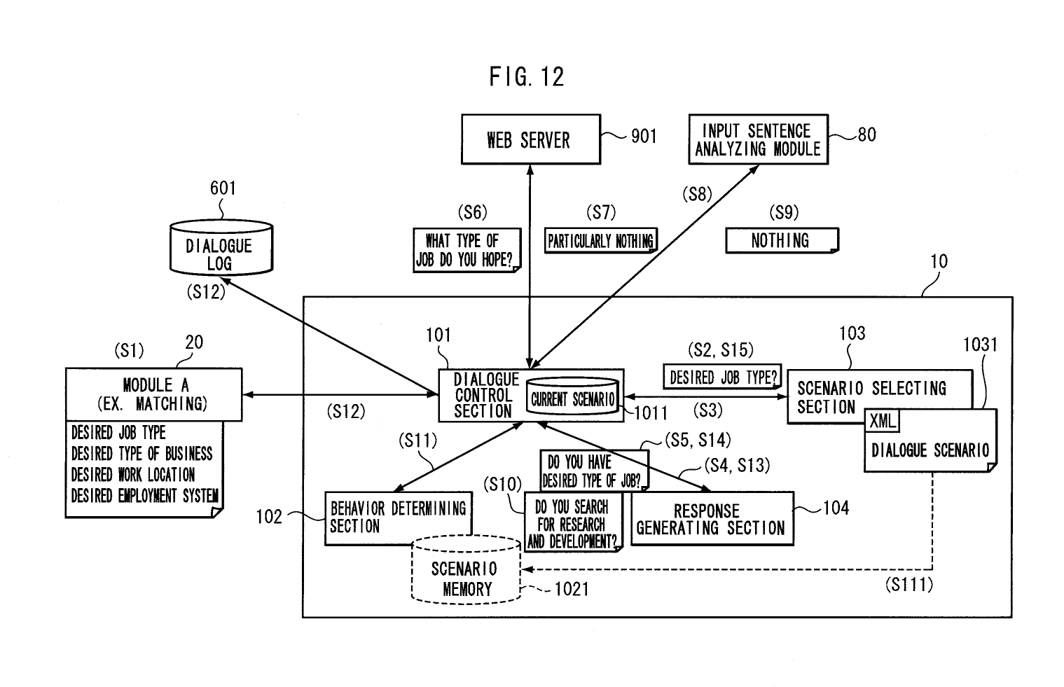

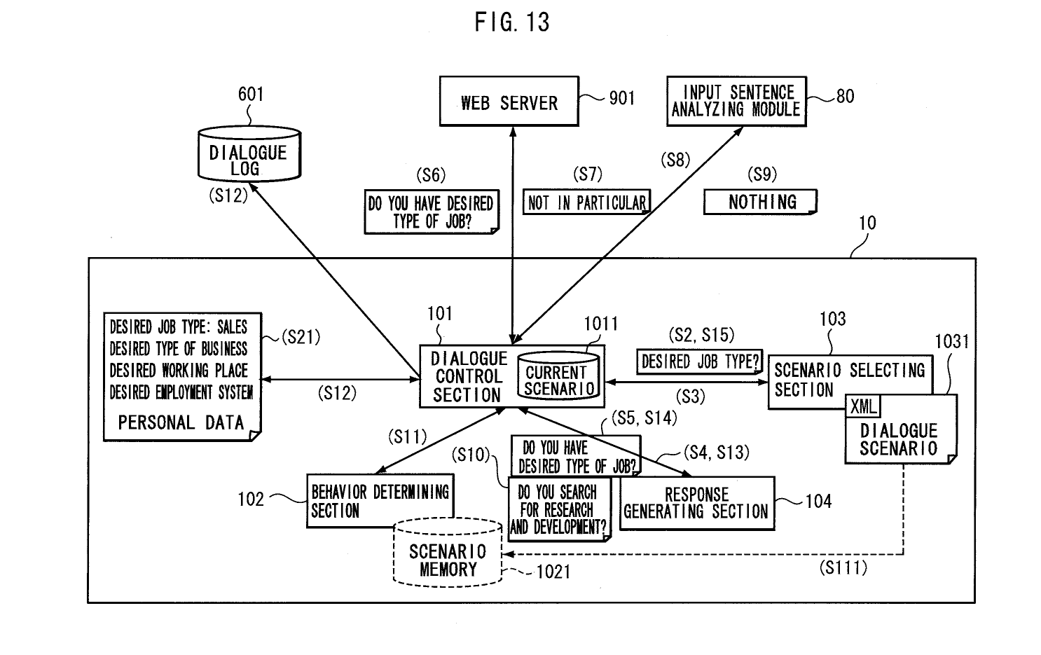

FIGS. 12 and 13 are structural diagrams each showing the structure of the dialogue managing component 10 of the second embodiment. FIG. 12 is a structural diagram in which personal information of a user is provided outside the dialogue managing component 10, and FIG. 13 is a structural diagram in which the personal information of a user is provided inside the dialogue managing component 10.

As shown in FIGS. 12 and 13, the dialogue managing device 10 of the second embodiment includes at least a dialogue control section 101, a behavior determining section 102, a scenario selecting section 103, and a response generating section 104.

The dialogue managing device 10 shown in FIG. 12 is provided at least in cooperation with a Web server 901, an input sentence analyzing module (user speech analyzing component) 80, a dialogue log (log DB) 601, and a matching component 20. Further, the dialogue managing device 10 shown in FIG. 13 is provided at least in cooperation with the Web server 901, the input sentence analyzing module (user speech analyzing component) 80, and the dialogue log 601.

The dialogue control section 101 is used to control the function realized by the dialogue managing device 10 or also control processing in cooperation with an external module (for example, the Web server 901, input sentence analyzing module 80, dialogue log 601, matching component 20 and the like). The dialogue control section 101 basically receives and transmits information between the behavior determining section 102, the scenario selecting section 103, the response generating section 104, and the external module.

Specifically, the dialogue control section 101 effects scenario request processing based on request information or determination of the answer sentence with respect to the scenario selecting section 103, request processing to generate the response sentence with respect to the response generating section 104, request processing to analyze an input sentence with respect to the input sentence analyzing module 80, request processing to determine the answer sentence with respect to the behavior determining section 102, and request processing to write a dialogue with respect to the response generating section 104.

The scenario selecting section 103, upon receiving a request of information that the matching component 20 hopes to acquire, from the matching component 20, is used to select a scenario for obtaining the information (occasionally referred to as an optimum scenario) from the dialogue scenario 1031.

Further, the scenario selection section 103 is used to provide the selected scenario to the dialogue control section 101. At this time, the dialogue control section 101 holds the scenario acquired from the scenario selection section 103 as a current scenario 1011, and provides the scenario to the response generating section 104.

Here, a determination as to the kind of attribute to which the information obtained from a user relates, is made, for example, in the matching component 20, based on the matching result of the retrieval object data and answer data of the user.

In the dialogue scenario 1031, for example, a scenario for obtaining all of information required by the matching component 20 is previously set. Further, as the dialogue scenario 1031, a scenario that corresponds to a dialogue scenario that the scenario managing component 50 shown in FIG. 3 has, can be used.

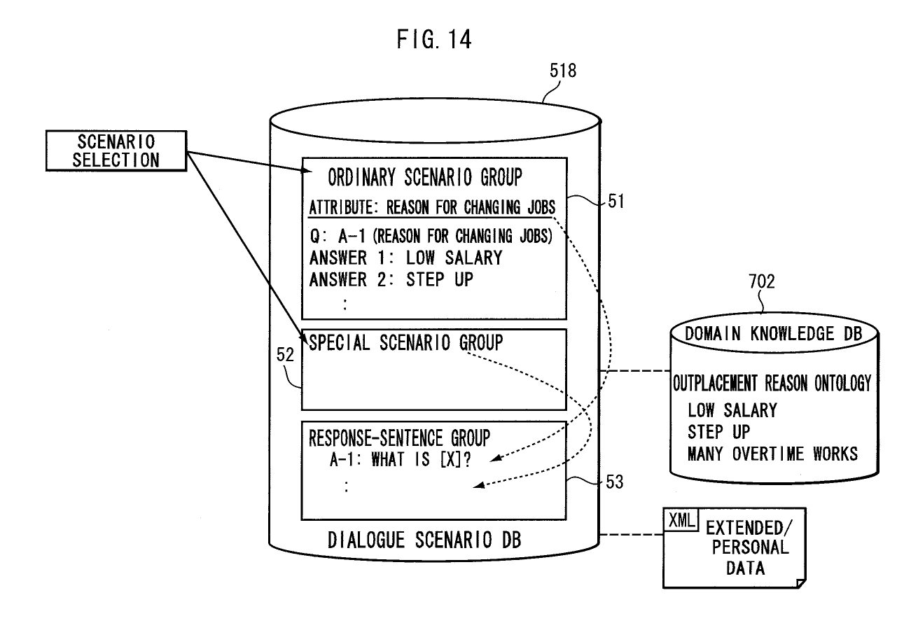

FIG. 14 is a structural diagram showing the structure of the dialogue scenario DB 518 in which a plurality of dialogue scenarios 1031 are stored. As shown in FIG. 14, the dialogue scenario DB 518 has an ordinary scenario group 51, a special scenario group 52 and a response-sentence group 53.

The ordinary scenario group 51 is a scenario aggregate used to pull out requirements desired by the user. The ordinary scenario group 51 has scenarios previously set for all of the attributes in the field relating to the retrieval object.

The special scenario group 52 is an aggregate of scenarios used to, in the laddering dialogue with the user, accommodate an irregular speech from the user (for example, in a case in which the user asks a question about the speech of a scenario) or to smoothly advance the dialogue with the user. For example, an “explanatory scenario”, a “confirmation scenario”, a user “sympathetic-feeling scenario”, a user “confirmative scenario” and the like correspond thereto. Further, there is also a “default scenario” that is executed when an action for the speech of the user does not exist in the ordinary scenario.

The response-sentence group 53 includes examples of response sentences, which are utilized in the ordinary scenario and special scenario, and are also called a response-sentence seed. In the response-sentence group 53, a response sentence for responding is set in advance, or a template having a variable is set.

Incidentally, the dialogue scenario DB 518 includes a description of a scenario of information based on the information stored in the domain knowledge DB 702 shown in FIG. 3.

Further, the scenario within the dialogue scenario DB 518 allows generation of the response sentence by also using contents of extended/personal data having information extended by an enhancer 302 or the like. In other words, a scenario in which a similar term is replaced may also be held.

The response generating section 104, upon receiving a scenario via the dialogue control section 101, generates the response sentence for responding to the user, based on the response-sentence seed of the scenario.

As the method of generating a response sentence by the response generating section 104, for example, by referring to the response sentence group 53 shown in FIG. 14, a method of preparing a response sentence in accordance with the response sentence group 53 can be applied. At this time, when the sentence of response is constituted by a template having a variable, the response sentence is completed by substituting actual data acquired from the user for the variable.

Further, the response generating section 104 is used to give the generated response sentence to the dialogue control section 101. At this time, the dialogue control section 101 provides the generated response sentence to the Web server 901 and transmits the same to the user U1.

The behavior determining section 102, upon receiving via the dialogue control section 101, the result of analyzing a sentence inputted from a user, which is the answer from the user, determines the next dialogue behavior based on the input analysis result, and gives the determined next behavior to the dialogue control section 101. At this time, the dialogue control section 101 controls so as to perform the next behavior in accordance with the behavior determined by the behavior determining section 102.

As the behavior determined by the behavior determining section 102, the following three behaviors are indicated. A first behavior provides information to the matching component 20 so as to complete the current scenario 1011. A second behavior continues the current scenario 1011. A third behavior allows execution of laddering special processing.

The laddering special processing as mentioned above is processing in which, when it becomes difficult to continue the ordinary scenario due to an irregular speech from the user (for example, when the user asks a question about the speech of the scenario, or the like), or when a special response for smoothly advancing the dialogue with the user, rather than the current scenario (a scenario used to collect information required by the user), is demanded, a scenario different from the current scenario is selected and the dialogue therefore is carried out continuously.

### (B-2) Operation of Second Embodiment

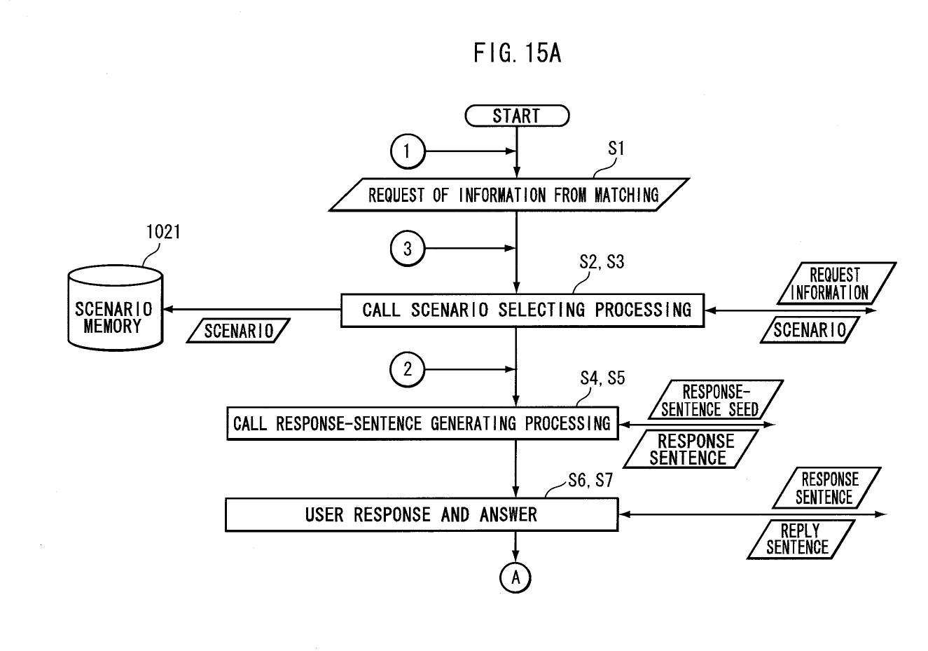

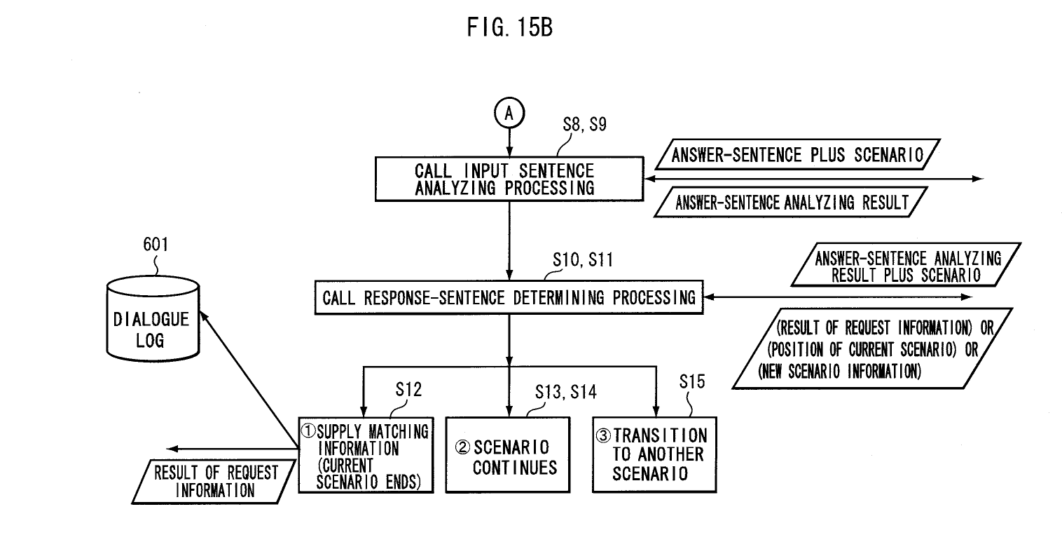

Next, the dialogue managing processing of the second embodiment is described with reference to the attached drawings. FIGS. 15A and 15B form a flow chart showing the dialogue managing processing of the second embodiment. The step numbers shown in FIGS. 15A and 15B are respectively denoted by the same step numbers in FIG. 12.

First, if a request of information that a user hopes to obtain is given from the matching component 20 to the dialogue control section 101 (step S1), then the dialogue control section 101 makes a scenario request based on request information to the scenario selecting section 103 (step S2).

At this time, the dialogue scenario 1031 stored in the dialogue scenario DB 518 is read into the scenario memory 1021.

For example, when the information that the matching component 20 requires is “desired job type”, the scenario selecting section 103 selects the scenario about “desired job type” from the dialogue scenario 1031, and gives the scenario to the dialogue control section 101 (step S3).

When the scenario selected by the scenario selecting section 103 is given to the dialogue control section 101, the dialogue control section 101 holds the scenario as the current scenario 1011, and gives the response sentence seed of the current scenario to the response generating section 104, so as to make a request for generating a response sentence (step S4).

In the response generating section 104, the response sentence is generated based on the response sentence seed in the scenario of the request information, and the generated response sentence is given to the dialogue control section 101 (step S5).

For example, as the response sentence for “desired job type” at this time, the response generating section 104 generates, based on the response sentence seed, the response sentence “Is there a type of job you desire?”

The dialogue control section 101 gives the response sentence generated by the response generating section 104 to the Web server 901 (step S6), to pose the question to the user terminal of the user U1.

Thereafter, the answer sentence from the user U1 with respect to the question is given to the dialogue control section 101 via the Web 901 (step S7), the dialogue control section 101 gives the answer sentence from the user U1 and the current scenario to the input sentence analyzing module 80, and makes a request to analyze the answer sentence (step S8).

In the input sentence analyzing module 80, the inputted answer sentence of the user U1 is analyzed, and the result of analysis is given to the dialogue control section 101 (step S9).

The input sentence analyzing method in the input sentence analyzing module 80 is, for example, carried out using domain knowledge (ontology) in which information knowledge is systematically classified. For example, when the answer sentence of the user U1 with respect to the response sentence is “Not in particular”, the input sentence analyzing module 80 gives the analysis result “No” to the dialogue control section 101.

When the analysis result of the answer sentence is received from the input sentence analyzing module 80, the dialogue control section 101 gives the analysis result of the answer sentence and the current scenario to the behavior determining section 102, and requests determination of the answer sentence (step S10).

By doing this, in the behavior determining section 102, the subsequent behavior is determined based on the analysis result of the answer sentence and the current scenario, and the determined behavior is given to the dialogue control section 101 (step S11). That is to say, the behavior determining section 102 makes a determination as to whether the current scenario is completed by providing information to the matching component 20, or whether the scenario is continued, or whether the laddering special processing is performed.

Here, the behavior determining processing in the behavior determining section 102 will be described in detail with reference to the attached drawings.

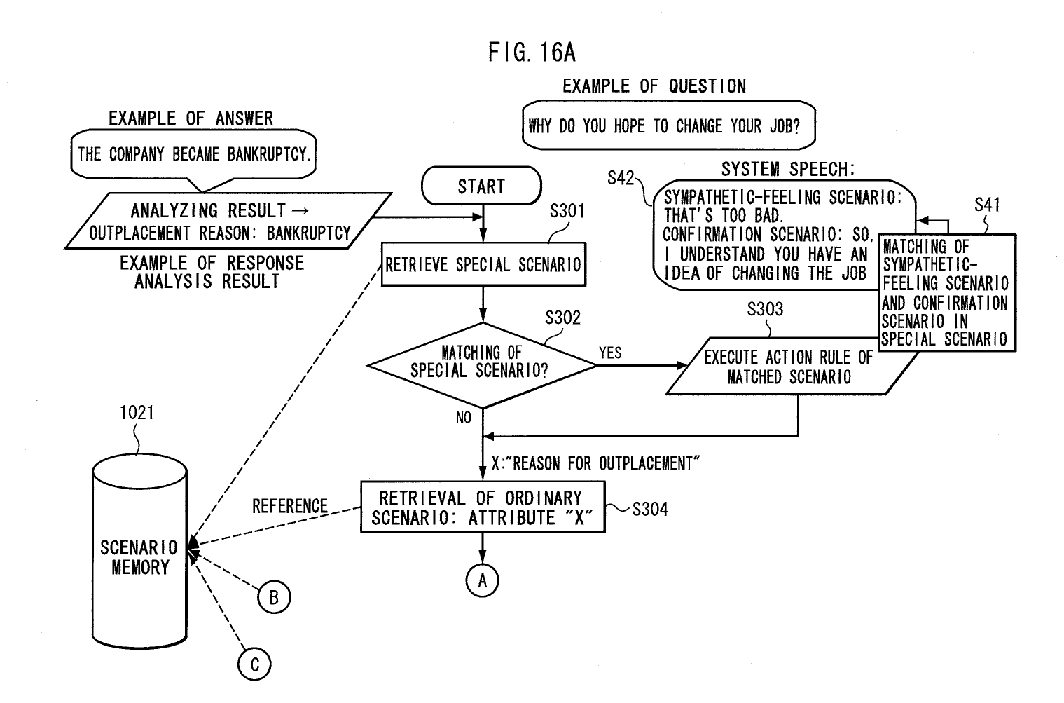

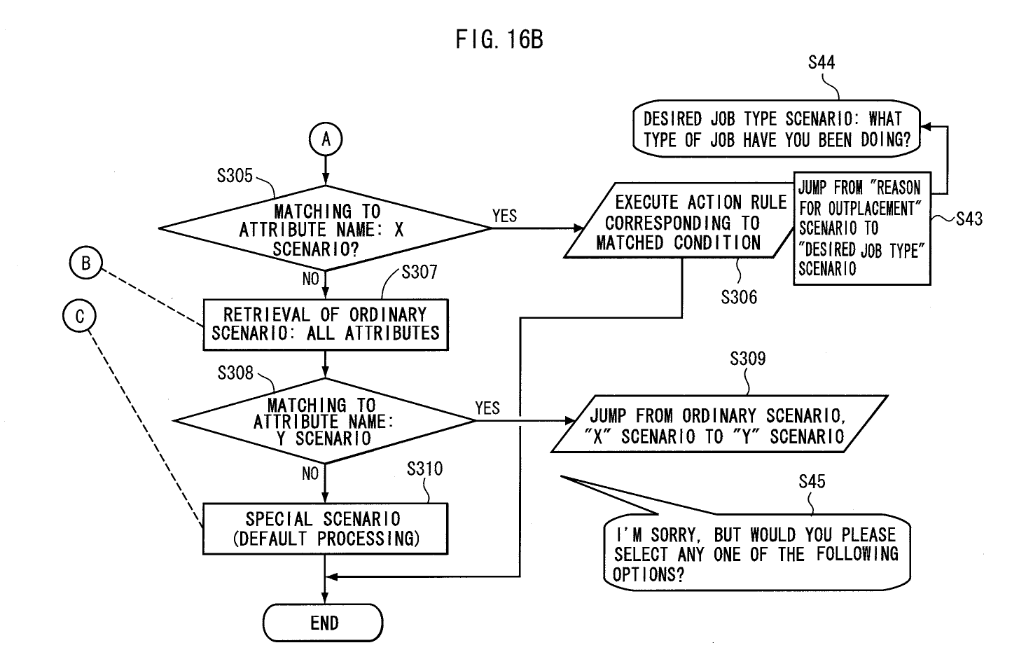

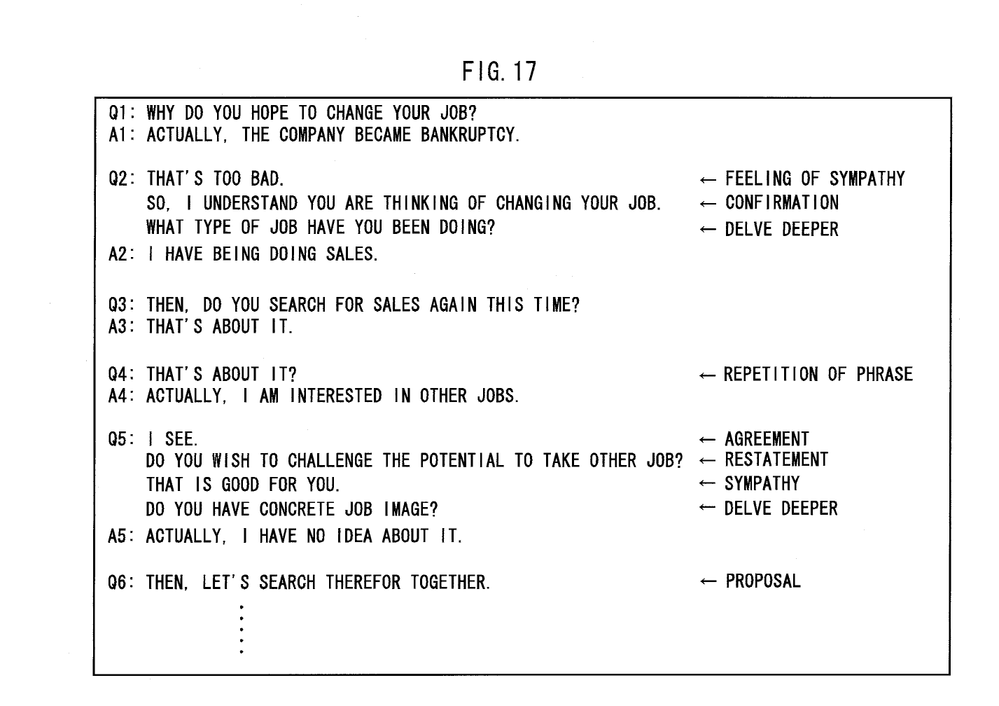

FIGS. 16A and 16B form a flow chart showing the behavior determining processing of the behavior determining section 102. Further, FIG. 17 shows by way of example contents of the laddering dialogue between the user U1 and the system.

As shown in FIG. 17, the dialogue managing component 10 poses, to the user, the response sentence “Why do you desire to change your job?” to bring out a “reason for changing jobs” from the user, and obtains the answer “Because my company went bankrupt.” as the answer from the user. As the analysis result of the answer from the input sentence analysis module 80, the “reason for changing jobs (attribute name): bankruptcy (attribute value)” is given to the behavior determining section 102.

In FIGS. 16A and 16B, at the time of initiation of the system, the dialogue scenario 1031 of the dialogue scenario DB 518 shown in FIG. 14 is loaded on the scenario memory 1021.

When the answer analysis result is given to the behavior determining section 102, the behavior determining section 102 retrieves, based on the received answer analysis result, the special scenario from the scenario memory 1021 (step S301).

Thus, with the behavior determining section 102 carrying out retrieval of the special scenario prior to retrieval of the ordinary scenario, the behavior determining section 102 allows selection of the special scenario that imparts a feeling of trust or security to the user (“sympathetic feeling scenario”) or allows selection of a special scenario that accommodates a case in which the user suddenly poses an unrelated question (“explanatory scenario”).

If a special scenario that matches the answer analysis result exists (step S302), the matched special scenario is selected, and the behavior determining section 102 gives the special scenario 101 to the dialogue control section 101. As a result, due to control of the dialogue control section 101, a response sentence action of the matched special scenario is executed (step S303).

Here, the scenario advancement processing in the behavior determining section 102 will be concretely described.

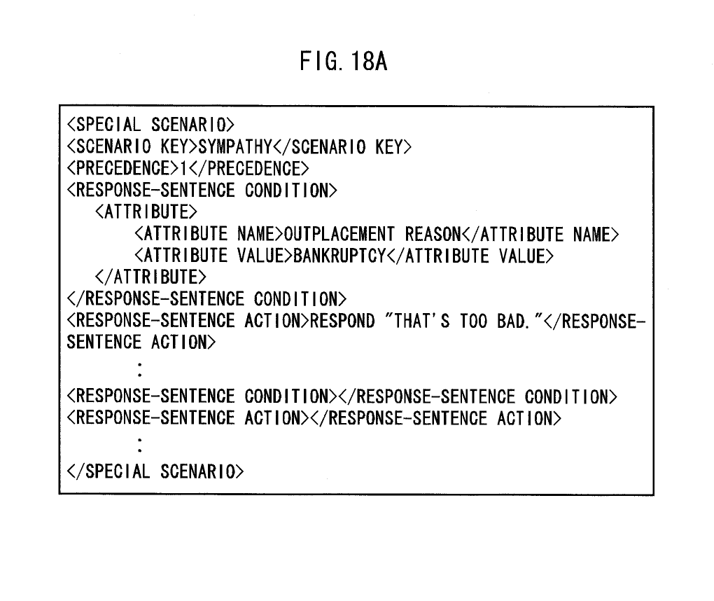

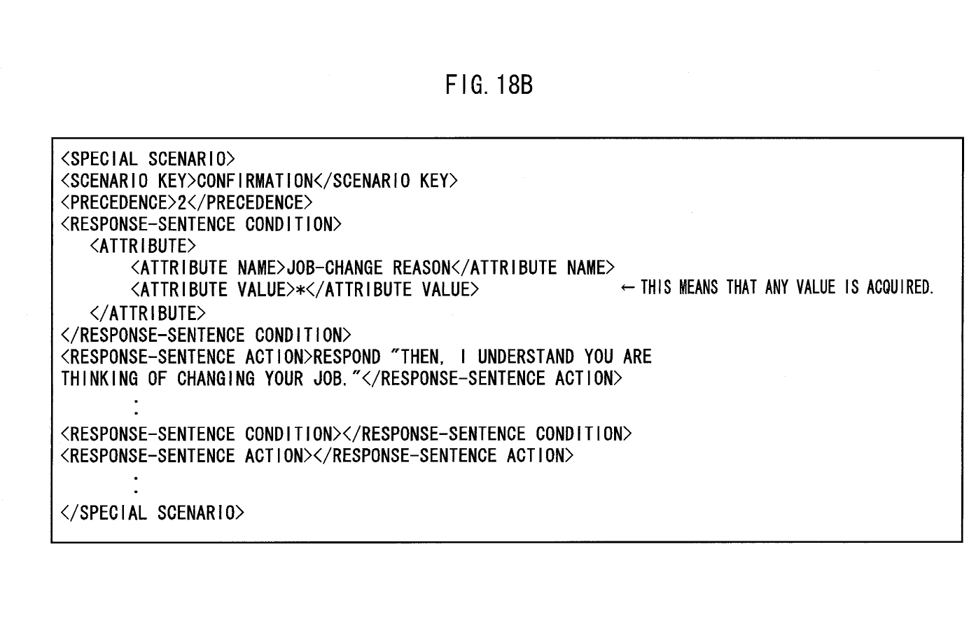

FIGS. 18A and 18B are examples of the special scenario. FIG. 18A is an example of the sympathetic feeling scenario, and FIG. 18B is an example of the confirmation scenario.

As shown in FIGS. 18A and 18B, each scenario is constituted by a “scenario key”, “precedence”, a “response-sentence condition”, and a “response-sentence action”.

In FIGS. 18A and 18B, one scenario includes definition of one set or plural sets of a “response-sentence condition” and a “response-sentence action” . The “response-sentence conditions” and the “response-sentence actions” correspond to each other, and in a case in which a certain “response-sentence condition” is given, the response-sentence action corresponding to the response-sentence condition is executed.

The “scenario key” is identification information of the scenario.

As the “response-sentence action”, an action in a case that corresponds to the “response-sentence condition” is defined. In FIGS. 18A and 18B, as the example of action, a case in which making a response with one previously set response sentence is defined is shown. However, the present invention is not limited to this case. For example, responses in a plurality of response sentences are defined; a response sentence constituted by a template with variables using user personal data acquired from the user in the past is defined; a response sentence having options that allow the user to select one from the options is defined; response-sentence continuation information as to whether the response is continued or ended is defined; and if the response is finished, information of another scenario to be invoked is defined; or variation of an order of scenario precedence or variation in the importance of matching are defined.

The “response-sentence condition” is a condition for causing execution of a response-sentence action. FIGS. 18A and 18B each show, by way of example, a case corresponding to the attribute value of the user. However, the present invention is not limited thereto. For example, information invoked from another scenario may be set as a condition, or a determination as to whether or not user personal data acquired in the past, rather than that which has been acquired from the user currently, or extended information corresponds to the attribute value may be set as a condition.

The “precedence” of the ordinary scenario is used to determine the order of precedence of attribute-name scenarios to be executed, in a case in which a plurality of information attribute names required by the matching component 20 is requested, or in a case in which the matching component 20 does not exist.

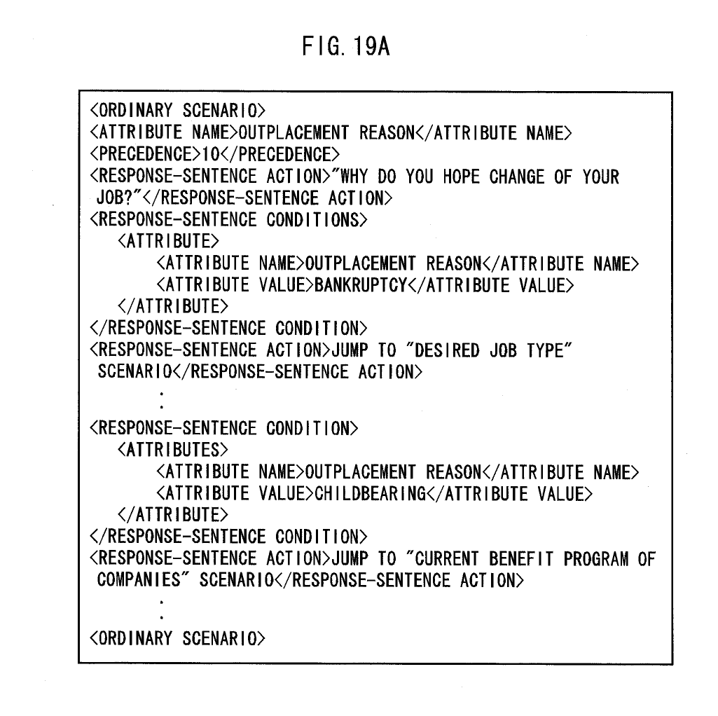

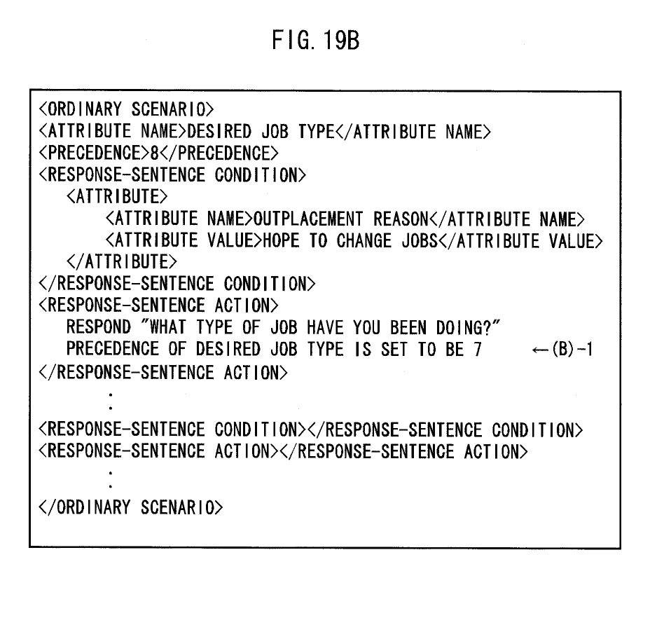

For example, in FIG. 19A, the scenario precedence of the reason-for-changing-jobs scenario is 10. In FIG. 19B, the precedence of the desired job type scenario is 8. In this case, if there is no information request from the matching component, the reason-for-changing-jobs scenario is executed prior to the desired job type scenario. In this way, the order of asking a question to the user can also be defined in the scenario (and further, the precedence of the desired job type can be rewritten in the response-sentence action as shown in the example of (B)-1 of FIG. 19B).

On the other hand, the “precedence” of the special scenario is provided so as to determine the type of order in which the speech of the special scenario is given within the special scenario (the ordinary scenario and the special scenario have different definitions of the “precedence”).

For example, in the case shown in FIGS. 18A and 18B, as the system speech, the sympathetic feeling scenario is first generated, and next the confirmation scenario is generated (that is, the scenario speech “That's too bad. Then, you are thinking of changing jobs, aren't you?” is given).

For example, when the analysis result of an answer sentence “reason for changing jobs (attribute name): bankruptcy (attribute value)” is given to the behavior determining section 102, the behavior determining section 102 retrieves the special scenario in which the attribute name “reason for changing jobs” , and the attribute value “bankruptcy” are set as the response-sentence conditions. In this case, the two special scenarios shown in FIGS. 18A and 18B by way of example (the sympathetic feeling scenario and confirmation scenario) are retrieved (S41 of FIGS. 16A and 16B). If so, the behavior determining section 102 transmits the two special scenarios to the dialogue control section 101.

When the dialogue control section 101 receives the special scenarios, the dialogue control section 101 gives the response sentence seed of the special scenario to the response generating section 104 in accordance with the order of precedence based on the precedence of the special scenario (step S13 shown in FIGS. 1, 15A and 15B).

The response generating section 104 generates the response sentence based on the response sentence seed from the dialogue control section 101, and gives the response sentence to the dialogue control section 101 (step S14 of FIG. 1). The response sentence “That's too bad.” expressed by execution of the sympathetic feeling scenario, and the response sentence “Then, you are thinking of changing jobs, aren't you?” expressed by execution of the confirmation scenario are given to the user U1 (S42).

On the other hand, in step S302, in a case in which there is no special scenario that matches the answer analysis result, or after the response sentence action of the special scenario is executed, the behavior determining section 102 carries out retrieval as to whether or not an ordinary scenario that matches the attribute name X (in this example, the reason for changing jobs) exists (step S304).

If an ordinary scenario that matches the answer analysis result exists (step S305), the matched ordinary scenario is selected, and the behavior determining section 102 gives the ordinary scenario to the dialogue control section 101. As a result, due to control of the dialogue control section 101, the response sentence action of the matched ordinary scenario is executed (step S306).

Next, scenario advancement processing of the ordinary scenario will be described. FIGS. 19A and 19B show examples of the ordinary scenario. Each scenario is constituted by “precedence”, a “response sentence condition” and a “response sentence action”. Further, this shows by way of example the scenario structure in a case of jumping from the scenario (A) to another scenario (B).

For example, the behavior determining section 102 retrieves the ordinary scenario in which the attribute name “reason for changing jobs” and the attribute value “bankruptcy” are set as the response sentence conditions. In this case, FIG. 19A shows a case in which the ordinary scenario shown in FIG. 19A is retrieved. In doing so, the behavior determining section 102 transmits, to the dialogue control section 101, information that the response sentence action of the ordinary scenario shown in FIG. 19A is to “jump to a desired job-type scenario”.

If so, the dialogue control section 101 requests a “desired job type” scenario to the scenario selecting section 103 (step S15 of FIG. 1). When the scenario selecting section 103 gives the “desired job type” scenario to the dialogue control section 101, the “desired job type” scenario is held as the current scenario, and the response sentence seed of the scenario which has been newly jumped to is given to the response generating section 104, and due to execution of a delving deeper scenario, the response sentence “What type of job were you doing before?” is given to the user U1 (S43).

As shown in FIG. 19A, it is possible to realize “delving deeper” by jumping to another scenario that further “delves deeper” for the contents based on the attribute value obtained from the user's speech.

On the other hand, in step S305, if there is no ordinary scenario having the attribute name “X (reason for changing jobs)” that matches the answer analysis result, the behavior determining section 102 carries out retrieval as to whether or not an ordinary scenario that causes matching of the response sentence condition for all the attribute names exists (step S307).

Then, if an ordinary scenario that matches the answer analysis result exists (step S308), the matched ordinary scenario is selected, and the behavior determining section 102 gives the ordinary scenario to the dialogue control section 101. As a result, due to control of the dialogue control section 101, transition processing from the ordinary scenario having the attribute name “X (reason for changing jobs)” to another ordinary scenario having the attribute name “Y” is performed (step S309).

In step S308, if no ordinary scenario that matches the answer analysis result exists, or after the response sentence action of the ordinary scenario action in step S306 is executed, the behavior determining section 102 gives the special scenario that is set as a default, to the dialogue control section 101 (step S310).

In this case, based on the special scenario of the default determined in the behavior determining section 102, the dialogue control section 101, in cooperation with the scenario selecting section 103 and the response generating section 104, transmits the response sentence “I'm sorry, but would you please select one from the following options?” to the user U1 (S45).

Hence, if, for example, no scenario to be applied exists, it is possible to make some response or pass to another question due to the special scenario being set as the default.

Incidentally, in the behavior determining section 102, when the contents correspond to the response sentence condition of the scenario that indicates completion, the contents are given to the dialogue control section 101, and the response sentence and answer sentence for the scenario are written in the dialogue log 601, and then the scenario is completed (step S12). In the dialogue log 601, writing is performed each time one scenario is completed. Therefore, even in a case of jumping from a certain scenario to another scenario, the response sentence and answer sentence of the previous scenario are written.

In the foregoing, a case in which the personal information data is located outside the dialogue managing device 10 as shown in FIG. 1 has been shown by way of example, but even in a case in which the personal information data is located inside the dialogue managing device 10 as shown in FIG. 13, a similar operation is performed.

However, as shown in FIG. 13, when the personal information data is located inside the dialogue managing device 10, the order of precedence is applied to information requested to the dialogue control section 101 (that is, data for bringing out an attribute value), and in accordance with the order of precedence, the information is requested to the dialogue control section 101.

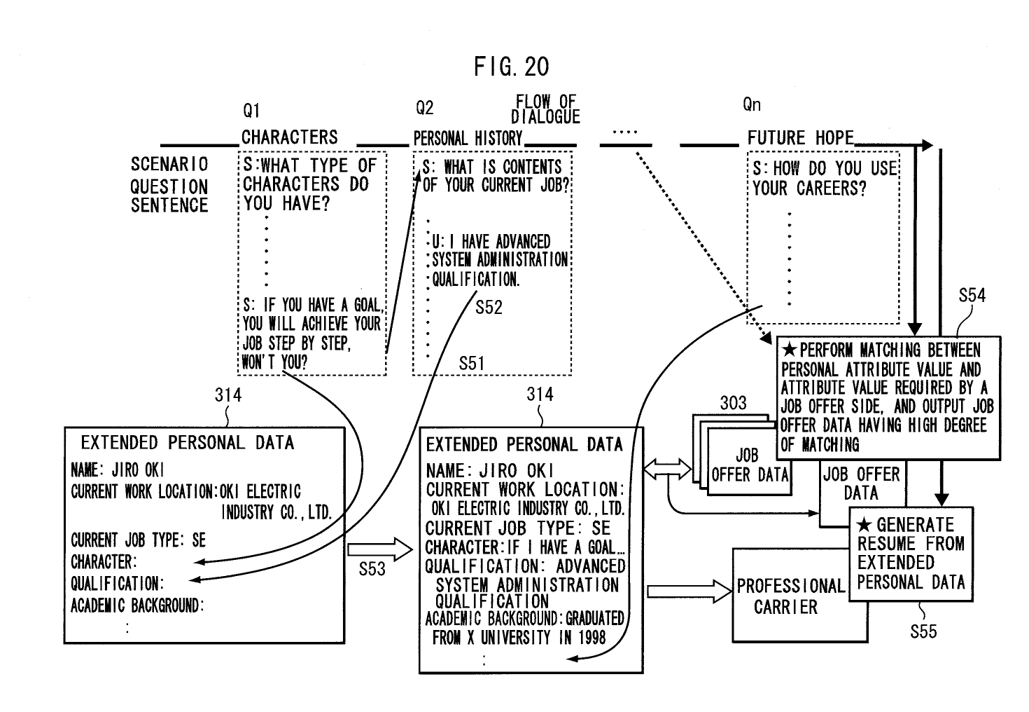

FIG. 20 is an illustrative diagram that schematically illustrates procession of the laddering dialogue in the laddering dialogue engine 1.

As shown in FIG. 20, respective contents of the first question Q1 (regarding character), question Q2 (regarding career), . . . , question Qn (n is a positive integer) (regarding the future) can be expanded in the dialogue between the user and the system, so that personal data other than a response to a main question (S51, S52) is acquired. By bringing out consciousness information of the user U1, an attribute value for each attribute is filled in the extended personal data 314 of the user U1 (S53). As a result, matching between a personal attribute value and an attribute value required by a job offering side is performed, and job information having a high degree of matching can be outputted (S54). Further, the summarizer 603 is used to prepare a resume, as a personal job history, from the extended personal data.

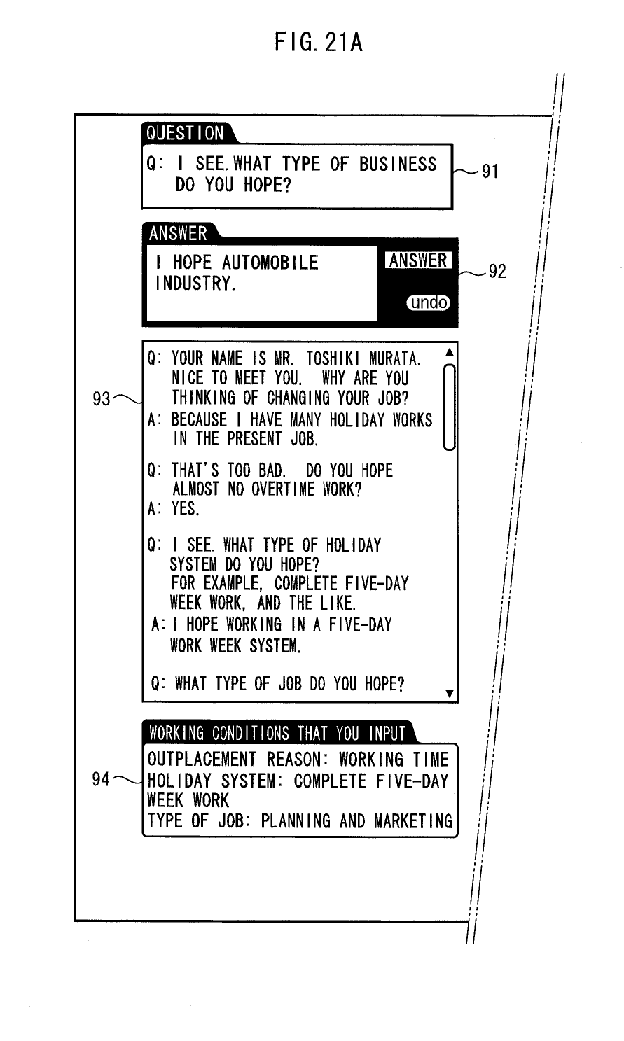

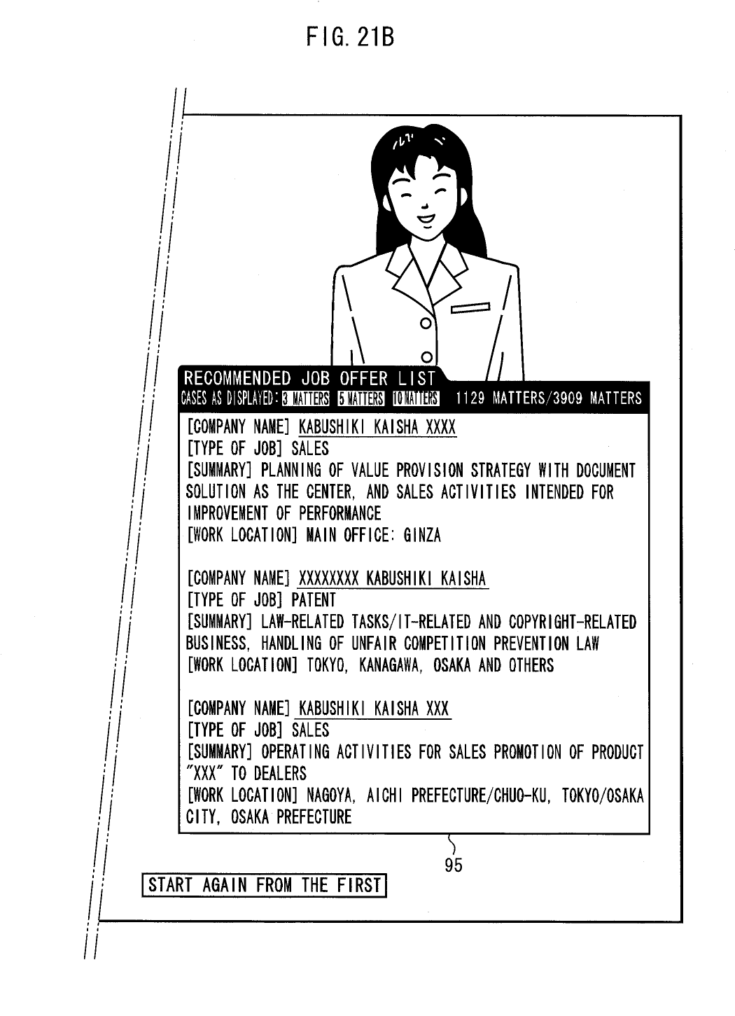

FIGS. 21A and 21B are examples of a display screen shown in the user terminal (browser) of the user U1. As shown in FIGS. 21A and 21B, on the display screen, a current question given from the laddering dialogue engine 1 is displayed in a question indicating section 91, and the content of a user's answer is displayed in an answer indicating section 92. Contents of dialogue previously made are displayed in the dialogue log indicating section 93. Further, in the job-condition indicating section 94, a condition detected by the dialogue engine 1 in the laddering dialogue, that is, a condition inputted by the user U1 is displayed. Job offerers retrieved by the laddering dialogue engine 1 are displayed on the job-offering list indicating section 95.

The display screens shown in FIGS. 21A and 21B are shown by way of example. For example, the following displays other than the display screens shown in FIGS. 21A and 21B can be provided.
(a) A display is shown in which if a user does not like the displayed company name, the user cancels in such a manner as to date back over the dialogue log. For example, if the user clicks by making a mark, the dialogue subsequent to the mark is cancelled, and the dialogue is restarted from the position of the mark.
(b) If the displayed company name is clicked, user data that is a job-offering condition of the company is highlighted. For example, when the job-offering condition of the company is shown as “job type: SE”, and the user data is shown as “desired job type: SE”, the desired job type of the user data is highlighted. That is to say, the job-offering conditions of respective companies can be simply understood.
(c) When another button “loosen conditions” exists, and a user views a list of companies displayed currently and is aware that the conditions are too narrowed down, the user pushes the aforementioned button. When the user pushes the button, the system poses a question for loosening the conditions to the user.

In the foregoing, examples of “delving deeper”, “confirmation”, and “sympathy” are respectively described, but “restatement”, “supply of information”, and “summarizing” can be carried out as described below.

For example, if “restatement” is effected, when the domain knowledge has, for example, the structure of “career enhancement (broader concept)” —“hope to get qualification (narrower concept)” and the attribute value of “hope to get qualification” is acquired from the user's speech, the response “You hope to enhance your career, don't you?” is made while referring to the value of the broader term, whereby “restatement” can be realized.

Further, for example, when “supply of information” is executed, the domain knowledge allows description of the meaning for each value such as “route sales representative: sales representative making the rounds of fixed customers”. For example, when the user issues the speech “What type of job is a route sales representative?”, the speech “what type of job?” is analyzed, the speech analysis passes the result “explanation request: route sales representative” to the dialogue control, whereby the explanation scenario of the special scenario is executed, and the meaning of the route sales representative described in ontology is acquired, and further, by making the response “A route sales representative is a sales representative that makes the rounds of fixed customers”, “supply of information” can be realized.

Further, for example, when “summarizing” is executed, a speech history of the user is held, and summary thereof becomes possible. By quoting and presenting the summarized result in the course of the dialogue, the dialogue can be smoothly developed.

### (B-3) Effects of Second Embodiment

As described above, the second embodiment includes the dialogue control section, behavior determining section, and scenario selecting section, and these constituent elements operate in cooperation with one another, thereby making it possible to develop a dialogue that finds out the consciousness of a user in accordance with the user's answers in the laddering dialogue between the user and the system.

### (B-4) Other Embodiments

(B-4-1) In the second embodiment, as one example of the service site, a job introduction site intended for people changing jobs has been shown by way of example, but the present invention is not limited thereto and can be widely applied to information existing on a network.

Further, as the information on the network, text data, image data, moving image data, sound data and the like can be set as retrieval object data.

(B-4-2) The functions of various constituent elements realized by the laddering search engine, and the dialogue managing device illustrated in the second embodiment are realized by software processing. For example, the hardware configuration is, for example, constituted by a CPU, a ROM, a RAM and the like, and the functions of the constituent elements are realized by the CPU to execute a processing program stored in the ROM using data required for the processing.

(B-4-3) The dialogue management device described in the second embodiment is not limited to the structure in which it is physically installed in the same device, and the various constitutional elements may be installed in dispersed devices, respectively. That is to say, the various constitutional elements may be arranged in a dispersed manner.

### (C) Third Embodiment

The third embodiment of an information extracting device, an information extracting method and an information extracting program of the present invention is hereinafter described in detail with reference to the attached drawings.

The third embodiment shows, by way of example, a case in which the information extracting device, information extracting method and information extracting program of the present invention are used, and applied to an information analyzing/information retrieving system in which a predetermined attribute and an attribute value are extracted from information that a user is conscious of, and from information to be retrieved, using, for example, a laddering retrieval service, and information that matches the information that the user is conscious of is retrieved and introduced.

### (C-1) Structure of Third Embodiment

### (C-1-1) Description of an Overall Construction of the Laddering Retrieving System

The laddering retrieving system that applies the information extracting device, information extracting method and information extracting program of the present invention is described in the first embodiment. Note that the same structures as those of the first embodiment are denoted by the same reference numerals, and description thereof is omitted.

The dialogue managing component 10 is used to control processing in the laddering retrieval service 1. In the dialogue managing component 10, various questions are repeatedly posed to the user U1 who hopes for retrieval, and based on the answer from the user U1 to the question, information that the user is really conscious of is brought out, and the user is allowed to retrieve information or contents matching the information that the user is conscious of, and the retrieved information and the like are introduced to the user U1.

### (C-1-2) Information Extraction Processing

Next, the information extracting device according to the third embodiment will be described in detail with reference to the attached drawings. Further, a case in which the service site 2 is a job-introduction domain site for people changing jobs is described below by way of example.

The information extracting processing of the third embodiment is a process in which information supplied by the service site 2 or Web information 4 (hereinafter occasionally referred to as retrieval object data) is acquired, an attribute and an attribute value therefor are extracted to make a set from the retrieval object data, the response information of the user U1 is acquired, and the set of an attribute and an attribute value therefor are extracted from the response information of the user U1.

The information extracting device of the third embodiment is preferably realized so as to have the function of the user speech analyzing component 80 or domain knowledge acquiring component 70 in the aforementioned laddering search engine 1.

Of course, in the aforementioned laddering search engine 1, the dialogue managing component 10 operates in cooperation with various components 20 to 90 by means of software processing, and information corresponding to the consciousness of the user is introduced while making a dialogue with the user by means of a laddering technique. Therefore, a position, at which information extracting processing described below is realized, is not particularly limited.

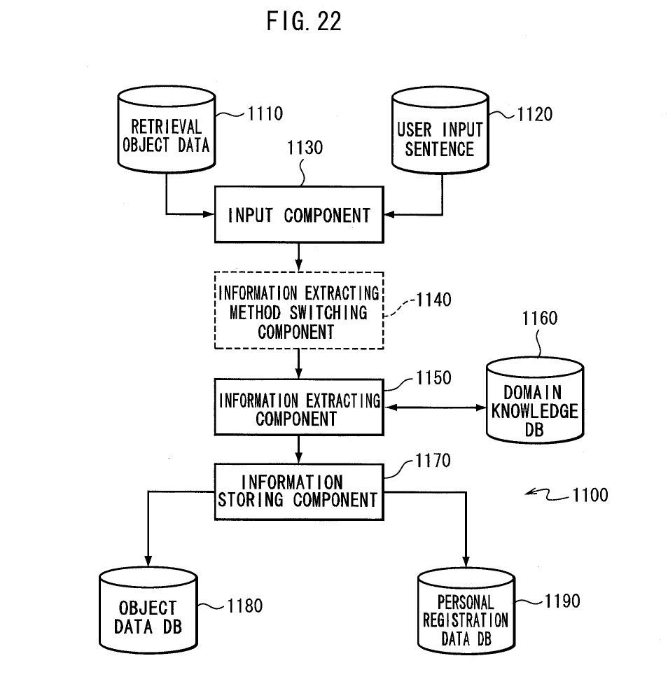

FIG. 22 is a structural diagram showing the structure of the information extracting device 1100 of the third embodiment.

As shown in FIG. 22, the information extracting device 1100 of the third embodiment is constituted by at least retrieval object data 1110, a user input sentence 1120, an input component 1130, an information extracting method switching component 1140, an information extracting component 1150, a domain knowledge DB 1160, an information storing component 1170, an object data DB 1180, and a personal registration data DB 1190.

The retrieval object data 1110 is information acquired, as a retrieval object, from the service site 2 via the network, or Web information 4 to be retrieved, which is acquired from the Web. The retrieval object data 1110 may be data acquired from the service site 2 or the like after start of the dialogue with the user U1, or may be data stored in advance in a database.

The user input sentence 1120 includes question information that is posed to the user U1 under the control of the dialogue managing component 10, and response information of the user U1 to the question information. The user input sentence 1120 is given from the dialogue control section 101 acquired from the user terminal. Incidentally, the user input sentence 1120 may also be temporarily stored in a storage component.

The input component 1130 takes in the retrieval object data 1110 or user input sentence 1120, and gives the same to the information extracting method switching component 1140. The retrieval object data 1110 or user input sentence 1120 is, for example, taken in by the input component 1130 one sentence at a time, and the information extracting processing described below is carried out for one sentence at a time. Naturally, a plurality of sentences may be taken in by the input component 1130, and the plurality of sentences may also be continuously subjected to the information extracting processing.

The information extracting method switching component 1140 is, upon receiving the retrieval object data 1110 or user input sentence 1120 from the input component 1130, used to determine the information extracting method based on the input retrieval object data 1110 or the user input sentence 1120.

Three types of information extracting methods described below can be applied.

The first information extracting method is an information extracting method by means of character-string matching or matching after morphological analysis, using the domain knowledge information stored in the domain knowledge DB 1160.

The second information extracting method is an information extracting method in which syntactic analyzing processing is carried out, and if a predetermined sentence structure is given, information is extracted by analyzing the sentence structure. For example, in a case in which response information from the user U1 has the sentence structure having the relationship of “(nominative) is equal to (objective)” as in the sentence “I am considering Tokyo (objective) as the work location (nominative)”, only the sentence structure is extracted. As a result, “work location (nominative)” and “Tokyo (objective)” can be made to correspond to each other.

The third information extracting method is an information extracting method in which, for example, in a case in which a question sentence is a negative sentence or an interrogative sentence, information that shows a user's intention with respect to the question, such as “YES”, “NO”, “Neither”, “Either”, “Anything”, and the like is extracted.

Further, as the method for determining the information extracting method, the following three patterns can be applied. The following determining methods of the three patterns are not set fixedly to the information extracting method switching component 1140, but allow switching of the information extracting method in accordance with an attribute and an attribute value even during the information extracting processing of one sentence.

The first pattern is a method in which an information extracting method corresponding to an attribute is determined in advance. In this case, the information extracting method switching component 1140 detects an attribute from the input retrieval object data 1110 or user input sentence 1120, and determines the information extracting method in accordance with the attribute.

The second pattern is a method in which a certain information extracting method is determined as a default. In this case, the information extracting method switching component 1140 allows a default information extracting method to be determined for all the attributes.

The third pattern is a method of determining the information extracting method by using constituent elements of the attribute value. In this case, the information extracting method switching component 1140 determines the constituent elements of the attribute value extracted from the inputted retrieval object data 1110 or user input sentence 1120, and determines the information extracting method in accordance with the constituent elements of the attribute value. Further, the information extracting method switching component 1140 can, even if it operates by means of the first pattern method or the second pattern method, determine the third pattern method depending on the determination result of the constituent elements of the attribute value.

The information extracting component 1150 is used to extract an attribute and an attribute value from the input retrieval object data 1110 or the user input sentence 1120 while referring to the ontology stored in the domain knowledge DB 1160 by the information extracting method determined by the information extracting method switching component 1140. Further, the information extracting component 1150 determines the ontology to be referred to depending on the type of attribute to be extracted, and extracts the attribute value using the ontology.

Further, the information extracting component 1150 may extract extended information in cooperation with the enhancer 302. That is to say, the information extracting component 1150 can extract an attribute and an attribute value, which are to be extracted, for extended character strings such as similar character strings or related strings.

Moreover, in a case in which the information extracting component 1150 is able to extract the attribute value from the user input sentence 1120, but the attribute to which the attribute value belongs is not understood, a determination is made that ambiguity exists, and this determination is given to the dialogue control section 101. Upon receiving it, the dialogue control section 101 can cause preparation of a question for inquiring to the user U1 about what type of attribute the attribute value belongs to, and can transmit the question to the user U1.

The domain knowledge DB 1160 corresponds to the aforementioned domain knowledge DB 702, and stores therein a plurality of domain knowledge as an aggregate of ontology.

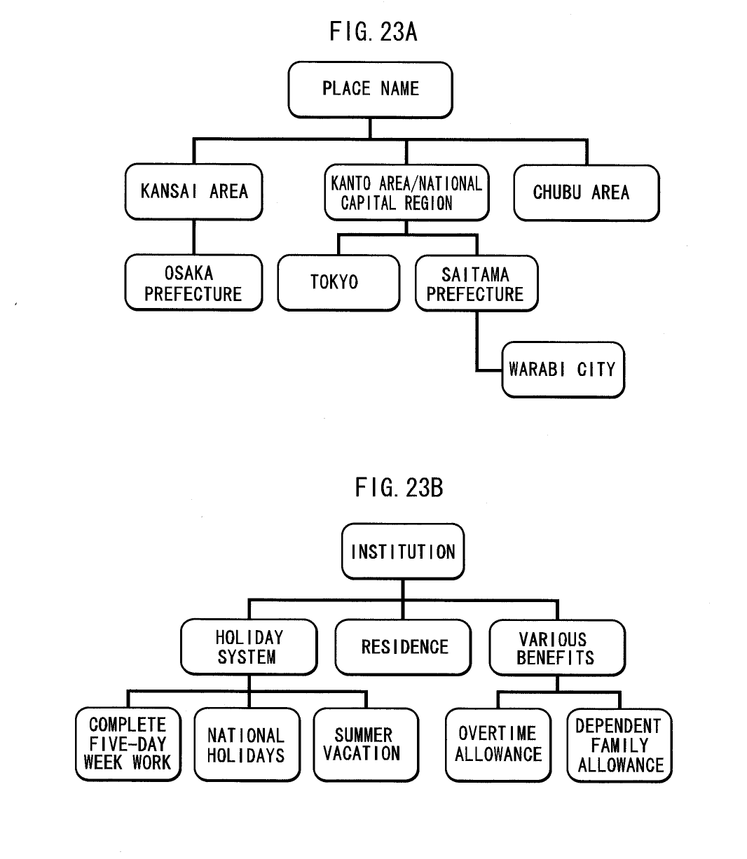

FIGS. 23A and 23B show the structures of the aggregates of ontology of the domain knowledge. For example, FIG. 23A shows an example of “place-name ontology”, and FIG. 23B shows an example of “institution ontology”.

The “place-name ontology” shown in FIG. 23A sets the “place name” as the broadest concept, and “Kansai area”, “Kanto area/National capital region”, “Chubu area” are linked thereto as the character strings of a narrower concept. That is, “place name”, and the group of “Kansai area”, “Kanto area/National capital region” and “Chubu area” have the relationship of parent and children. Further, “Osaka prefecture” is linked to the character string of the narrower concept of “Kansai area”, and “Kansai area” and “Osaka prefecture” have the parent-child relationship. The expression of “Kanto area/National capital region” means that “Kanto area” and “national capital region” have equivalent character strings. With regard to the relationship between the other character strings as well, the parent-child relationships are similarly set through the links.

The information storing component 1170 allows an attribute and an attribute value extracted from the retrieval object data by the information extracting component 1150 to be stored in the object data DB 1180, and the attribute and the attribute value extracted from the user input sentence 1120 are stored in the personal registration data DB 1190.

The object data DB 1180 corresponds to the object data DB 303 of the aforementioned matching object analyzing component 30. Further, the personal registration data DB 1190 corresponds to the personal registration data DB 304 of the matching object analyzing component 30.

(C-2) Operation of Third embodiment

Next, operation of the information extracting processing of the third embodiment will be described in detail with reference to the attached drawings.

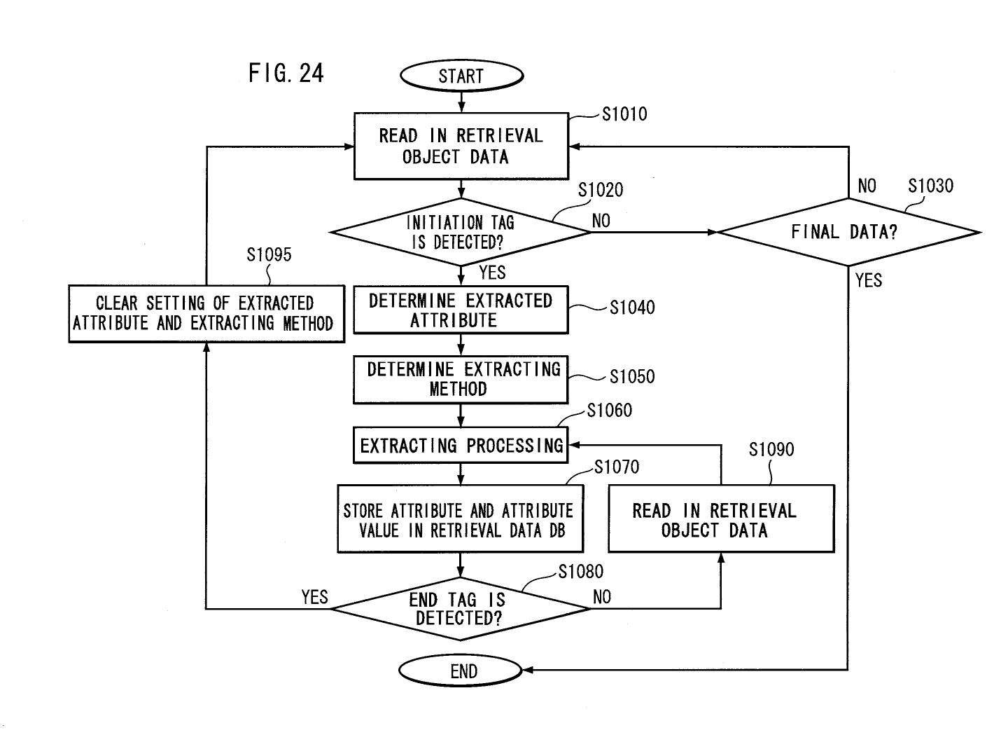

FIG. 24 is a flow chart that shows a case in which the information extracting device 1100 of the third embodiment extracts an attribute and an attribute value from retrieval object data.

In FIG. 24, first, when the retrieval object data 1110 is read via the input component 1130 (step S1010), the information extracting method switching component 1140 determines the information extracting method based on the inputted retrieval object data 1110.

The information extracting method switching component 1140 detects an initiation tag included in the inputted retrieve object data 1110 (step S1020). If no initiation tag is detected, when the final data of the retrieval object data 1110 is detected, the process is completed, and if this is not the case, the process returns to step S1010 and the process proceeds (step S1030).

If the initiation tag is detected in step S1020, the information extracting method switching component 1140 effects morphological analysis processing, syntactic analysis processing and expression normalization processing, respectively, for each of data subsequent to the initiation tag, and detects as to whether the data includes an attribute, or not (step S1040).

The morphological analysis processing, syntactic analysis processing and expression normalization processing allows application of processing based on a morphological analysis section 804, syntactic analysis section 803 and expression normalization section 802 of the user speech analyzing component 80. Further, the morphological analysis processing, syntactic analysis processing and expression normalization processing allow wide applications of existing techniques, and description thereof will be omitted.

If an attribute is detected, the information extracting method switching component 1140 determines the information extracting method in accordance with the attribute (step S1050).

The information extracting method switching component 1140 can determine the information extracting method based on the determination pattern of the aforementioned three patterns of information extracting methods.

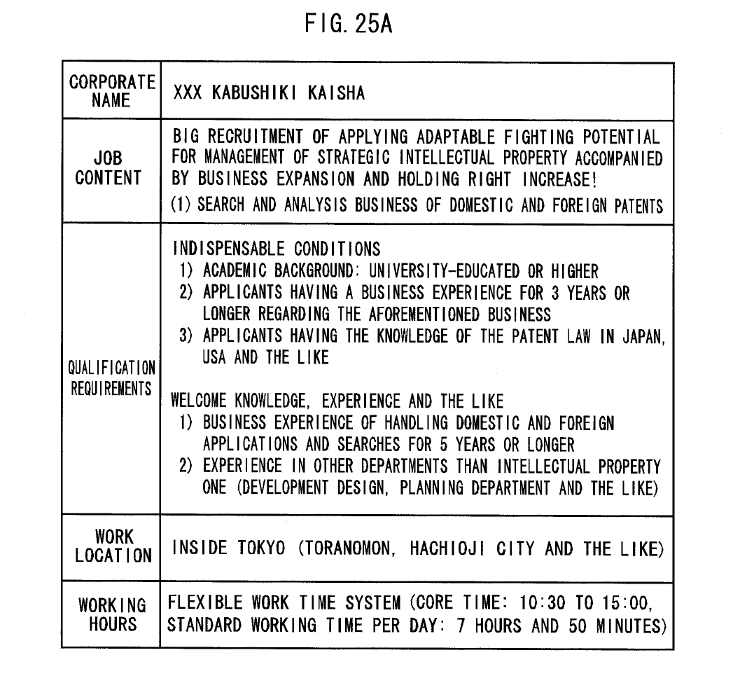

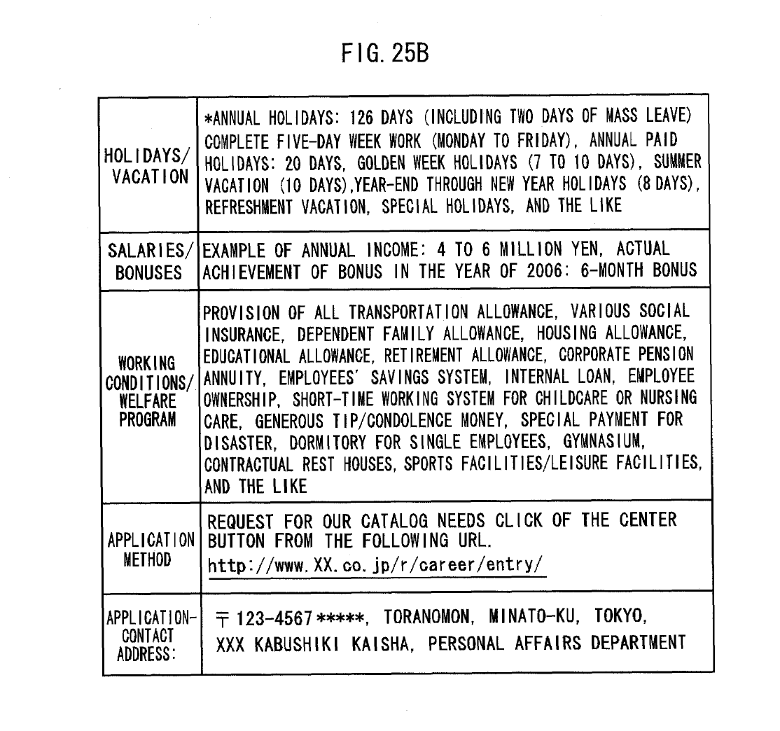

For example, FIGS. 25A and 25B show an example of retrieval object data, which is information supplied in the job introduction site for people changing jobs. In this case, the attribute corresponds to, for example, items mentioned in the left column including “corporation name”, “job content”, “work location”, “working hours”, “days-off and holidays”, “salaries and bonuses”, “working conditions and welfare programs”, and the like. The attribute values of these attributes correspond to items described in the right column, such as “xxx Company”, “accompanied by business expansion and tenure build-up . . . ”, and the like.

For example, when the information extracting method is set in accordance with the extracted attribute, the information extracting method switching component 1140, when detecting, for example, the attribute “work location”, determines character string matching previously set in the attribute “work location”, or a matching method of morphological analysis results.

If so, the information extracting component 1150 extracts, by the information extracting method determined by the information extracting method switching component 1140, an attribute value for an attribute in a set from the retrieval object data 1110 (step S1060), and stores the set of the attribute and the attribute value therefor in the object data DB 1180 (step S1070).

For example, in the aforementioned case shown in FIGS. 25A and 25B, “inside Tokyo (prefecture)”, “Toranomon (station)”, “Hachioji (station)” and the like are extracted by matching for the attribute “work location”, and the attribute values “inside Tokyo”, “Toranomon” and “Hachioji” are each made to correspond to the attribute “work location”, and are stored in the object data DB 1180.

The retrieval object data 1110 is read in (step S1090) until an end tag is detected (step S1080), and processing of extracting an attribute value is carried out repeatedly. If the end tag is detected (step S1080), the attribute to be extracted, and the information extracting method are cleared once (step S1095), the process returns to step S1010, and the process is effected repeatedly.

Next, processing in a case in which the information extracting device 1100 of the third embodiment extracts an attribute and an attribute value from the user input sentence 1120 will be described.

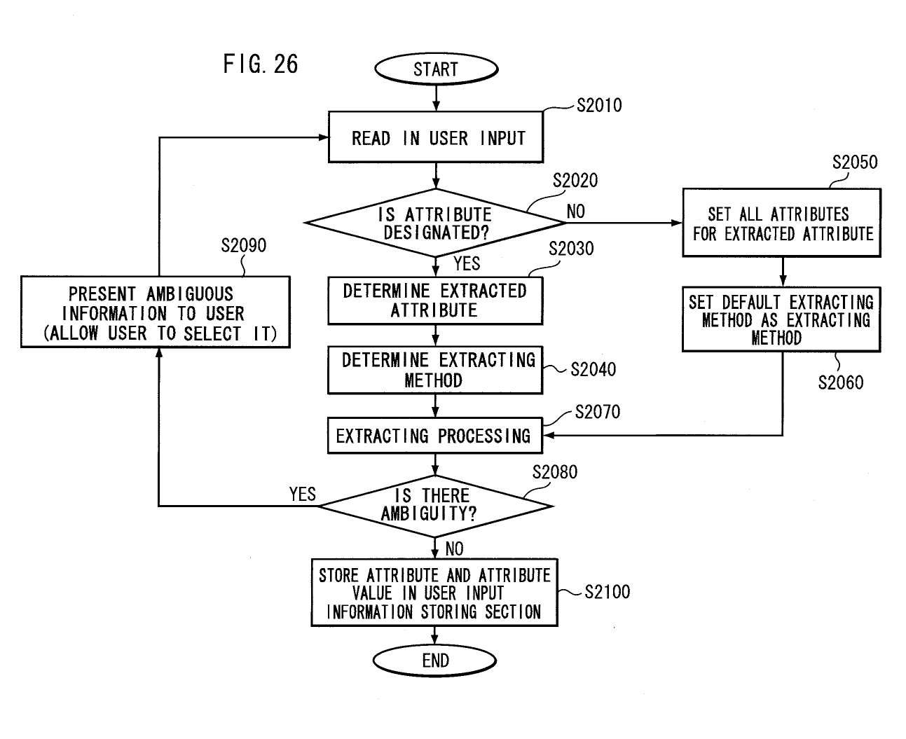

FIG. 26 is a flow chart showing processing in a case in which the information extracting device 1100 extracts an attribute and an attribute value from the user input sentence 1120. FIG. 26 shows processing in a case in which one user input sentence 1120 is given, but similar processing is repeated for each of all the user input sentences 1120.

In FIG. 26, first, the user input sentence 1120 is read in via the input component 1130 (step S2010).

At this time, when the user input sentence 1120 is response information for a question posed to the user to obtain a certain attribute, the dialogue managing component 10 may give a designation, to the information extracting method switching component 1140, as to what type of attribute the response information is for (that is, attribute designation).

If the attribute designation exists (step S2020), the information extracting method switching component 1140 determines the attribute designated from the dialogue managing component 10 (step S2030), and determines the information extracting method corresponding to the attribute (step S2040). In this case as well, the information extracting method switching component 1140 can determine the information extraction method based on the determination pattern of the aforementioned three patterns of information extracting methods.

If no attribute designation exists (step S2020), the information extracting method switching component 1140 sets all the attributes as objects for extraction (step S2050), extracts the attribute included in the user input sentence 1120, and determines a default information extracting method (step S2060).

As the attribute extracting method, for example, when the user input sentence 1120 includes a tag, a method of determining an attribute by detecting the tag, or for example, by performing matching processing such as character-string matching for the attribute included in the user input sentence 1120 can be applied.

In step S2060 of FIG. 26, a case in which a default information extracting method is used is shown by way of example. However, all of the three patterns of information extracting methods may be set, or alternatively, these information extracting methods which are used in a predetermined order until the attribute value is extracted may be set.

The information extracting component 1150 extracts an attribute value based on the information extracting method determined by the information extracting method switching component 1140 (step S2070).

At this time, the information extracting component 1150 determines an ontology to be referred to depending on the type of attribute to be extracted, and extracts an attribute value using the ontology.

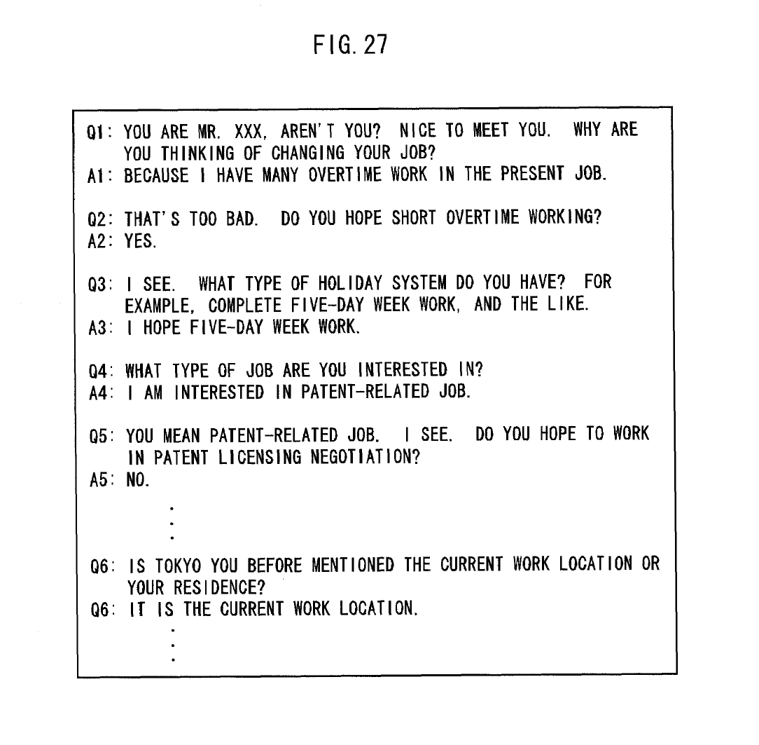

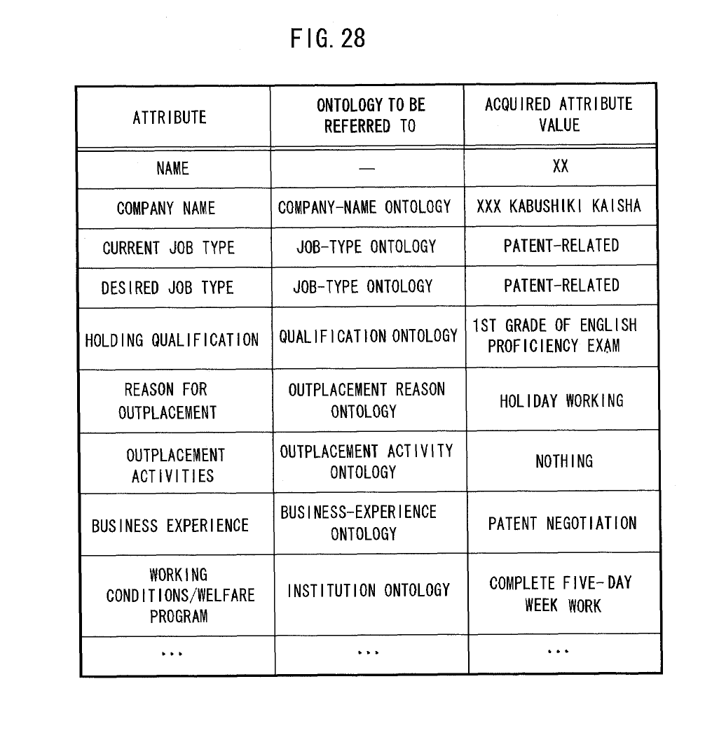

FIG. 27 shows an example of the user input sentence 1120. FIG. 28 shows the relationship between the ontology to be referred to by the information extracting component 1150, and the attributes.

For example, in FIG. 27, Q3 is a question for “working conditions/welfare programs”, and A3 is the responses thereto. In this case, the information extracting component 1150 refers to, from the relationship shown in FIG. 28, the “institution ontology” (FIG. 23B) that corresponds to the attribute “working conditions/welfare programs”.

The information extracting component 1150 extracts, while referring to the “institution ontology” shown in FIG. 23B, from the response information of the user U1 of “I hope to work with a five-day workweek.” of A3, the “full five-day workweek system” which matches the character string “five-day workweek”, as the attribute value.

In this manner, the information extracting component 1150 extracts an attribute value while referring to an ontology corresponding to the attribute.

In the aforementioned example, the information extracting method is shown by way of example in a case of using matching of character strings or matching of the result of morphological analysis, but other examples are also shown.

For example, in FIG. 27, Q4 is a question for the attribute “desired job type”, and A4 is the response thereto. The information extracting component 1150 refers to the “job-type ontology” corresponding to the attribute “desired job type”.

In this case, if the information extracting method switching component 1140 analyzes the sentence “I see that the job you are interested in is patent-related work” of A4, it recognizes that this sentence has a structure including a noun and a verb. Then, the syntactic analysis is effected for the sentence A4, and when the sentence A4 has a predetermined sentence structure (for example, the sentence structure “(nominative) is (objective)”, the information extracting method switching component 1140 switches the information extracting method from the matching method of character strings to the method using a syntactic analysis result. As a result, the information extracting component 1150 analyzes that, from the sentence structure of A4, “job you are interested in (nominative)” is equal to “patent-related (objective)”, and extracts, as the attribute value, “patent-related” which matches the character string of the objective “patent-related”.

Further, for example, in FIG. 27, the sentence Q5 is a delving deeper question for the attribute “desired job type”, and the sentence A5 is the response thereto.

The sentence Q5 is an interrogative sentence “Do you hope to engage in patent license negotiation?” In this case, the information extracting component 1150 extracts “NO” as the response to the sentence A5, and the user U1 is allowed to select a job type other than “patent license negotiation” in the “patent-related” for the attribute “desired job type”, as the intention of the user U1.

Further, the information extracting component 1150 determines that ambiguity exists for an ambiguous attribute value for which it is not known what type of attribute the attribute value corresponds to (step S2080), and the information having ambiguity is given to the dialogue managing component 10. As a result, due to control of the dialogue managing component 10, the ambiguous information is presented to the user U1 and can be selected by the user U1 (step S2090).

For example, in FIG. 27, the sentences Q6 and A6 indicate a case in which, in the previous dialogue, the user U1 has given the response “Tokyo”. In this case, the attribute value “Tokyo” has been given in response by the user U1, but it is not understood whether “Tokyo” means the “work location” or the “residence”.

Accordingly, the information extracting component 1150 gives, to the dialogue managing component 10, information that “Tokyo” is an attribute value having ambiguity. As a result, the dialogue managing component 10 poses a question for inquiring as to the attribute of the attribute value “Tokyo”, that is, “Is Tokyo which you mentioned before your current work location or your residence?” as in the sentence Q6. Then, the information extracting component 1150 extracts the attribute “work location” from the response A6 to the question Q6, “It is my current work location.”, whereby the set of the attribute “work location” and the attribute value “Tokyo” is acquired.

As described above, the set of the attribute and the attribute value of the user input sentence 1120 extracted by the information extracting component 1150 is stored by the information storing component 1170 in the personal registration data DB 1190 (step S2100).

As described above, the set of the attribute and the attribute value extracted from the retrieval object data 1110 and the user input sentence 1120 is stored by the information extracting device 1100 in the object data DB 1180 and the personal registration data DB 1190. Subsequently, under the control of the dialogue managing component 10, due to matching processing using the matching component 20, the object information that the user U1 is conscious of is retrieved and the retrieved information is introduced to the user U1.

### (C-3) Effects of Third Embodiment

As described above, the third embodiment makes it possible to properly switch the information extracting method corresponding to the structure of the input information by means of the information extracting method switching component. Therefore, even if the dialogue is developed variously, information included in the dialogue can be properly extracted by the information extracting method corresponding to the structure of the input information.

### (C-4) Other Embodiments

(C-4-1) In the third embodiment, as an example of the service site, a job introduction site for people changing jobs is shown, but the present invention is not limited thereto and can be widely applied to information existing on a network.

Further, with respect to the information on the network, text data, image data, moving image data, sound data and the like can be set as retrieval object data.

(C-4-2) The functions of various constituent elements realized by the laddering search engine and information extracting device described in the third embodiment are realized by software processing. For example, the hardware configuration is constituted by, for example, a CPU, a ROM, a RAM and the like, and the functions of these various constituent elements are realized by the CPU to execute a processing program stored in the ROM by execution using data required for the processing.

(C-4-3) The information extracting device described in the third embodiment is not limited to the structure in which the various elements are physically mounted in the same apparatus, and the various constituent elements may also be mounted in dispersed apparatuses. That is to say, the various constituent elements may be arranged in a dispersed manner.

Further, the language used is not limited to Japanese, and foreign languages such as English and Chinese can be widely applied.

### (D) Fourth Embodiment

The fourth embodiment of a dialogue system, a dialogue method and a dialogue program according to the present invention will be described hereinafter in detail with reference to the attached drawings. The laddering type retrieving system to which the dialogue system, dialogue method and dialogue program of the present invention can be applied is described in the first embodiment.

### (D-1) Structure of Fourth Embodiment

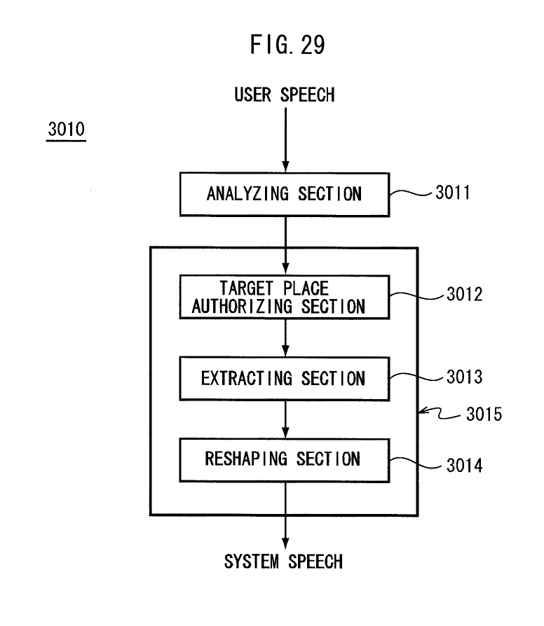

FIG. 29 is a functional block diagram that shows the main structure of a dialogue system 3010 according to the fourth embodiment. In FIG. 29, a user speech is inputted and component parts which generate a system speech are shown.

The dialogue system 3010 may also be configured as a part of an apparatus larger than, for example, the laddering type retrieving device or the like. Further, the dialogue system 3010 may also be configured by installing a dialogue program (including fixed data and the like) in a general-purpose information processing apparatus such as a personal computer (PC) or a server. In either case, functionally, the dialogue system can be shown with the structure shown in FIG. 29. Installation of the dialogue program is not limited to a download method via a communication network, and a method using a recording medium that is readable by a computer may also be employed. For example, if the system is used as a part of the laddering type retrieving device having the function of retrieving and proposing the work location to which a user is about to change jobs, the dialogue system 3010 is installed on the Web server that offers a site for providing the work location to which a user is about to change jobs.

In FIG. 29, the dialogue system of the fourth embodiment has an analyzing section 3011, a target place authorizing section 3012, an extracting section 3013 and a reshaping section 3014. The target place authorizing section 3012, extracting section 3013 and reshaping section 3014 form a repeated response generating section 3015.

Inputted to the dialogue system 3010 is a user speech constituted by a natural language sentence. For example, the natural language sentence (text) that the user inputs in the field for input of a speech sentence on the Web page displayed on a personal computer serving as a user terminal is inputted to the dialogue system 3010. Further, for example, an apparatus having the dialogue system 3010 installed therein may take in the user's speech using an input device such as a keyboard. Moreover, for example, the user's speech may also be taken in by performing recognition processing of voice (an audio signal) captured by a microphone at the user terminal or by a microphone of an apparatus having the dialogue system 3010 installed therein.

The analyzing section 3011 is used to perform morphological analysis and syntactic analysis for the user speech, divide it into words (morphemes), and thereby clarify the structure of a sentence. As the morphological analysis or syntactic analysis, any existing analyzing method can be applied.

The target place authorizing section 3012 is used to recognize a position of elements which are suitable for producing a repeated response. The criterion of determination and the determination method are described later in the description of the operation, but some criteria of determination are described below. The place of “predicate plus its objective or nominative” near the end of the user speech is targeted at as (a candidate of) the target place. The place of “noun plus its modifier” near the end of the user speech is targeted at as (a candidate of) the target place. The place of intention and subjectivity expressions such as “muri(JP)/[not possible(EN)]”, “komaru(JP)/[distressed(EN)]”, “shi-tai(JP)/[hope to(EN)]”, “dekinai(JP)/[cannot(EN)]” and the like, or several words including expressions similar to the above in the user speech are targeted at as (a candidate of) the target place. Rather than the intention and subjectivity expressions themselves, portions where specific contents for “komaru(JP)/[distressed(EN)]” and “shitai(JP)/[hope to(EN)]” are described are targeted at as (candidates of) the target places. The target place authorizing section 3012 performs, when a plurality of (candidates of) target places exists, narrowing-down processing at one target place in accordance with a predetermined rule. Concrete methods will be clearly described in the section concerning operation.

The extracting section 3013 is used to extract (select) a portion having a natural length (a subtree in a syntactic tree structure) for a repeated response from a target place and its vicinities in the user speech authorized by the target place authorizing section 3012. As described below in the section concerning operation, any number of words that is not greatly different from a standard length (for example, if the standard length is three words, then four or two words) predetermined according to the type of expression is admitted. Incidentally, a configuration may be provided in which the upper limit of the word count is set, rather than the standard length, to secure a natural length in a repeated response (in the case of a short length, forced increase of length (words) should not be executed). The extracting section 3013 also performs shortening of word strings in a case in which a long portion (a subtree of a parsing tree) is not admitted. In the shorting processing, an objective or a nominative is eliminated, or a modifier is eliminated.

The reshaping section 3014 is used to alter (or reshape) an expression in a case in which the portion for a repeated response obtained by the extracting section 3013 corresponds to a predetermined rule. For example, the tense of the sentence is converted, or the sentence is converted to an honorific expression. Further, in a case in which a noun (phrase) is extracted, the phrase “desu/ne?(JP) or “desu/ne(JP)” [“, don't you?”, “aren't you”, or the like (EN)] may be added.

The portion for a repeated response subjected to processing by the reshaping section 3014 becomes a system speech (natural language sentence). The system speech is embedded and displayed on the Web page shown in the personal computer serving as the user terminal. Further, for example, the apparatus having the dialogue system 3010 installed therein may be equipped with a display device so as to display the system speech. Moreover, a method of performing voice synthesis for a system speech constituted by text data and producing voice (an audio signal) from a speaker of the user terminal or a speaker of an apparatus having the dialogue system 3010 installed therein, may also be provided.

The analyzing section 3011, the target place authorizing section 3012, the extracting section 3013 and the reshaping section 3014 are realized by, for example, a dedicated control device or a processor that executes a program (CPU), and hardware resources including a storage device such as a random access memory (RAM) in which a program executed by the processor and data are stored, a ROM, a HDD and the like.

Further, in the forgoing, descriptions have been given respectively for each of the functions, but it is not necessary to clearly separate the physical structure of the hardware to be realized for each section and prepare these sections independently. For example, a HDD in which a program of the target place authorizing section 3012 is stored may be used in common as a HDD in which analyzing dictionary data of the analyzing section 3011 is stored, and further, a part of a device that realizes other functions may also be utilized. Moreover, a part that forms the dialogue system 3010 may be disposed at a different location connected via the network.

### (D-2) Operation of Fourth Embodiment

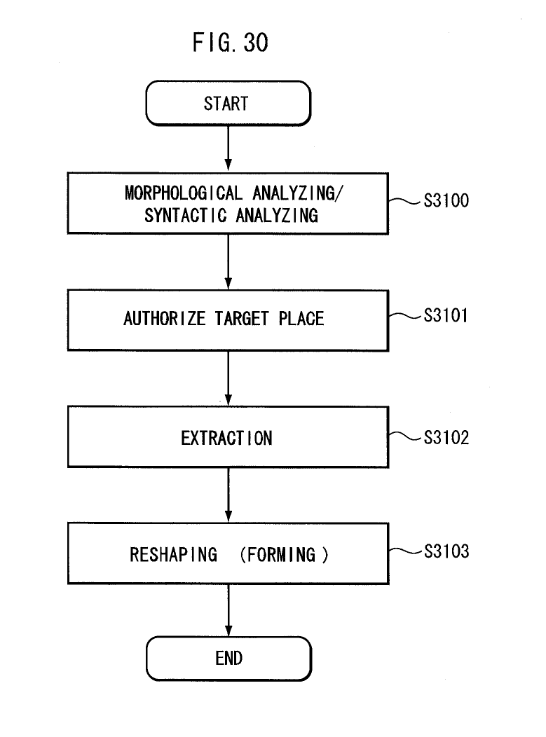

Next, operation of the dialogue system according to the fourth embodiment having the aforementioned parts (a dialogue method according to the fourth embodiment) is described with reference to the attached drawings. FIG. 30 is a flow chart that shows operation of the dialogue system 3010 according to the fourth embodiment.

When the user speech is inputted, the dialogue system 3010 according to the fourth embodiment starts the processing shown in FIG. 30, and executes morphological analysis and syntactic analysis by the analyzing section 3011 (S3100), the target place authorization by the target place authorizing section 3012 (S3101), extraction by the extracting section 3013 (S3102), and reshaping (forming) by the reshaping section 3014 (S3103) in a sequential manner, thereby allowing formation of the system speech. The respective processing of steps S3100, S3101, S3102 and S3103 are hereinafter described in detail.

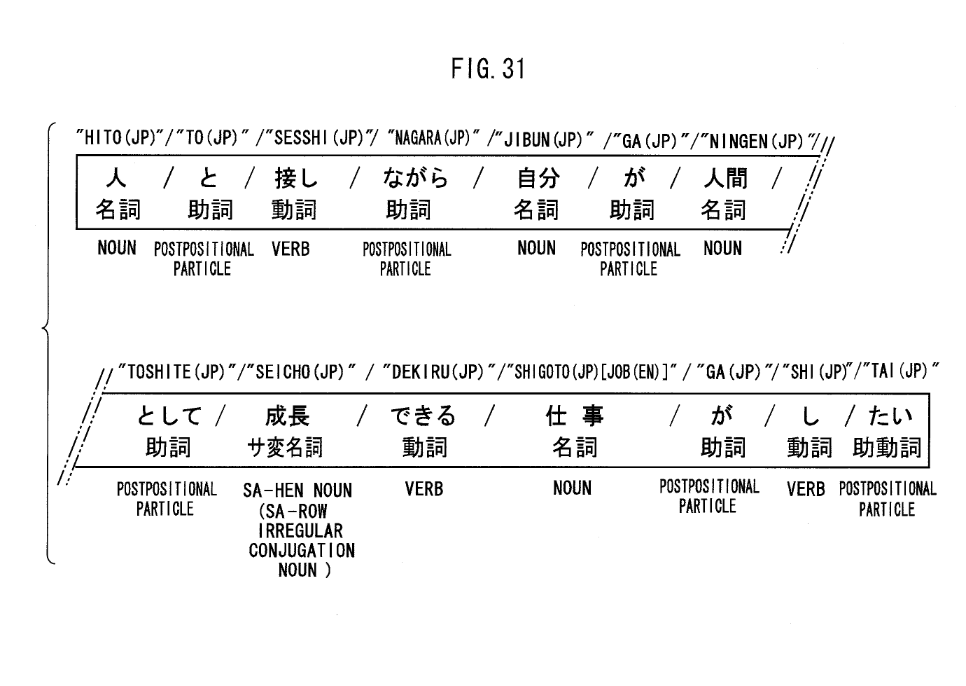

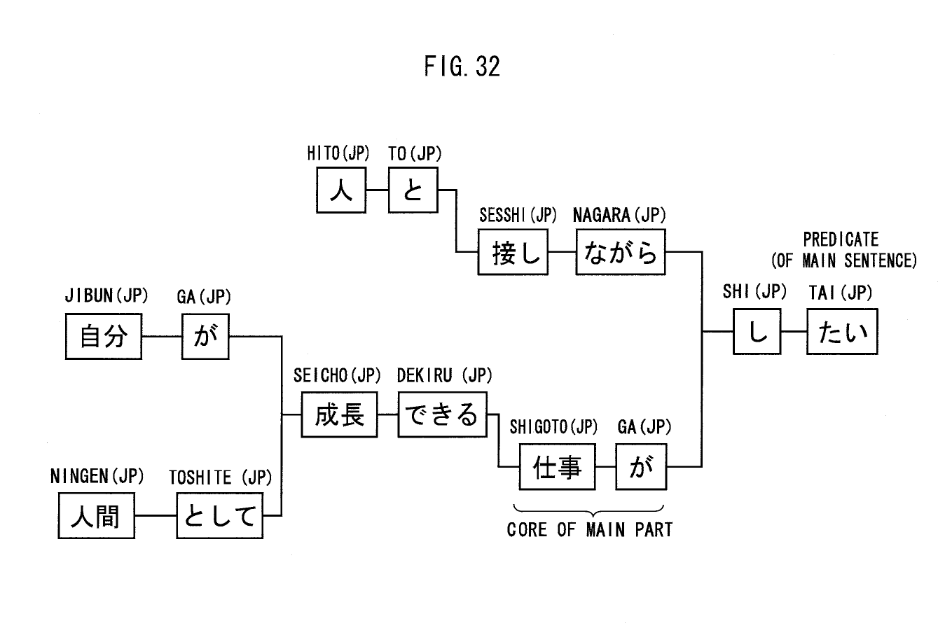

The analyzing section 3011 effects morphological analysis and syntactic analysis by any well known analyzing method (S3100). FIG. 31 shows the result of morphological analysis for the user speech “hito(JP)/to(JP)/sesshi(JP)/nagara(JP)/ jibun(JP)/ga(JP)/ningen(JP)/toshite(JP)/seichou(JP)/dekiru(JP)/shigoto(JP)/ga(JP)/ shi(JP)/tai(JP)”. FIG. 32 shows the result of syntactic analysis (syntactic tree) for the result of the morphological analysis.

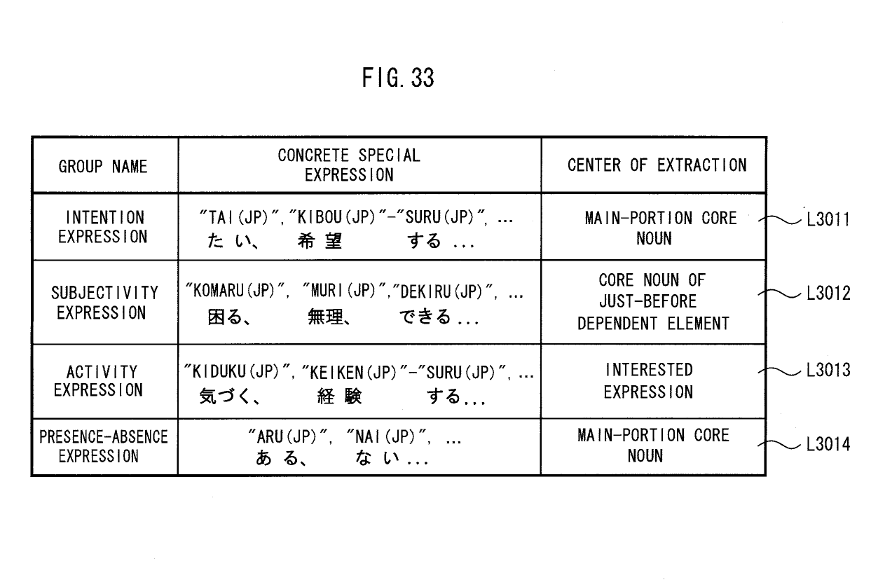

The target place authorizing section 3012 recognizes a portion intended for a repeated response while using an special expression list for authorization shown in FIG. 33, which is embedded in the section 3012 (S3101).

The special expression list for authorization defines, as shown in FIG. 33, a group name, concrete special expression, and center of extraction.

The first line L3011 means, when the user speech includes the special expressions such as “tai(JP)/[hope to (EN)]”, “kibou/suru(JP)/[hope to(EN)]” and the like (in this list, expressions are described in the present form or the original form, but they are applicable to other forms stated in the user speech; the same also applies to the other lines), these expressions belong to the group of “intention expression”, and a core noun of a nominative part corresponding to a predicate part which contains these expressions, is placed at the center of extraction. The example of an analysis result shown in FIG. 32 includes “tai(JP)”, and therefore, corresponds to the aforementioned case, and “shigoto(JP)/[job(EN)],” which is a core noun of the nominative part, is placed at the center of extraction.

The second line L3012 means, when the user speech includes special expressions such as “komaru(JP)/[distressed(EN)]”, “muri(JP)/[not possible(EN)]”, “dekiru(JP)/[can(EN)]” and the like, these expressions belong to the “subjectivity expression” group, and a core noun in a most adjacent (precedent) dependent element of these expressions is placed at the center of extraction. The example of the analysis result shown in FIG. 32 includes “dekiru(JP)”, and therefore, corresponds to the aforementioned case, and “seicho(JP)/[grow(EN)],” which is the core noun in a most adjacent (precedent) dependent element, is placed at the center of extraction. Further, if the user speech “. . . zangyo(JP)/ga(JP)/sukunai(JP)/tokoro(JP)/de(JP)/nai(JP)/to(JP)/ komari(JP)/masu(JP)” [/“I will be distressed if it is not a place at which I have to work overtime only a few days in a month. (EN)”] is given, “tokoro(JP)/[place(EN)]” would become the center of extraction.

The third line L3013 means, when the user speech includes special expressions such as “kiduku(JP)/[notice(EN)]”, “keiken/suru(JP)/[experience(EN)]” and the like, they belong to the group of “activity expression”, and the special expression itself is the core word and is placed at the center of extraction. For example, if the user speech “. . . ikaseru(JP)/shigoto(JP)/datte(JP)/kiduita-ndesu(JP)” [/“I noticed that I would be able to utilize my experiences for the job (EN)”] is given, the word “kiduku(JP)” is placed at the center of extraction (“kiduita (JP)” is the past tense form of “kiduku (JP)”).

The fourth line L3014 means, when the user speech includes special expressions such as “aru(JP)/[present(EN)]”, “nai(JP)/[absent(EN)]” and the like, they belong to the group of “yes-no” expression, and the core noun of the nominative part corresponding to the predicate part which contains these expressions, is placed at the center of extraction. For example, if the user speech “. . . nobite(JP)/iru(JP)/tokoro(JP)/no(JP)/hou(JP)/ga(JP)/shanai(JP)/no(JP)/ikioi(JP)/ga(JP)/ari(JP)/sou(JP)/dakara(JP)” [/“I think that people of the corporation, performance of which is improving, may have power (EN)”] is given, “ikioi(JP)/[power(EN)]” is placed as the center of extraction.

In the target place authorizing section 3012, it is confirmed as to whether the expression given in the “concrete special expression” in the special expression list for authorization in FIG. 33 exists in the aforementioned analysis result. If the expression exists, the target place authorizing section 3012 recognizes, as the target place, a portion of the analysis result (user speech) corresponding to the “center of extraction” on the corresponding line in the special expression list. If a plurality of authorized target places exist, in the syntactic analysis result, a portion nearest the predicate of the principal sentence is selected. That is to say, the selection is made in view of a distance in the syntactic analysis result, not the distance set as an appeared character string. Referring to the syntactic analysis result shown in FIG. 32, in matching with the list of special expressions, the target place “shigoto(JP)/[job(EN)]” dependent on the special expression “tai(JP)”, and the target place “seichou(JP)” dependent on the special expression “dekiru(JP)” are found. The target place that is at a short distance from the predicate of the principal sentence “shitai(JP)” is “shigoto(JP)” as clearly seen from the FIG. 32, and therefore, the target place “shigoto(JP)” is placed at the center of extraction.

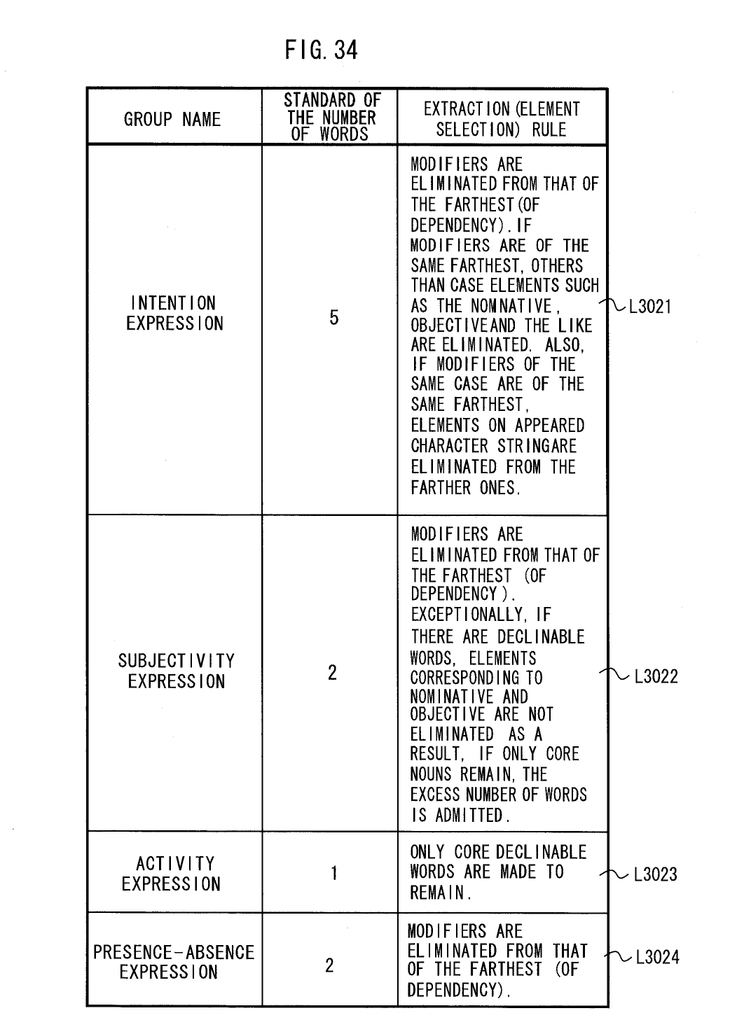

The extracting section 3013 extracts the user speech portion to be used in a repeated response while using the embedded extracting special expression list shown in FIG. 34 (S3102). The extracting section 3013, basically, extracts the user speech portion for a repeated response by taking out a subtree (a tree-shaped group resulting from the syntactic analysis) rooted from the word (group) of the center of extraction at the target place, authorized by the target place authorizing section 3012. The extracting section 3013 determines whether the extracted user speech portion falls within the upper-limit number of words set based on a standard of number of words described below in the list of special expressions to be extracted. If the user speech portion falls within the upper-limit number of words, the extracted user speech portion is made into an extraction result in an unchanged state. If it does not fall therein, some words are removed from the extracted user speech portion in accordance with an extraction (element selection) rule described below in the list of special expressions to be extracted, so that the user speech portion is made to fall within the range that is equal to or less than the upper-limit number of words, and the user speech portion after eliminated is set as an extraction result.

The list of special expressions to be extracted regulates, as shown in FIG. 34, a group name, a standard of number of words, and an extraction rule.

First line L3021 shows that the standard of the number of words at a predetermined portion belonging to the “intension expression” group is 5, and when the number of words in the extracted user speech portion (subtree) is greater than the upper-limit number of words set based on the standard of the number of words, the words in the subtree is removed in such a way as described below. First, the most distant dependent element from the center of extraction (see FIG. 33) is removed. Secondly, if the dependent elements have the same distance from the center of extraction, those other than case elements such as a nominative case, an objective case and the like are removed. Thirdly, if all the most distant elements are case elements, the most distant case element on the basis of character string is removed. In this case of removal, a word or a subtree branch is used as a minimum unit, and removal according to the first to third rules is repeated until the user speech falls within the upper-limit number of words. For example, assuming that the upper-limit number of words is set to be the standard of the number of words plus one word, the upper limit number of words for the “intension expression” group becomes six words.

For the result of syntactic analysis shown in FIG. 32, the “shigoto(JP)/L[job(EN)]” is the center of extraction and forms a root, as described above. Therefore, when the user speech portion (subtree) intended for a repeated response is taken out, the phrase “jibun(JP)/ga(JP)/ningen(JP)/toshite(JP)/ seicho(JP)/dekiru(JP)/shigoto(JP)” (seven words) is extracted at first. This phrase includes words that exceed six words, that is the upper-limit number of words, and therefore, some words are removed. In this case, dependent elements “jibun(JP)/ga(JP)” and “ningen(JP)/toshite(JP)” have the same distance from “shigoto(JP)”, but based on the second rule in which elements other than the case elements are removed, a nominative case “jibun(JP)/ga(JP)” is not removed and the phrase “ningen(JP)/toshite(JP)” is removed. As a result, the number of words becomes five and falls within the upper limit number of words (six words), and therefore, the phrase “jibun(JP)/ga(JP)/seichou(JP)/dekiru(JP)/shigoto(JP)” becomes the extraction result. The extraction result is the structure having two sections linked together, but not a portion having continuous user speeches.

Explained above is the case when the number of the elements in the extracted subtree exceeds upper limit. However, there may be rules to add some words to the subtree when the number of the elements is less than the lower limit (the same applies to any line of FIG. 34). The addition rule may be made symmetrical with the removal rules. For example, first, the most adjacent dependent element to the center of extraction (see FIG. 33) is added. Secondly, if the dependent elements have the same distance to the center of extraction, the case elements such as a nominative case, an objective case and the like are added preferentially. Thirdly, if all the most adjacent elements are not case elements, the most adjacent case element on the basis of character string is added.

The second line L3022 shows that the standard of the number of words at a predetermined portion belonging to the “subjectivity expression” group is 2, and when the number of words in the extracted user speech portion (subtree) is greater than the upper-limit number of words set based on the standard of the number of words, the most distant dependent element from the center of extraction (see FIG. 33) is removed. However, the following two cases are regarded as exceptions. When a declinable word (adjectives, verbs, etc) is included in a dependent element, elements corresponding to the subjectivity case and the objective case are not removed, as an exception. And when only the core noun remains if some words are removed by the rules, the extraction result holds the state in which the number of words is greater than the upper limit, without carrying out the removal.

If the user speech “zangyo(JP)/ga(JP)/sukunai(JP)/tokoro(JP)/de(JP)/ nai(JP)/to(JP)/komarimasu(JP)” is given, the word “tokoro(JP)/[place(EN])” becomes the center of extraction as described above, and the phrase “zangyo(JP)/ga(JP)/sukunai(JP)/tokoro(JP)” is first taken out as the user speech portion (subtree) to be intended for a repeated response. The number of words in the subtree exceeds the upper-limit number of words according to the rule L3022. In this case, the phrase “zangyo(JP)/ga(JP)” is more distant and therefore, it is to be removed. However, the declinable word “sukunai(JP)” exists for “zangyo(JP)/ga(JP)”, and therefore, the phrase “zangyo(JP)/ga(JP)” is not removed. In order that the number of words in the user speech may fall within the upper-limit number of words, there is no choice but to remove all of “zangyo(JP)/ga(JP)/sukunai(JP)”, but if so, only the core noun “tokoro(JP)/[place(EN)]” remains, and therefore, a user speech having an excess number of words over the upper limit is admitted, whereby the “zangyo(JP)/ga(JP)/sukunai(JP)/tokoro(JP)/” is set as the final extraction result.

The third line L3023 shows that the standard of the number of words at a predetermined portion belonging to the “activity expression” group is 1, and a description in which only the core noun recognized as the center of extraction (see FIG. 33) is set as the extraction result is given.

For example, in the user speech “ikaseru(JP)/shigoto(JP)/datte(JP)/kiduitandesu(JP)”, when the word “kiduku(JP)” becomes the center of extraction, the word “kiduku(JP)” cannot be particularly segmented, and therefore, only the core noun is set as the extraction result, and removal of words is not executed.

The fourth line L3024 shows that the standard of the number of words at a predetermined place that belongs to the “yes-no” group is 2, and when the number of words in the extracted user speech portion (subtree) is greater than the upper limit number of words set based on the standard of the number of words, the most distant dependent element from the center of extraction (see FIG. 33) are removed.

For example, in the user speech “nobite(JP)/iru(JP)/tokoro(JP)/no(JP)/ hou(JP)/ga(JP)/shanai(JP)/no(JP)/ikioi(JP)/ga(JP)/ari(JP)/sou(JP)/dakara(JP)”, if the word “ikioi(JP)/[power(EN)]” is the center of extraction, the phrase “shanai(JP)/no(JP)/ikioi(JP)” (three words) are taken out as the user speech portion (subtree) intended for a repeated response. The phrase “shanai(JP)/no(JP)/ikioi(JP)” (three words) falls within the upper-limit number of words, and therefore, the phrase “shanai(JP)/no(JP)/ikioi(JP)” becomes the extraction result just as it is. The syntactic tree is not described, but the phrase “nobite(JP)/iru(JP)/tokoro(JP)/no(JP)/hou(JP)/ga(JP)” is directly dependent on the phrase “ari(JP)/sou(JP)”. Therefore, the former phrase is not intended to be extracted from the viewpoint of the center of extraction “ikioi(JP)”.

The reshaping section 3014 reshapes (forms) a character string of the extraction result by the extracting section 3013 in accordance with the reshaping rule recorded internally as mentioned below (S3103). For example, a correspondence table for conversion to honorific language is prepared, and when an object language matches a headword, it is reshaped (converted). As an example, a correspondence table in which the word “kiduku(JP)” is converted to honorific language “kidukareru(JP)”, and the “jibun” is converted to respect language “gojibun(JP)” is prepared and used. In addition, for example, if only the extraction result ends with the noun (phrase), the phrase “desu(JP)/ne(JP)?” or “desu(JP)/ne(JP)” is added. Finally, general morphological synthesis (a process opposite to morphological analysis) is performed and the user speech is outputted in the form using natural conjugational words.

When respective processes of the target place authorizing section 3012 and the extracting section 3013 are finished, if there are no words to be extracted, the system speech having a repeated response is not given.

### (D-3) Effects of Fourth Embodiment

According to the fourth embodiment, the special expression list for authorization is prepared. The intention and subjectivity expressions in the user speech are searched for in the list, and the intention and subjectivity expressions or their neighboring elements are utilized preferentially for the response (system speech). Therefore, it is possible to effectively produce the feeling of sympathy to the user.

Further, according to the fourth embodiment, unlike a conventional device, rather than only a predicative and the central word of a case element being extracted, a place to be used preferentially is determined, and words or ones neighboring thereto that are to be used for the response are determined. In addition, word elements are removed (added) so that the response length matches a length of the standard as previously set, whereby the length of the system response becomes a natural length, so as to ensure naturalness of the dialogue.

Moreover, reshaping (restatement processing) is applied to a portion extracted from the user speech by the reshaping section 3014, so as to produce the final system speech in the form of repeated words. Therefore, it is possible to prevent formation of a monotonous or unnatural response.

As described above, the sympathetic feeling is effectively produced, and as a result of ensuring naturalness of the dialogue, the dialogue is stimulated and information is readily collected from the user.

### (E) Fifth Embodiment

Next, the fifth embodiment of a dialogue system, a dialogue method and a dialogue program according to the present invention will be described in detail with reference to the attached drawings.

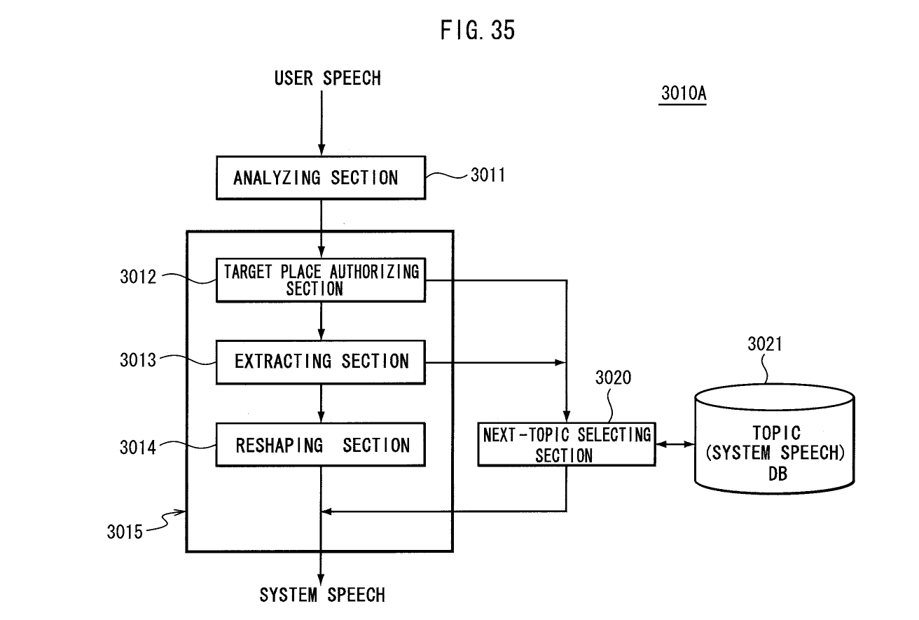

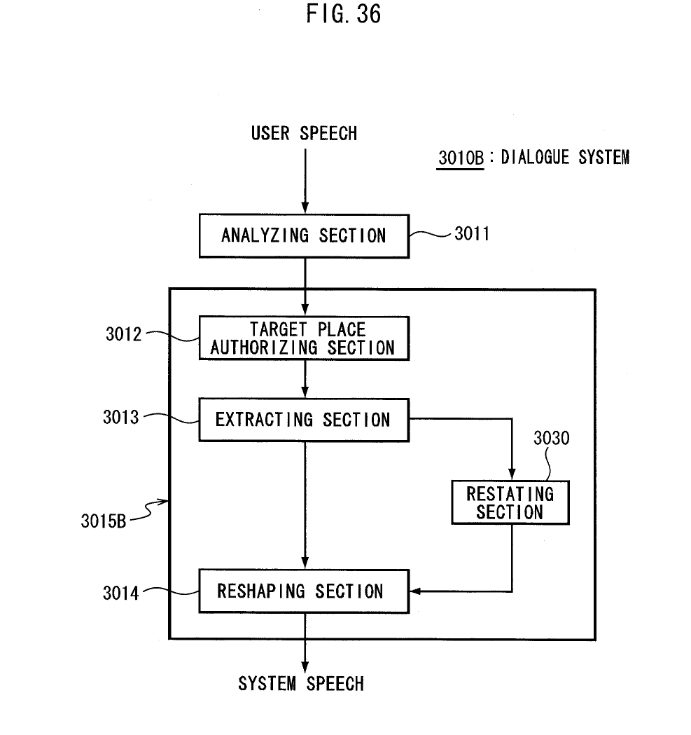

FIG. 35 is a functional block diagram that shows the main structure of a dialogue system 3010A according to the fifth embodiment. The same and corresponding portions as those shown in FIG. 29 according to the fourth embodiment are denoted by the same reference numerals.

The dialogue system 3010A according to the fifth embodiment has a next-topic selecting section 3020 and a topic database 3021 in addition to the structure of the dialogue system 3010 of the fourth embodiment.

The topic database (topic DB) 3021 stores therein dialogue scenario information, a system speech and the like. For example, if the dialogue system 3010A is incorporated in a retrieving device used to introduce job openings, system speeches for many items such as desired work location, desired annual income, working time (including allowable overtime), days of duty and the like are stored, and are also stored for respective items in a hierarchical manner (for example, if a user hopes for the Kanto area in the user speech in response to the system speech inquiring the desired work location, the process passes to the system speech in which the user's hope is extracted at the stage of a smaller area). In addition, the aforementioned topic database stores therein a method of transferring a system speech in a certain item (dialogue scenario), and a system speech transfer method in which if collection of information for a certain item is finished, an item for which a system speech to be transferred is outputted is determined (dialogue scenario).

In the fifth embodiment, when the target place authorizing section 3012 cannot authorize the target place, it notifies the next-topic selecting section 3020 of this information. Further, when the extracting section 3013 cannot effect extraction, it notifies the next-topic selecting section 3020 of this information. When the authorization and the extraction is not successful, the next-topic selecting section 3020 takes out and outputs the system speech (next topic) in accordance with the contents stored in the topic database 3021.

The fifth embodiment can exhibit the same effects as those of the fourth embodiment, and also exhibit the effect of being capable of changing the topic at the initiative of the system. In other words, although there is the possibility that the topic will not change to another topic by repeated responses alone, the fifth embodiment can avoid this problem.

### (F) Sixth Embodiment

Next, the sixth embodiment of a dialogue system, a dialogue method and a dialogue program according to the present invention will be described in detail with reference to the attached drawings.

FIG. 36 is a functional block diagram showing the main structure of a dialogue system 3010B according to the sixth embodiment. The same and corresponding portions as those of FIG. 29 according to the fourth embodiment are denoted by the same reference numerals.

The dialogue system 3010B according to the sixth embodiment has a restatement section 3030 in a repeated response generating section 3015B in addition to the dialogue system 3010 of the fourth embodiment.

The restatement section 3030 has a synonymous-word dictionary built-in. All or a part of the extracted user speech portion is replaced by another expression if possible, and as a result, the extracted user speech portion is replaced by another expression having the same contents. The synonymous-word dictionary is, for example, a database including a certain phrase and its restated phrase in pair. For example, a database in which for a heading “umaku(JP)/mawaru(JP)”, the phrase “sumu-su(JP)/ni(JP)/susumu(JP)” can be acquired as a replaced phrase. By referring to the database, when the phrase “shigoto(JP)/wa(JP)/umaku(JP)/mawatte(JP)/iru(JP)” is extracted from the user speech, it can be replaced by the phrase “shigoto(JP)/wa(JP)/sumu-su(JP)/ni(JP)/ susunde(JP)/iru(JP)” [/“Tasks are being proceeded smoothly (EN)”].

The reshaping section 3014 executes, when the restatement section 3030 does not operate, reshaping processing for the extraction result form the extracting section 3013. When the restatement section 3030 operates, the reshaping section 3014 executes reshaping processing for restated character strings of the extraction result, which are outputted from the restatement section 3030.

The sixth embodiment can exhibit the same effects as those of the fourth embodiment, and makes it possible to form a system speech by restating an expression used by the user, and also prevent monotony of the repeated response.

### (G) Seventh Embodiment

Next, the seventh embodiment of a dialogue system, a dialogue method and a dialogue program according to the present invention is described in detail with reference to the attached drawings.

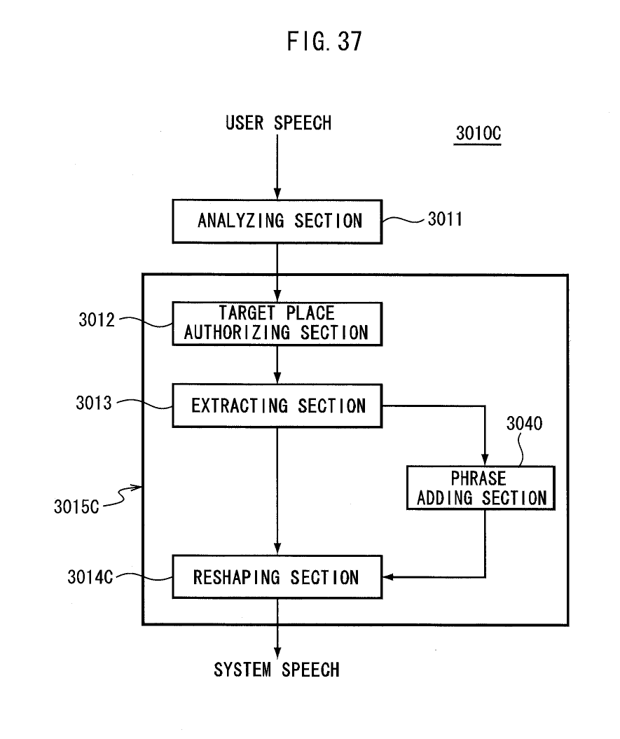

FIG. 37 is a functional block diagram showing the main structure of a dialogue system 3010C according to a seventh embodiment. The same and corresponding portions as those of FIG. 29 according to the fourth embodiment are denoted by the same reference numerals.

The dialogue system 3010C according to the seventh embodiment has a phrase addition section 3040 in a repeated response generating section 3015C in addition to the structure of the dialogue system 3010 of the fourth embodiment.

The phrase addition section 3040 has, built therein, a database for taking out addition phrases (responses), and in accordance with contents of the extraction result from the extracting section 3013 (or original contents of the user speech), a proper phrase is selected from among the addition phrases such as “soudesuka(JP)”, “tsuraidesune(JP)”, “taihendeshitane(JP)”, and “yokkatadesune(JP)”. For example, the phrase “sodesuka(JP)” is used as a general phrase to be added without consideration of feeling. For example, a database in which headings such as “dekinai(JP)”, “rarenai(JP)” or the like, and the phrase “tsuraidesune(JP)” are set in pairs is prepared, and if a heading in the database exists in the result extracted by the extracting section 3013, the phrase that forms a pair with the heading is selected and transferred to the reshaping section 3014C. Further, for example, a sub-group is provided in each of the groups in the special expression list for authorization shown in FIG. 33 (in the case of the subjectivity expression, a positive subjectivity expression to which the word “dekiru(JP)” corresponds, or a negative subjectivity expression to which the word “komaru(JP)” or “muri(JP)” corresponds is given), and the name of the sub-group may also be used at the side of the heading in the database used for taking out the addition phrases (responses).

The database used to take out addition phrases (responses) in the phrase addition section 3040 stores therein addition position information that defines whether the phrase is added before the repeated response to which it is added, or whether the phrase is added after the repeated response to which it is added, and the phrase addition section 3040 transfers a selected phrase and addition position information to the reshaping section 3014C. For example, the phrase “sodesuka(JP)” is set so as to be added before the repeated phrase, and the phrase “tsuraidesune(JP)” is set so as to be added after the repeated phrase.

The reshaping section 3014C adds the phrase (response) transferred from the phrase addition section 3040, before or after the repeated response after the reshaping processing, and outputs the phrase as the system speech.

The seventh embodiment can exhibit the same effects as those of the fourth embodiment, and the phrase (response) selected from a plurality of types is incorporated in the repeated response, thereby making it possible to exhibit the feeling of sympathy more strongly.

### (H) Eighth Embodiment

Next, the eighth embodiment of a dialogue system, a dialogue method and a dialogue program according to the present invention will be described in detail with reference to the attached drawings.

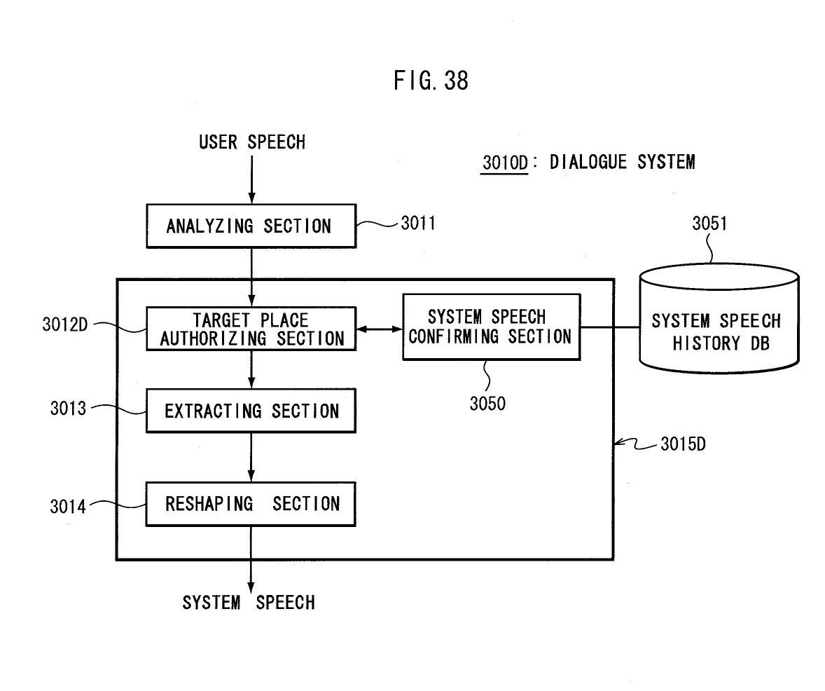

FIG. 38 is a functional diagram showing the main structure of a dialogue system 3010D according to the eighth embodiment. The same and corresponding portions shown in FIG. 29 according to the fourth embodiment are denoted by the same reference numerals.

The dialogue system 3010D according to the eighth embodiment has a system speech confirming section 3050 in a repeated response generating section 3015D in addition to the structure of the dialogue system 3010 of the fourth embodiment. Further, the dialogue system 3010D according to the eighth embodiment also has a system speech history database (system speech history DB) 3051 as a constituent element.

The system speech history database 3051 stores therein at least a directly previous system speech. For example, the database in which the dialogue (system speech and user speech) history is stored can be used as the system speech history database 3051 of the eighth embodiment.

The system speech confirming section 3050 receives, from the target place authorizing section 3012D, information of element word/phrase to be authorized as the target place (see the center of extraction in FIG. 33). The system speech confirming section 3050 confirms whether or not the element word/phrase to be authorized as the target place matches a word included in the directly previous system speech existing in the system speech history database 3051. If the directly previous system speech includes an element word/phrase to be authorized as the target place, the system speech confirming section 3050 notifies the target place authorizing section 3012D, and eliminates the element word/phrase from the authorization candidate of the target place.

For example, in a case in which there is one candidate of element word/phrase to be authorized as the target place, when it is removed from the authorization candidates of the target place, a repeated response is not made for the current user speech. Further, for example, in a case in which there are a plurality of candidates of element language to be authorized as the target place, when a portion of them is removed from the authorization candidates of the target place, one of the remaining authorization candidates is selected.

The eighth embodiment has the same effects as those of the fourth embodiment. Further, candidates of the repeated response are each compared with the past system speech, and therefore, it is possible to prevent overlapping of the system speeches having the same contents by the repeated responses, so as to realize a natural dialogue.

### (I) Other embodiments

In the description of the aforementioned embodiments as well, various modified embodiments have been mentioned, but further modified embodiments as shown below by way of example can be applied.

The respective technical features of the aforementioned embodiments may be used in a combination of two or more if it is possible for them to be applied in combination.

In the fourth embodiment, the target place intended for a repeated word is shown while using the special expression list for authorization including concrete special expressions shown in FIG. 33. Additionally, the target place intended for a repeated word may be authorized using an attribute or an attribute value. For example, the target place intended for a repeated word may also be authorized by using expressions belonging to a time attribute or an area attribute. In the user speech “zangyo(JP)/wa(JP)/2-jikan(JP)/inai(JP)/de(JP)/onegai(JP)/shimasu(JP)” [/“I hope for a job in which the overtime is two hours or less(EN)”], or “30-pun(JP)/inai(JP)/no(JP)/zangyo(JP)/ga(JP)/yoi(JP)/desu(JP)” [/“I hope for a job in which the overtime is 30 minutes or less(EN)”], the target place may also be authorized using the time attribute so that the phrase “2-jikan(JP)/inai(JP)” [/“two hours or less(EN)”] or “30-pun(JP)/inai(JP)” [/“30 minutes or less(EN)”] becomes a candidate to be authorized at the target place intended for the repeated word. For the attribute value as well, the center of extraction as shown in FIG. 33, or the standard of the number of words or extraction rule as shown in FIG. 34 would be fixed.

The fifth embodiment shows a case in which, when no repeated response is effected, the system speech is switched to a next topic. However, a configuration may be provided in which, even when a repeated response can be effected, the system speech may be switched to the next topic. For example, a configuration may be provided in which, when the continuous number of times of using a repeated response is calculated, and the continuous number of times reaches a predetermined value, the system speech may be switched to a next topic. In this case, the system speech may also be formed by adding a repeated response prior to the next topic.

The sixth embodiment shows the case in which one candidate intended for being restated exists, but a plurality of candidates intended for being restated may also be prepared for the same original phrase. In this case, it suffices that a candidate which is restated in the first stage may be applied.

The seventh embodiment shows the case in which when a phrase addition condition is set, a phrase is constantly added. However, it suffices that in accordance with a continuous number of times of adding or an addition ratio, if the phrase addition condition is set, a determination may be made as to whether the phrase is added or not. For example, in the next system speech, prior to which addition of a phrase has been continuously performed twice, no phrase is added.

The eighth embodiment shows the case in which when an element word/phrase candidate at the target place is included in the directly previous system speech, it is removed from the group of candidates. However, in a case in which the element word/phrase candidate is included in the several directly preceding system speeches, it may be removed from the group of candidates.

In the aforementioned embodiments, examples in which Japanese is used have been described, but the present invention is not limited thereto. For example, other languages such as English may also be applied.

In the aforementioned embodiments, names of places in Japan and the like have been used, but the present invention is not limited thereto. For example, names of places in other nations such as the US may also be applied.

The retrieving system may be configured to include at least two of the first to eighth embodiments.

What is claimed is:

1. An information retrieving device comprising:
a user speech analyzing component that poses, to a user, question sentences for respective ones of a plurality of attributes during a dialogue with a user, and analyzes an attribute value for each of the attributes from an answer sentence from the user to a question sentence;
a user data holding component that, as a result of analysis by the user speech analyzing component, holds user data that allows the plurality of attributes, and respective user attribute values for the attributes to correspond to one another;
a matching component that, by referring to the user data, when an acquisition ratio of the attribute values from a received user answer sentence with respect to all of the attributes is a predetermined value or greater, selects at least one target data candidate that matches each of the attributes and each of the attribute values of the user data, from a plurality of target data; and
a dialogue control component that outputs each of the target data candidates selected by the matching component, to the user's side.

2. The information retrieving device of claim 1, wherein the matching component includes:
an evaluation value calculating section that, when the acquisition ratio of the attribute values is less than the predetermined value, calculates an evaluation value for each of the attributes values for all of the attributes in the user data; and
an attribute selecting section that, by referring to a predetermined attribute determination rule, performs attribute selecting processing that corresponds to a calculated result of the evaluation value obtained by the evaluation value calculating section.

3. The information retrieving device of claim 2, wherein the attribute selecting section selects dialogue scenarios that allow progression of a dialogue with the user, sequentially from attributes having higher precedence of the progression.

4. The information retrieving device of claim 1, wherein the dialogue control component outputs target data candidates sequentially from a target data candidate that matches an attribute having a highest precedence of the user's output.

5. An information retrieving method comprising:
(a) posing, to a user, a question sentence about each of a plurality of attributes during a dialogue with the user, and analyzing an attribute value for each of the attributes from an answer sentence from the user to the question sentence;
(b) holding, as a result of the analyzing in (a), user data in which the plurality of attributes and user attribute values for each of the attributes correspond with each other;
(c) with reference to the user data, selecting at least one target data candidate that matches each of the attributes of the user data, and each of the attribute values, from a plurality of target data, when an acquisition ratio of the attribute values from a received user answer sentence with respect to all of the attributes is a predetermined value or greater; and
(d) outputting each of the target data candidates selected in (c) to the user's side.

6. A storage medium readable by a computer, the storage medium storing a program of instructions executable by the computer to perform a function for information retrieval, the function comprising:
(a) posing, to a user, a question sentence about each of a plurality of attributes during a dialogue with the user and analyzing an attribute value for each of the attributes from an answer sentence from the user to the question sentence;
(b) holding, as a result of the analyzing in (a), user data in which the plurality of attributes and user attribute values for each of the attributes correspond with each other;
(c) by referring to the user data, selecting, from a plurality of target data, at least one target data candidate that matches each of the attributes of the user data, and each of the attribute values, when an acquisition ratio of the attribute values from a received user answer sentence with respect to all of the attributes is a predetermined value or greater; and
(d) outputting each of the target data candidates selected in (c) to the user's side.

7. A dialog managing device comprising:
a dialogue scenario database in which a plurality of dialogue scenarios is stored;
a scenario selecting component that selects a dialogue scenario for information requested by an information requesting component, from the dialogue scenario database;
a response generating component that, based on the dialogue scenario selected by the scenario selecting component, generates a response sentence about the requested information and gives the response sentence to a user terminal;
a behavior determining component that receives, as an analysis result of an answer sentence, an attribute and an attribute value for the attribute from an answer sentence analyzing component that analyzes a user answer sentence to the response sentence, retrieves at least one of the dialogue scenarios corresponding to a response condition based on the attribute and the attribute value, from the dialogue scenario database, and determines a next behavior in accordance with each of the dialogue scenarios; and
a dialogue control component that effects control of a dialogue with a user in accordance with the next behavior determined by the behavior determining component.

8. The dialogue managing device of claim 7, wherein each dialogue scenario has an ordinary scenario that brings out an attribute value of the user for the attribute, and a special scenario that corresponds to an irregular speech from the user in the dialogue with the user and that facilitates a dialogue with the user.

9. The dialogue managing device of claim 7, wherein the dialogue scenarios each define the attribute, the response condition, and a response action that shows an operation subsequently executed when the scenario corresponds to the response condition.

10. The dialogue managing device of claim 8, wherein the response action of each of the dialogue scenarios includes response sentence continuing information having information for determining whether the response of the dialogue scenario continues or ends, or information that calls out another dialogue scenario.

11. The dialogue managing device of claim 7, wherein when at least one of the dialogue scenarios, which corresponds to the response condition, is retrieved from the dialogue scenario database based on the attribute and the attribute value, the behavior determining component retrieves the dialogue scenario from ordinary scenarios after retrieving from special scenarios.

12. The dialogue managing device of claim 7, wherein the response action of each of the dialogue scenarios has a precedence applied thereto, and when the behavior determining component retrieves the plurality of dialogue scenarios, the dialogue control component allows execution of the response action of each of the dialogue scenarios in accordance with the precedence applied to the response action.

13. A dialogue managing method comprising:
(a) selecting, from a dialogue scenario database, a dialogue scenario about information requested by an information requesting component;
(b) preparing a response sentence for the requested information based on the dialogue scenario selected in (a), and giving the response sentence to a user terminal;
(c) receiving, from an answer sentence analyzing component that analyzes a user answer sentence to the response sentence, an attribute and an attribute value for the attribute as an analysis result of the answer sentence, retrieving at least one of the dialogue scenarios, which corresponds to a response condition based on the attribute and the attribute value, from the dialogue scenario database, and determining the next behavior in accordance with each of the dialogue scenarios; and
(d) effecting control of a dialogue with a user in accordance with the next behavior determined in (c).

14. A storage medium readable by a computer, the storage medium storing a program of instructions executable by the computer to perform a function for dialogue management, the function comprising:
(a) selecting, from a dialogue scenario database, a dialogue scenario about information requested by an information requesting component;
(b) based on the dialogue scenario selected in (a), preparing a response sentence for the requested information, and giving the response sentence to a user terminal;
(c) receiving, from an answer sentence analyzing component that analyzes a user answer sentence to the response sentence, an attribute and an attribute value for the attribute, as a result of analysis of the answer sentence, retrieving at least one of the dialogue scenarios, which corresponds to a response condition, from the dialogue scenario database based on the attribute and the attribute value, and determining a next behavior in accordance with each of the dialogue scenarios; and
(d) effecting control of a dialogue with a user in accordance with the next behavior determined in (c).

15. A consciousness extracting system for extracting consciousness of a user based on dialogue information exchanged between the user and the system, comprising:
a dialogue managing device that gives a response sentence to a user terminal of the user, receives an answer sentence to the response sentence, and effects a dialogue with the user in accordance with a predetermined dialogue scenario;
an answer sentence analyzing device that analyzes the user answer sentence received from the user terminal; and
a dialogue information accumulating device that allows accumulation of dialogue information of each of the dialogue scenarios, for each user,
wherein the dialogue managing device includes:
a dialogue scenario database in which a plurality of dialogue scenarios is stored;
a scenario selecting component that selects a dialogue scenario for information requested by an information requesting component, from the dialogue scenario database;
a response generating component that, based on the dialogue scenario selected by the scenario selecting component, generates a response sentence about the requested information and gives the response sentence to a user terminal;
a behavior determining component that receives, as an analysis result of an answer sentence, an attribute and an attribute value for the attribute from an answer sentence analyzing component that analyzes a user answer sentence to the response sentence, retrieves at least one of the dialogue scenarios corresponding to a response condition based on the attribute and the attribute value, from the dialogue scenario database, and determines a next behavior in accordance with each of the dialogue scenarios; and
a dialogue control component that effects control of a dialogue with a user in accordance with the next behavior determined by the behavior determining component.

16. An information extracting device comprising:
a knowledge database that allows systematic classification of relationships between a plurality of words in a plurality of fields;
an input component that takes in input information;
an information extracting component that, if an attribute to be extracted, included in the input information is detected, extracts an attribute value for the attribute included in the input information using knowledge in a field relating to the attribute in the knowledge database; and
an extracted information storing component that stores therein the attribute and the attribute value of the attribute, extracted from the information extracting component, so that the attribute and the attribute value correspond to each other.

17. The information extracting device of claim 16, wherein the information extracting component has an information extracting method determining section that determines an extracting method for extracting the attribute value from the input information in accordance with predetermined designation information.

18. The information extracting device of claim 17, wherein the information extracting component extracts the attribute value for the attribute by means of matching between knowledge of a field relating to the attribute in the knowledge database, and a character string that forms the input information, or a morphological analysis result.

19. The information extracting device of claim 17, wherein when the input information is constituted by a predetermined sentence structure in which the attribute and the attribute value have a corresponding relationship, the information extracting component extracts the predetermined sentence structure by means of syntactic analysis of the input information.

20. The information extracting device of claim 17, wherein the information extracting component extracts information that shows a user's intention included in the input information.

21. An information extracting method comprising:
(a) taking in input information;
(b) when an attribute to be extracted, which is included in the input information, is detected, extracting an attribute value for the attribute included in the input information using knowledge of a field relating to the attribute in a knowledge database; and
(c) storing the attribute and the attribute value of the attribute extracted in (b) so that the attribute and the attribute value correspond to each other.

22. A storage medium readable by a computer, the storage medium storing a program of instructions executable by the computer to perform a function for information extraction, the function comprising:
(a) taking in input information;
(b) extracting, when an attribute to be extracted, which is included in the input information, is detected, an attribute value for the attribute included in the input information using knowledge of a field relating to the attribute in a knowledge database; and
(c) storing the attribute and the attribute value of the attribute extracted in (b) so that the attribute and the attribute value correspond to each other.

23. A dialogue system that has a dialogue with a human by transmitting and receiving data of a natural language sentence between the human and a device that interfaces with the human, comprising:
an analyzing section that analyzes a speech of the human;
a target place authorizing section that authorizes a target place at which an element used to produce a speech by the system is extracted from the speech of the human, by using the analysis result; and
an extracting section that extracts, based on the target place, an element from the human speech so that a system speech has a proper length.

24. The dialogue system of claim 23, further comprising a reshaping section that reshapes an extracted human speech element into a natural form as the system speech.

25. The dialogue system of claim 23, wherein the target place authorizing section has different target places to be authorized, depending on the kind of a special expression used in the human speech.

26. The dialogue system of claim 23, wherein the extracting section has different extracting methods depending on the kind of a special expression used in the human speech.

27. The dialogue system of claim 23, further comprising a next-topic selecting section that, when the target place authorizing section does not succeed in authorizing the target place, or when the extracting section does not succeed in extraction, takes out and outputs a system speech relating to a next topic from a topic database.

28. The dialogue system of claim 23, further comprising a restatement section that converts an element language extracted from the extracting section to another expression.

29. The dialogue system of claim 23, further comprising a phrase addition section that, when an element language extracted by the extracting section, or a trigger that responds to the human speech is included, generates a phrase of a response corresponding thereto,
wherein the response phrase is added to a system response fixed in accordance with an extraction result of the extracting section, so as to form a final system response.

30. The dialogue system of claim 23, further comprising a system speech confirming section that confirms whether a word at the target place, which is about to be authorized by the target place authorizing section, matches a word included in several directly preceding system speeches,
wherein the target place authorizing section is provided so as to inquire to the system speech confirming section when the target place is authorized, and when the word at the target place matches a word included in the several directly preceding system speeches, the target place authorizing section is further provided so as not to determine the target place.

31. A dialogue method of having a dialogue with a human by transmitting and receiving data of a natural language sentence between a dialogue system and a device that interfaces with the human,
the dialogue system including an analyzing section, a target place authorizing section and an extracting section,
the dialogue method comprising:
the analyzing section analyzing a speech of the human;
the target place authorizing section using the analysis result, and authorizing a target place used to extract an element used by the system to produce a speech, from the human speech; and
the extracting section extracting, based on the target place, an element from the human speech so that the system speech has a proper length.

32. A storage medium readable by a computer, the storage medium storing a program of instructions executable by the computer to perform a function for a dialogue, the function comprising:
analyzing a speech of a human;
authorizing a target place used to extract, from the human speech, an element used by the computer to produce a speech, by using the analysis result; and
extracting, based on the target place, an element from the human speech so that the speech of the computer has a proper length.

33. An information retrieving system comprising:
an information retrieving device;
a dialogue managing device;
an information extracting device; and
a dialogue system,
wherein
the information retrieving device includes:
a user speech analyzing component that poses, to a user, question sentences for respective ones of a plurality of attributes during a dialogue with a user, and analyzes an attribute value for each of the attributes from an answer sentence from the user to a question sentence;
a user data holding component that, as a result of analysis by the user speech analyzing component, holds user data that allows the plurality of attributes, and respective user attribute values for the attributes to correspond to one another;
a matching component that, by referring to the user data, when an acquisition ratio of the attribute values from a received user answer sentence with respect to all of the attributes is a predetermined value or greater, selects at least one target data candidate that matches each of the attributes and each of the attribute values of the user data, from a plurality of target data; and
a dialogue control component that outputs each of the target data candidates selected by the matching component, to the user's side,
the dialogue managing device includes:
a dialogue scenario database in which a plurality of dialogue scenarios is stored;
a scenario selecting component that selects a dialogue scenario for information requested by an information requesting component, from the dialogue scenario database;
a response generating component that, based on the dialogue scenario selected by the scenario selecting component, generates a response sentence about the requested information and gives the response sentence to a user terminal;
a behavior determining component that receives, as an analysis result of an answer sentence, an attribute and an attribute value for the attribute from an answer sentence analyzing component that analyzes a user answer sentence to the response sentence, retrieves at least one of the dialogue scenarios corresponding to a response condition based on the attribute and the attribute value, from the dialogue scenario database, and determines a next behavior in accordance with each of the dialogue scenarios; and
a dialogue control component that effects control of a dialogue with a user in accordance with the next behavior determined by the behavior determining component, the information extracting device includes:
a knowledge database that allows systematic classification of relationships between a plurality of words in a plurality of fields;
an input component that takes in input information;
an information extracting component that, if an attribute to be extracted, included in the input information is detected, extracts an attribute value for the attribute included in the input information using knowledge in a field relating to the attribute in the knowledge database; and
an extracted information storing component that stores therein the attribute and the attribute value of the attribute, extracted from the information extracting component, so that the attribute and the attribute value correspond to each other, and
the dialogue system includes:
an analyzing section that analyzes a speech of the human;
a target place authorizing section that authorizes a target place at which an element used to produce a speech by the system is extracted from the speech of the human, by using the analysis result; and
an extracting section that extracts, based on the target place, an element from the human speech so that a system speech has a proper length.
